(19) United States
(12) Patent Application Publication
(10) Pub. No.: US 2002/0161907 A1
(43) Pub. Date: Oct. 31, 2002

(54) Adaptive multi-protocol communications system

(76) Inventor: Avery Moon, San Lorenzo, CA (US)

Correspondence Address: GLENN PATENT GROUP, 3475 EDISON WAY, SUITE L, MENLO PARK, CA, 94025, US

(21) Appl. No.: 10/128,941

(22) Filed: Apr. 24, 2002

Related U.S. Application Data
(60) Provisional application No. 60/286,595, filed on Apr. 25, 2001.
(60) Provisional application No. 60/298,355, filed on Jun. 14, 2001.
(60) Provisional application No. 60/308,280, filed on Jul. 26, 2001.
(60) Provisional application No. 60/308,275, filed on Jul. 26, 2001.

(51) Int. Cl. G06F 15/16

(52) U.S. Cl. 709/230; 709/246

(57) ABSTRACT

An adaptive multi-protocol communications system provides a plurality of single computer interface cards connected to a common backplane or interconnect. Each interface card sends and receives bit streams of a specific application protocol, exchanging data between possibly differing application protocols. The interface card feeds the incoming binary stream into a finite state machine dedicated to converting a specific application protocol bit stream into a multi-dimensional matrix representation for a particular communication protocol, e.g., EDI, XML, or the invention's intermediate translation representation. The invention uses finite state machines to convert from the initial communication protocol bit stream to the invention's intermediate representation. A finite state machine on a receiving interface card is used to convert the incoming bit stream into an intermediate language multi-dimensional matrix and passes the matrix to a destination interface card which has a finite state machine used to convert the intermediate language multi-dimensional matrix to an application protocol bit stream. The application protocol bit stream is then sent to a receiving computer system.

### CROSS REFERENCE TO RELATED APPLICATIONS

This application claims benefit of U.S. Provisional Patent Application Serial No. 60/286,595, filed on Apr. 25, 2001, U.S. Provisional Patent Application Serial No. 60/298,355, filed on Jun. 14, 2001, U.S. Provisional Patent Application Serial No. 60/308,280, filed on Jul. 26, 2001, and U.S. Provisional Patent Application Serial No. 60/308,275 filed on Jul. 26, 2001.

### BACKGROUND OF THE INVENTION

1. Technical Field

The invention relates to data communication across computer networks. More particularly, the invention relates to translating between different communication protocols and transmitting data across differing computer networks.

2. Description of the Prior Art

Over the past five decades, thousands of computer programs have been written for businesses to implement a wide variety of functions. As businesses accumulate more computer systems with different functionality, they accumulate more of these discrete computer programs. As technology evolves, businesses upgrade existing systems and procure new systems at idiosyncratic intervals. As a result of business needs and industry-wide technologic innovation, businesses accumulate over time a disparate set of computer systems running a heterogeneous set of computer programs.

Over the past 20 years, the majority of businesses have interconnected all their computer systems together using a mix of hardware and software. Networking hardware such as: switches and routers, networking software, web servers, and firewalls, have become a cornerstone of how business computer systems are built and used today. Many capabilities offered by computer software today require that each computer be connected to a common shared network. At a macro level, the Internet is simply a worldwide amalgamation of computer networks from businesses, educational institutions, and governmental agencies.

The shift to requiring each computer to be connected to a network has greatly affected computer software. Specifically, many types of computer software now require the ability to communicate with other software, via the mutually shared network, to implement their capabilities. Electronic mail, web pages, and file servers all exemplify this dependence upon a shared network for transmission of information between computer software.

To facilitate the sharing of information between computer software, running over a shared network, a wide variety of computer protocols have been created which define the semantics for this sharing. Further, numerous discrete but interdependent layers of computer protocols have been defined over the past 30 years. For example, the OSI network stack model is one formulation of these protocols and their mutual relationship.

Within this context, three general layers of computer protocols can be identified: physical, network, and application. Physical network protocols are concerned with defining the specifics about the physical properties of the wires and hardware used to implement computer networking. For example, the electrical signaling and the number of bits in a byte are defined within physical protocols.

Network protocols are concerned with defining the specifics about the organizational, representational, and identification semantics of the computer network. For example, the basic data unit, framing schemas, error recovery/retry mechanisms, and packet (dis)assembly are defined within network protocols.

Application protocols are concerned with session negotiation, line parameters (compression, encryption, etc), data translation, data presentation format, data schemas, transactional semantics, and request-reply semantics. This protocol decomposition follows from conceptually aggregating layers from the OSI stack, based upon how they are implemented by computer systems today. Application protocols are implemented in computer software, within the specific software programs which require access to data using such protocols.

A wide variety of hardware computer systems and computer software programs have been devised to implement the physical and network protocol layers. Specially-designed hardware is required to implement the physical network protocols, as specific wiring and electrical signaling behavior must be implemented in silicon and be connectable via a physical network plug. The network protocol layers were initially (before 1990) implemented by software running on general purpose computers. More recently, network protocols have been implemented using custom application-specific integrated circuits (ASICs) or programmable network processors. These individual components, implementing physical and network layer protocol processing, are packaged into products including routers and switches.

Application protocols have not been implemented in hardware due to a variety of factors. First, connecting application logic with the hardware integration system is not considered feasible for performance and programmability reasons. Second, the perceived financial value for such a hardware integration system was not sufficient to warrant its development and commercialization. Third, rapid technologic change in the technology industry and long hardware design cycles for hardware questioned the financial motivation. Fourth, many historical protocols were proprietary to specific companies and hardware implementation may result in intellectual property infringement. Fifth, many software engineers did not perceive a need for a hardware-based integration system. Sixth, implementing integration systems in hardware was not considered an engineering best practice for either software or hardware engineers. Seventh, the lack of universally agreed upon protocol standards demanded the infeasible requirement that hundreds of application protocols be supported by the hardware integration system. Eighth, software engineering lacks best practices and historical precedent on how to implement complex computer software using a hardware approach.

As many computer protocols exist for each layer, there has always been a need for solutions which facilitate communication among systems using different protocols to exchange data. All these solutions implement functionality which enables multiple systems to exchange data by understanding and bridging the protocol interfaces which each discrete system exposes via its network connectivity; for this document, all solutions which implement capabilities which fit into this functional description are abstractly termed integration systems.

Beginning in the mid-1980s, multi-protocol network routers pioneered integration of heterogeneous physical and network layer protocols. Specifically, the multi-protocol network router implemented the functionality necessary to exchange data between networks running different types of physical and network layer protocols. The prototypical example of this class of innovation was the development of routing hardware which could exchange data between the proprietary IBM SNA protocol and the Internet Protocol (IP).

Bringing this analogy to the application layer, where application layer protocols are at the exchange level, the exchange of data between computers having heterogeneous application level protocols at the software level is complicated at best. Referring to FIG. 1, prior approaches required a large amount of software conversions for when for example, n application protocols are exchanged between two computer systems 101, 102. Since each conversion is unique, prior approaches required n² conversion mapping routines 103, where n is the number of discrete instances of application protocols being exchanged, to completely cover the conversion combinations. Supporting n² conversion routines is not feasible as n grows large. Due to this n² complexity, prior approaches have resulted in high cost and long development cycles.

Prior approaches also commonly require many discrete software components for each application protocol used in exchange. Therefore, facilitating exchange among multiple systems is onerous for users because they must continually adapt their software and systems to use these disparate components. Further, the design for each data exchange component differs based upon many different factors such as programming language, protocol type, and operating system. Thus, prior approaches not only are technically complex, but they also are difficult to use because they lack a common design or implementation.

It would be advantageous to provide an adaptive multi-protocol communications system that provides a hardware integration system that communicates between multiple application protocols and dramatically reduces the number of conversion processes required. It would further be advantageous to provide an adaptive multi-protocol communications system that allows a user to easily expand the system to accommodate additional application protocols.

### SUMMARY OF THE INVENTION

The invention provides an adaptive multi-protocol communications system. The system provides a hardware integration system that communicates between multiple application protocols and reduces the number of conversion processes required to n. In addition, the invention provides a modular system that allows a user to easily expand the system to accommodate additional application protocols.

The invention provides a plurality of single computer interface cards connected to a common backplane or interconnect. Inter-card communication is accomplished via a memory-mapped schema. Each interface card sends and receives bit streams of a specific application protocol. The interface cards exchange data between possibly differing application protocols.

The interface card feeds the incoming binary stream into a finite state machine. Each finite state machine is dedicated to converting a specific application protocol bit stream into a multi-dimensional matrix representation. The finite state machine operates on the bit stream and creates a multi-dimensional schema matrix for a particular communication protocol, e.g., EDI, XML, or the invention's intermediate translation representation.

A lookaside buffer is used by the finite state machine to properly create the multi-dimensional matrix using previous state values. The lookaside buffer contains previous stream values that are placed into the lookaside buffer by the finite state machine.

The user can adjust the finite state machine's behavior with a set of configuration tables and an exception table. The configuration tables allow the user to define how the finite state machine operates on the incoming byte stream to achieve a correct syntax for the schema matrix. The exception table is a set of constraints over the multi-dimensional regions of the matrix.

A preferred embodiment of the invention uses a two-stage approach to converting bit streams. A first finite state machine on a receiving interface card is used to convert the incoming bit stream into a multi-dimensional matrix representation of the bit stream's application protocol. A second finite state machine is used to convert the application protocol multi-dimensional matrix to an intermediate representation multi-dimensional matrix.

The intermediate representation multi-dimensional matrix is passed to a destination interface card. The destination interface card has a first finite state machine used to convert the intermediate representation multi-dimensional matrix to an application protocol multi-dimensional matrix. A second finite state machine is used to convert the application protocol multi-dimensional matrix to an application protocol bit stream. The application protocol bit stream is then sent to a computer system.

Another preferred embodiment of the invention uses composite finite state machines. Composite finite state machines convert from the initial communication protocol directly to the invention's intermediate representation. A finite state machine on a receiving interface card is used to convert the incoming bit stream into an intermediate representation multi-dimensional matrix.

The intermediate representation multi-dimensional matrix is passed to a destination interface card. The destination interface card has a finite state machine used to convert the intermediate representation multi-dimensional matrix to an application protocol bit stream. The application protocol bit stream is then sent to a computer system.

Other aspects and advantages of the invention will become apparent from the following detailed description in combination with the accompanying drawings, illustrating, by way of example, the principles of the invention.

### BRIEF DESCRIPTION OF THE DRAWINGS

FIG. 1 is a block schematic diagram of a prior art approach of converting application protocols using n² conversion routines according to the invention according to the invention;

FIG. 2 is a block schematic diagram showing an illustrative example of a representative plurality of systems connecting to the invention via a plurality of interfaces according to the invention;

FIG. 3 is a block schematic diagram of a preferred embodiment of the invention using a multi-computing architecture to provide application protocol conversions according to the invention;

FIG. 4 is a block schematic diagram showing an illustrative example of a configuration operation involving a user, the invention, and a plurality of interconnected systems according to the invention;

FIG. 5 is a block schematic diagram showing an illustrative example of an integration operation involving the invention and a plurality of interconnected systems according to the invention;

FIG. 6 is a block schematic diagram showing a preferred embodiment of the universal configuration functionality using declarative configuration according to the invention;

FIG. 7 is a block schematic diagram of a multi-computer system implementing the invention's application protocol conversions according to the invention;

FIG. 8 is a block schematic diagram of the major components of two types of single board computers according to the invention;

FIG. 9 is a block schematic diagram of a high level view of PCI-to-PCI bridges on single board computers according to the invention;

FIG. 10 is a block schematic diagram of the major components surrounding a CPU on a single board computer according to the invention;

FIG. 11 is a block schematic diagram of a bit stream conversion to a multi-dimensional matrix representation according to the invention;

FIG. 12 is a block schematic diagram of a three-stage conversion pipeline according to the invention according to the invention;

FIG. 13 is a block schematic diagram showing a two-stage multi-dimensional matrix conversion process using finite state machines according to the invention;

FIG. 14 is a block schematic diagram showing a one-stage multi-dimensional matrix conversion process using composite finite state machines according to the invention;

FIG. 15 is a block schematic diagram of a source multi-dimensional matrix representation, target multi-dimensional matrix representation, and sequential multi-stage conditional dataflow according to the invention;

FIG. 16 is a block schematic diagram of a prefix pipeline, infix pipeline, and suffix pipeline according to the invention;

FIG. 17 is a block schematic diagram showing an illustrative example of a plurality of prefix pipelines, infix pipelines, suffix pipelines, and pipeline crossbars according to the invention;

FIG. 18 is a block schematic diagram showing a preferred embodiment of the sequential multi-stage conditional dataflow for the prefix pipeline according to the invention;

FIG. 19 is a block schematic diagram showing a preferred embodiment of the sequential multi-stage conditional dataflow for the suffix pipeline according to the invention;

FIG. 20 is a block schematic diagram showing a preferred embodiment of the sequential multi-stage conditional dataflow for the infix pipeline according to the invention;

FIG. 21 is a block schematic diagram showing a preferred embodiment of the multi-dimensional matrix for the invention using slots, dimensions, and a multi-dimensional region according to the invention;

FIG. 22 is a block schematic diagram showing the relationship among slots across dimensions for a preferred embodiment of the multi-dimensional matrix for the invention according to the invention;

FIG. 23 is a block schematic diagram showing slot annotation for a preferred embodiment of the multi-dimensional matrix for the invention according to the invention;

FIG. 24 is a block schematic diagram showing an illustrative example of slot annotations for a preferred embodiment of the multi-dimensional matrix for the invention according to the invention;

FIG. 25 is a block schematic diagram showing a preferred embodiment of an abstract functional operation defined over two multi-dimensional matrices according to the invention;

FIG. 26 is a block schematic diagram showing a preferred embodiment of an operation derived from an abstract functional operation defined over two multi-dimensional matrices according to the invention;

FIG. 27 is a block schematic diagram showing a preferred embodiment of the finite state machine for the invention according to the invention;

FIG. 28 is a block schematic diagram showing an illustrative example using a preferred embodiment of the finite state machine for the invention according to the invention;

FIG. 29 is a block schematic diagram showing a preferred embodiment of the finite state machine for the invention according to the invention;

FIG. 30 is a block schematic diagram of a pairspace with a plurality of nodes associated with the pairspace abstract formulation according to the invention;

FIG. 31 is a block schematic diagram of the functional components of the p function associated with the pairspace abstract formulation according to the invention;

FIG. 32 is a block schematic diagram of the finite state machine for the read primitive operation associated with the pairspace abstract formulation according to the invention;

FIG. 33 is a block schematic diagram of the finite state machine for the write primitive operation associated with the pairspace abstract formulation according to the invention;

FIG. 34 is a block schematic diagram of the finite state machine for the remove primitive operation associated with the pairspace abstract formulation according to the invention;

FIG. 35 is a block schematic diagram of the finite state machine for the notify primitive operation associated with the pairspace abstract formulation according to the invention;

FIG. 36 is a block schematic diagram of the finite state machine for the white-lambda process associated with the pairspace abstract formulation according to the invention;

FIG. 37 is a block schematic diagram of the finite state machine for the testAndSet primitive operation associated with the pairspace abstract formulation according to the invention;

FIG. 38 is a block schematic diagram of the finite state machine for the fetchAndAdd primitive operation associated with the pairspace abstract formulation according to the invention;

FIG. 39 is a block schematic diagram of the generative time-dynamic attribute of the pairspace abstract formulation according to the invention;

FIG. 40 is a block schematic diagram specifying the functional representation of non-disjointness for the pairspace abstract formulation according to the invention;

FIG. 41 is a time-dynamic comparison of state between temporal and persistent pairspace abstract formulations according to the invention;

FIG. 42 is a block schematic diagram of the major components of the TDGC abstract formulation according to the invention;

FIG. 43 is a block schematic diagram illustrating the correspondence between a GIRC pair and a (name, value) pair according to the invention;

FIG. 44 is a block schematic diagram of the finite state machine for the lock primitive operation associated with the pairspace abstract formulation according to the invention;

FIG. 45 is a block schematic diagram of the finite state machine for the composite unlock primitive operation associated with the pairspace abstract formulation according to the invention;

FIG. 46 is a block schematic diagram of a preferred embodiment for a distributed garbage collection algorithm for the pairspace abstract formulation according to the invention;

FIG. 47 is a block schematic diagram of an illustrative example of node reachable for a preferred embodiment of a distributed garbage collection algorithm for the pairspace abstract formulation according to the invention;

FIG. 48 is a schema representation of the correspondence between AFO and (Name, Value) pair for the pairspace abstract formulation according to the invention;

FIG. 49 is a block schematic diagram of a finite state machine of a preferred embodiment implementing object invocation in ADPM for the pairspace abstract formulation according to the invention;

FIG. 50 is a block schematic diagram of a finite state machine diagram of prior art implementing proxy object invocation according to the invention;

FIG. 51 is a block schematic diagram of a finite state machine of a preferred embodiment for adaptive delegation for strong-typing object invocation for the pairspace abstract formulation according to the invention;

FIG. 52 is a block schematic diagram illustrating the logical correspondence between TGAD and a bridge for the pairspace abstract formulation according to the invention;

FIG. 53 is a block schematic diagram of a finite state machine of a preferred embodiment for implementing TGAD through a bridge with distributed systems utilizing a plurality of application protocols for the pairspace abstract formulation according to the invention;

FIG. 54a is a block schematic diagram of a subset of the automated systems integration method according to the invention;

FIG. 54b is a block schematic diagram of a subset of the automated systems integration method according to the invention;

FIG. 55 is a block schematic diagram illustrating the correspondence between a plurality of sequential iterations of the automated systems integration method according to the invention;

FIG. 56 is a block flow diagram for multiple instances of an embodiments of the automated systems integration method with non-overlapping delta sets according to the invention;

FIG. 57 is a block flow diagram for multiple instances of an embodiments of the automated systems integration method with overlapping delta sets according to the invention;

FIG. 58 is a block flow diagram for illustrating the monotonic sequential time reduction for multiple instances of an embodiment of the automated systems integration method according to the invention;

FIG. 59 is a block schematic diagram of the primary components for a single iteration of an embodiment of the automated systems integration method according to the invention; and

FIG. 60 is a block flow diagram of time-dynamic component evolution and composition of an embodiment apparatus of the automated systems integration method according to the invention.

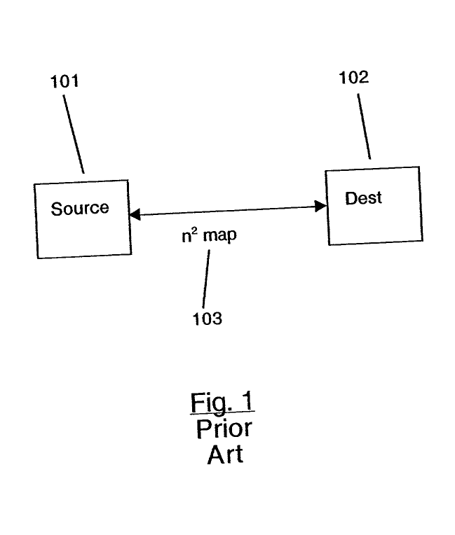

### DETAILED DESCRIPTION OF THE INVENTION

The invention is embodied in an adaptive multi-protocol communications system. A system according to the invention provides a hardware integration system that communicates between multiple application protocols and reduces the number of conversion processes required to n. In addition, the invention provides a modular system that allows a user to easily expand the system to accommodate additional application protocols.

Just as a multi-protocol network router can accommodate hardware components which communicate with any physical and network protocol, the invention provides an integration system which accommodates hardware components which communicate with any application protocol. An application protocol according to the invention includes all the distinct interrelated concepts which are implied by the common interpretation of the term protocol when considered at the application layer, such as data protocol, data format, data schema, request-reply semantics, inter-application synchronicity semantics, and inter-application transaction processing semantics.

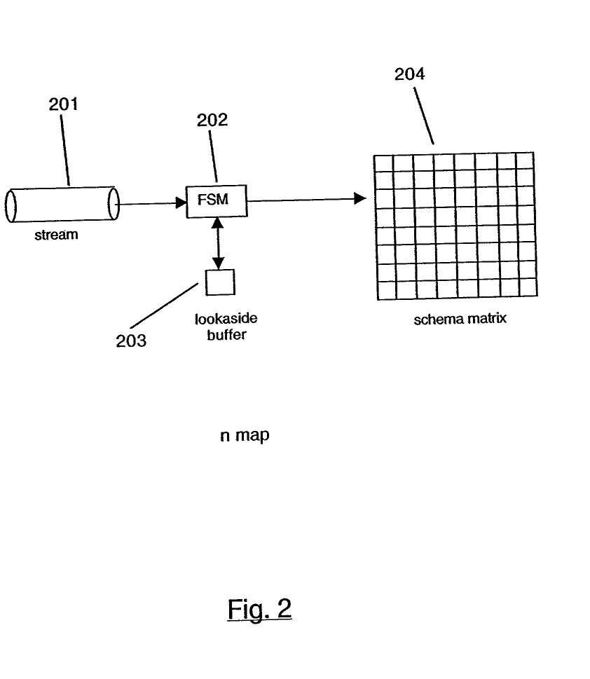

With respect to FIG. 2, the invention comprises a plurality of interfaces. Each interface is composed of single computer interface cards, accepting one or more network streams 201. The network streams are fed into the finite state machine 202. The finite state machine 202 operates on the network stream 201 to create the intermediate virtual representation 204. An operation of a finite state machine 202 is elaborated below. An intermediate virtual representation 204 may be specific to either a particular application protocol, e.g., EDI, XML, or the invention's intermediate virtual translation representation.

The lookaside buffer 203 may be used by the finite state machine 202 to properly create the intermediate virtual representation 204. For some data exchange operations, a finite state machine 202 must be able to look back into the previous stream values to place the correct values into a intermediate representation 204. The lookaside buffer 203 contains previous stream values, or composite values derived from one or more previous stream values, that are placed into and may be subsequently read from the lookaside buffer 203 by the finite state machine 202. Either the lookaside buffer 203 or the intermediate representation 204 may be shared among multiple finite state machines 202, provided they are collectively located on the same interface.

The finite state machine 202 is specifically created for a particular application protocol, in order to create a proper intermediate virtual representation 204. The intermediate virtual representation 204 is subsequently used by either another interface or by another finite state machine, as will be described below. Further, the invention may implement a plurality of well-defined operations upon an intermediate virtual representation 204 prior to its subsequent use by either another interface or by another finite state machine.

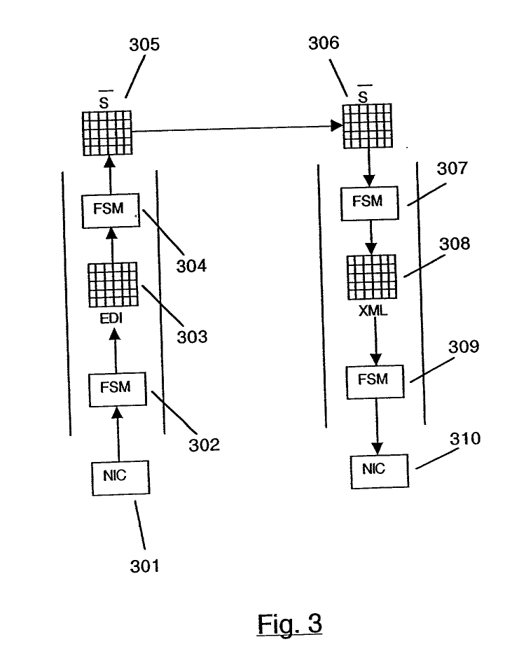

Referring to FIG. 3, a sequence of binary digits come off of the network interface card (NIC) 301 located on an interface. The binary digits are mapped onto a multi-dimensional schema matrix 303 by the finite state machine 302. In this example, the source protocol is EDI and the destination protocol is XML. One skilled in the art will immediately recognize that the EDI and XML protocols in this example could be equivalently substituted for any two application protocols.

The multi-dimensional schema matrix represents the structural characteristics for both an application protocol, commonly referred to as the schema, and data, commonly referred to as the values, whose structure adheres to such an application protocol. A preferred embodiment for the schema matrix is described below.

The EDI matrix 303 is passed to a finite state machine 304. This finite state machine 304 translates the EDI matrix 303 into the invention's intermediate translation virtual representation matrix 305. The virtual representation matrix 305 is transferred to the destination side's interface card via the interconnect, using a memory mapping scheme for example.

The virtual representation allows any computer interface card to transfer data to any other computer interface card without the card having to know the destination protocol. Computer interface cards may be communicably connected to other computer interface cards and freely exchange virtual representation matrices to transfer data.

The destination side's finite state machine 307 reads its copy of the virtual representation matrix 306. As will be described below, an interconnect may provide a means for the finite state machine 307 to directly use the intermediate virtual representation matrix 305 without copying, using a zero-copy communication scheme for example. The finite state machine 307 translates the matrix 306 into an XML multi-dimensional matrix 308. The XML multi-dimensional matrix 308 is passed to the finite state machine 309. The finite state machine 309 converts the XML matrix 308 into an XML bytestream and streams the XML stream to the NIC 310.

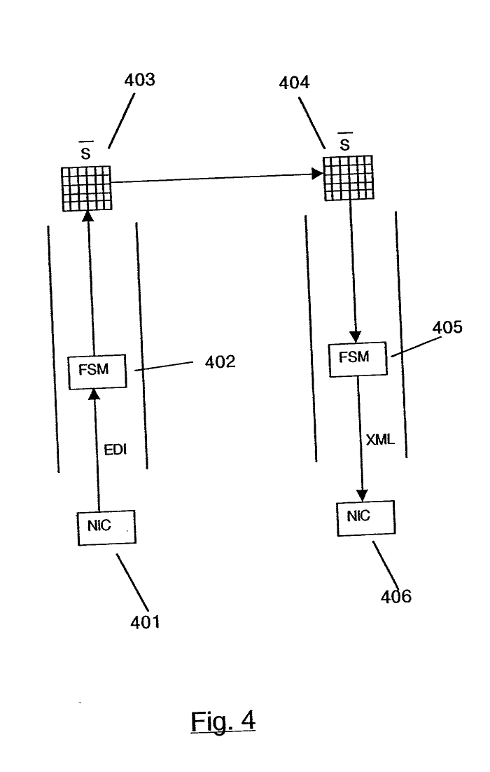

With respect to FIG. 4, a preferred embodiment of the invention uses composite finite state machines. Composite finite state machines convert directly between the communication protocol and the invention's intermediate virtual representation. The NIC 401 sends an EDI stream, for example, to the finite state machine 402. The finite state machine 402 maps from the initial EDI to the single intermediate virtual representation matrix 403.

The destination side's finite state machine 405 reads its copy of the virtual representation matrix 404. The finite state machine 405 then translates the virtual representation matrix 404 into an XML stream and streams the XML to the NIC 406.

The one or more specific intermediate-to-intermediate translation methods used to translate from the intermediate virtual representation matrix 403 to the intermediate virtual representation matrix 404 are not considered attributes of this invention.

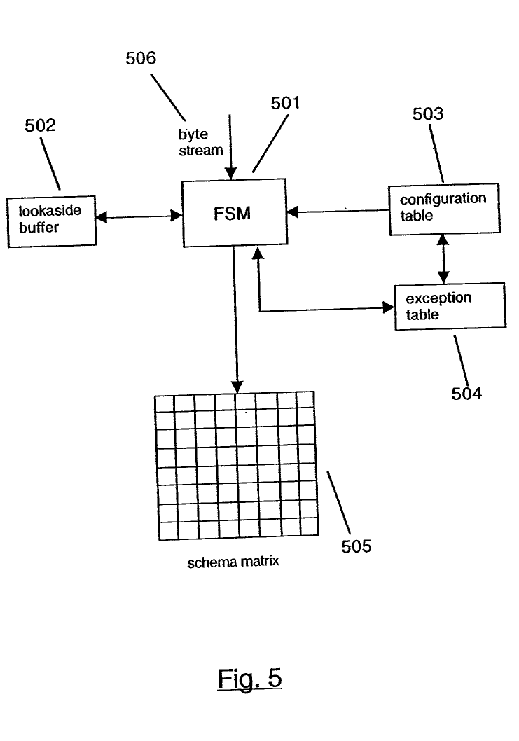

Referring to FIG. 5, the invention combines a finite state machine 501 with a lookaside buffer 502 to create a schema matrix 505. As noted above, the finite state machine is created for a specific communication protocol. When a user requires modifications and customizations to the finite state machine's exchange or translation process, the invention provides the user with a configuration table 503 and an exception table 504 to adjust the finite state machine's behavior.

Each finite state machine 501 may be modified or customized arbitrarily based upon requirements directly or indirectly specified by the user, or based upon characteristics of operations being processed by a finite state machine 501. The configuration table 503 allows a user to define how the finite state machine 501 operates on the incoming byte stream 506. One skilled in the art will recognize that the process for how a user provides such instructions for modification or customization is not an attribute of the invention.

The exception table 504 is a set of constraints over the multi-dimensional regions of the matrix 505, along with an optional set of corresponding actions to take when such constraints are violated. As an illustrative example of an exception table 504, the constraints can be used as rules by a finite state machine 501 to enforce an incoming byte stream uses a correct syntax which is compatible for a schema matrix 505.

The preceding constitutes the defining attributes for the invention. Preferred embodiments of the invention are now described.

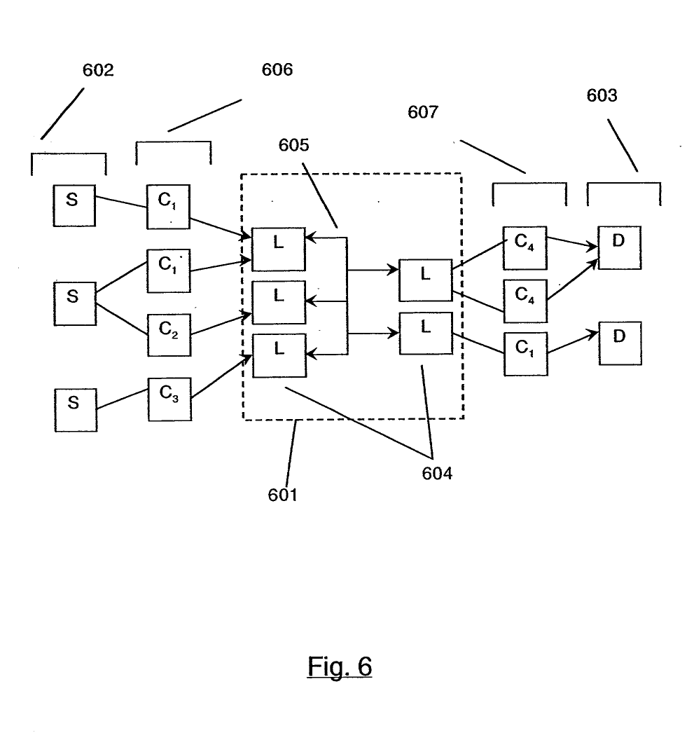

Referring to FIG. 6, a preferred embodiment of the invention could be embodied by an adaptive multi-protocol communications system in many different ways. As one example, the system 601 provides a multi-processor system that adapts to computer systems using differing application protocols 606, 607. The invention connects to one or more source computer systems 602, while connecting to one or more destination computer systems 603. Each source computer system 602 uses one or more application protocol(s) 606, while each destination computer system 603 uses one or more application protocol(s) 607. As is customary to reduce unnecessary detail, many components and electrical connections implicit in this and subsequent block diagrams are not drawn.

Each source and destination computer system 602, 603 connects to system 601 via an interface 604. Each interface 604 is composed of many discrete parts, as described below. The plurality of interfaces 604 are able to intercommunicate directly via an internal interconnect 605. The manner in which the interfaces 604 intercommunicate via the interconnect 605, along with the manner in which each interface 604 communicates with the source and destination computer systems 602, 603 is not a defining attribute of the system. One skilled in the art will recognize that the interconnect 605 serves to facilitate electrical connectivity among each interface 604, and thus the interconnect 605 may consist of any discrete or composite set of components which facilitate such electrical connectivity.

Although source and destination computer systems 602, 603 as illustrated in FIG. 2 as distinct entities, a preferred embodiment of the invention could equivalently support a single computer system serving as both a source and destination computer system 602, 603. One or more source computer systems 602 or destination computer systems 603 connecting to the system 601 could simultaneously connect using two or more application protocols. One or more source computer systems 602 or one or more destination computer systems 603 could simultaneously perform two or more exchanges using the same application protocol. Each application protocol 606, 607 connecting a source or destination computer systems 602, 603 and an interface 604 can either be uni-directional or bi-directional, as well as unicast or multicast.

The exact number and physical block specification of application protocols 606, 607, interfaces 604, and source and destination systems 602, 603 should be considered an attribute of a preferred embodiment of the invention, and not a defining attribute of the invention.

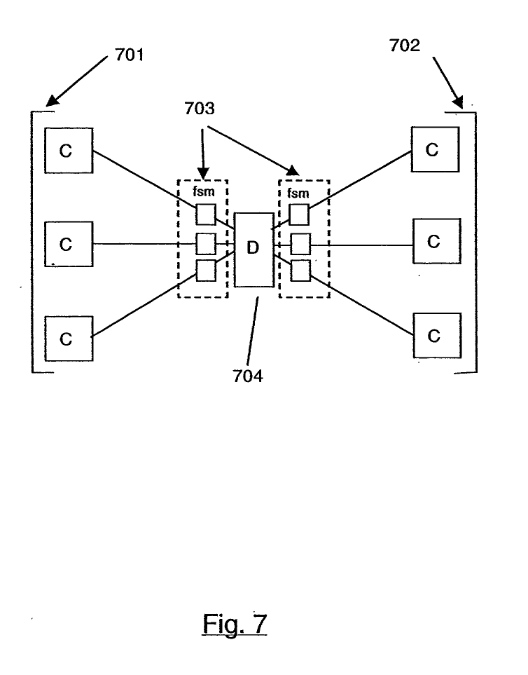

Referring to FIG. 7, an enlarged view of FIG. 6 focusing on the invention is illustrated, focused on the perspective of the one or more finite state machines 703 implemented on each interfaces 704. Each interface in the invention efficiently produces an intermediate virtual representation of the data being exchanged using finite state machines 703, which is communicated between interfaces across the interconnect using a common intermediate virtual representation 304. An intermediate virtual representation is used to exchange data between the computer systems using differing application protocols 301, 302.

FIG. 6 and FIG. 7 illustrate why only n conversion processes are required for data exchange implemented by this invention. Specifically, the maximum bound of n processes for exchange arises for two reasons. First, any application protocol 606, 607 can be converted into the intermediate virtual representation 704 via an appropriate finite state machine 703. Second, the finite state machine 703 and corresponding intermediate virtual representation 704 for a given application protocol are equivalent for both input to the invention (application protocol 701, 702 to intermediate virtual representation 704) and output from the invention (intermediate virtual representation 704 to application protocol 701, 702).

The invention is informally called a universal integration platform (UIP), as the invention defines an extensible hardware architecture which provides support for exchange among all application-layer protocols 606, 607 which are accessible by the invention via a shared network. The invention implements data exchange processes among any number of arbitrary computer systems (such as source and target computer systems 602, 603), each internetworked with the invention via a network connection. Further, the invention supports these capabilities for arbitrary computer systems, whether located on a private intranet or on the public Internet, provided they are internetworked via a common shared network. The invention apparatus can be connected to any computer systems via any network which provides connectivity logically equivalent to that provided by direct network connectivity, over switched/routed networks or the Internet for example. The application protocol 606, 607, 701, and 702 are carried over these network connections between the invention apparatus and the arbitrary computer systems.

In doing so, the invention provides the hardware implementation for a programmable computing system which facilitates the execution of arbitrary computational operations, either internally within the invention or externally on any arbitrary computer systems via remotely invoking functionality via an established application protocol. Thus, the invention further differs from computer hardware implementing physical and network layer protocols, as the invention can be dynamically configured to implement arbitrary logical transformations over the exchanged data. One skilled in the art will thus recognize that the invention can support any transformation which can be specified using a general-purpose programming language. An embodiment of these generalized logical transformations is provided below. This generality and extensibility contrasts with network routers and switches, whose primary functionality is not generally programmable.

Using the OSI network model discussed above as a reference, the invention is concerned with capabilities which implement integration processes affecting data and computational logic at the session-layer (layer 5) and above, supporting multiple application-layer protocols. Further, the invention makes only a single assumption about the interrelationship between itself and external computing systems for OSI layers 1-4: a physical network connection (PNC) is necessary to be established between the invention and a plurality of computing systems. One skilled in the art will recognize that the attributes of the PNC, such as whether it is connect-oriented or connectionless for example, are not a defining attribute of the invention.

As such, the semantics and implementation details of how such PNC, and the protocol stack manipulation for OSI layers 1-4 inherent therein, is established and maintained to the plurality of external computing systems is not considered relevant to the invention. Equivalently, such apparatus is physically connected to the external computer systems via a physical network cable. Provided such connection exists, precisely how it is implemented is not relevant to the invention.

From the perspective of the invention apparatus, each PNC is modeled programmatically as an abstract network connectivity endpoint via a bi-directional network communication abstraction. A preferred embodiment for this network communication abstraction are network sockets. The socket is a prevalent abstraction used in network programming for modeling a bi-directional capacity between two computer systems. Using such a network communication abstraction, embodied by the socket abstraction, ensures the invention remains independent from, or equivalently has no dependencies upon, the specific attributes of the PNC protocol type or the implementation mechanism. Thus, the invention is independent from the processing of physical and network protocols, as implemented by systems such as routers and switches.

One preferred embodiment of the invention implements data exchange among a plurality of application protocols via a closely-coupled asymmetric multi-computing, multi-processing apparatus. Such an apparatus is defined as closed-coupled because all components are physically contained within a single enclosure. It is defined as multi-computing, as such an enclosure supports the insertion of multiple physically-independent single board computers (SBC). It is further defined as multi-processing, as each SBC can include multiple central processing units (CPUs). Each CPU need not be a general-purpose CPU, as such may be an application-specific processor such as an ASIC, FPGA, or network processor. Each interface 604 from FIG. 6 is embodied on an SBC. One skilled in the art will recognize that the correspondence between interface and SBC is not a defining attribute of the invention.

Each of the SBCs are interconnected via a dedicated, high-speed interconnect. This dedicated interconnect serves the role of the interconnect 205 from FIG. 2. One skilled in the art will recognize that this dedicated interconnect could be embodied by any physical component which facilitates electrical connectivity between SBCs (commonly referred to as a backplane or bus). Representative examples include a shared bus, switched bus, integrated switch, switched fabric, or one or more specialized bridge chips.

A key defining characteristic of this apparatus is that the SBCs are programmatically independent. Equivalently, each SBC executes one independent stream of computer instructions per CPU and utilizes independent random access memory (RAM). The adaptability and extensibility of the invention partially arises from this SBC independence, which enables functionality of the invention to be determined by the individual SBCs inserted into the invention. For example, CPU n of SBC m cannot access via direct processor addressing, RAM of any other SBC than SBC m. Various enclosures are available to contain such SBCs and provide interconnect, each of which can contain a varying number of these computing units.

Many attributes of the invention, such as performance viability and concurrent multi-processing, rely upon the design factor that each data exchange operation for each application layer protocol (ALP) is processed by a single dedicated SBC. Due to the coupling between SBC and application protocol, SBCs are equivalently referred to in this document as ALP logical adapters (ALA).

Equivalently, the benefits of the invention depend upon such an asymmetric architecture and would not be achievable using systems that lack such asymmetry. Thus, this apparatus differs markedly from generic symmetric multi-computing and multi-processing machines (commonly referred to as SMP, NUMA, or equivalent), in which each CPU is a general-purpose processor. In such contrasting designs, each CPU is predominantly interchangeable (although in some cases distinguishable) from the perspective of the operating system and application-layer software executing upon it. Thus, each CPU has a positive probabilistic chance of being scheduled to implement any data exchange functionality or in which the allocation of programmatic tasks to specific CPUs and SBCs is specified by the user of the machine via process scheduling or other application-layer software programming.

Beyond just a specific hardware architecture, the invention relies intimately upon how functionality is decomposed into parts and then implemented accordingly by SBCs within such apparatus. Each SBC in the apparatus implements a single specific and well-defined set of capabilities. The UIP includes two distinct categorical types of such SBCs, which are generically termed adapters: (1) programmable interpretation adapters and (2) ALP logic adapters. The design and intent of the PIA and ALA SBCs within this extensible multi-protocol integration system are as flexible function-specific component building blocks.

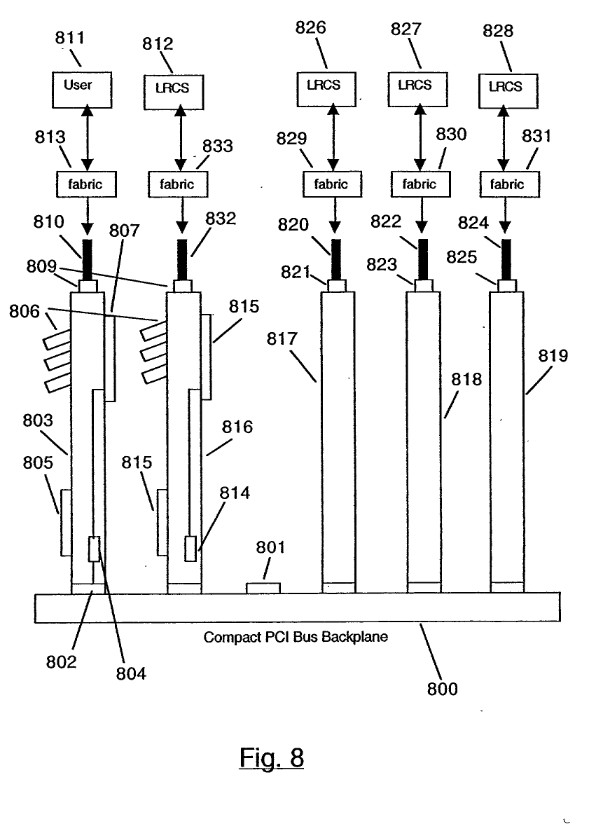

With respect to FIGS. 8, 9, 10, and 11, exemplary illustrations of a component level diagram of the invention with multiple adapters (SBCs) 803, 816, 817, 818, 819 are shown. The SBC 803, 816, 817, 818, 819 are interconnected internally via a compact shared peripheral component interface (CompactPCI) bus backplane 800. As described above, the CompactPCI bus backplane of this preferred embodiment could equivalently be substituted for hardware components which provide equivalent electrical capabilities, such as: a shared bus, switched bus, integrated switch, switched fabric, or one or more specialized bridge chips.

Each individual adapter is connected externally 809 to either a network fabric 813 supporting connectivity by user 811 via an arbitrary network cable 810, or connected externally to a single LRCS 812, 826, 827, 828; each adapter externally connected to an LRCS via an independent and discrete network fabric 833, 829, 830, 831, providing concurrent connectivity between the adapter and the LRCS. The term network fabric is defined hear to mean any electrical connectivity provided via a network cable with optional intermediate bridging system such as a switch or router.

Adapter 803 is a programmable interpretation adapter (PIA SBC), as distinguished by 803 connecting to user 811. SBCs 816, 817, 818, 819 are ALP logical adapters, as distinguished by each connecting to their respective LRCS 812, 826, 827, and 828. Note that detail on adapters 817, 818, 819 is omitted for clarity, as their onboard components are substantively similar to that of adapter 816.

In a preferred embodiment, each SBC is inserted into backplane 800 via a PCI interface 801, 802, which provides the electrical connectivity between each adapter and backplane 800. Equivalently, the mechanism which provides electrical connectivity between each SBC will depend upon the attributes of the interconnect. For example, some interconnect types may not rely upon insertion for electrical connectivity, but rather use network cables. PCI interface 801 is an empty PCI interface, having no SBCs presently inserted into it. PCI interface 802 is a non-empty PCI interface, which results from the insertion of adapter 803 into backplane 800. The lack of SBCs in PCI interface 801, with the opportunity for insertion of additional SBCs at a future time, is the basis of extensibility for the invention. At any future time, an additional SBC (not shown, but which matches the electrical requirements of the PCI interface bus) can be inserted into PCI interface 801 to provide additional capacity or capabilities.

PCI buses can support a broad quantity of adapters ranging from one to several dozen, or more. Further, a broad range of computing devices exist which are compatible with the PCI bus architecture, such as Intel Pentium and Sun Sparc SBCs, which implement the functionality necessary to qualify as an adapter in this context. As such, the exact number and physical block specification of such adapters should be considered an attribute of an embodiment of the invention, and not a defining attribute of the invention. However, the breadth of types of adapters compatible with the PCI bus exemplifies the inherent flexibility of the adaptivity and extensibility provided by this invention.

The SBCs 803, 816, 817, 818, 819 can be constructed from any common combination of CPU 807, RAM 806, persistent storage 805, and other implied board-level components for use in a CompactPCI architecture. Further, the number of processors on each SBC is solely an embodiment detail, as any small number of CPUs 807 (typically four or fewer) could be accommodated on a single SBC without substantively modifying the block diagram as illustrated in FIG. 8. For this embodiment, each SBC is a single CPU. The size and type of the RAM 806 and persistent storage 805, are also embodiment details, as their exact size, type, and timings is not relevant to the implementation of the invention.

Both distinct types of SBC adapters defined by the invention, PIA and ALA, are illustrated in FIG. 8. SBC 803 is a PIA adapter, distinguished by the network connection 810 to a RCS 811. SBCs 816, 817, 818, 819 are ALA adapters, distinguished by network connections 832, 820, 822, 824 to LRCS 812, 826, 827, 828, respectively.

Several commonalties in embodiment exist between the PIA 803 and ALA 816, 817, 818, 819 adapters. Specifically, PIA and ALA adapters share a common architecture: CPU-and network I/O-oriented SBCs, which combine high-performance CPU 907, 915 with high-performance network I/O (Ethernet, in this example) 907. CPUs 907 and 915 are explicitly differentiated to clearly exemplify that the type, speed, and other implementation attributes of the CPU may differ substantively between the SBCs without affecting the functionality of the invention. In this example, the CPUs 907, 915 are qualitatively similar: based upon the same architecture, only with differing speeds based upon the complexity of the ALP being processed by the SBC. Further, the network I/O 907 could differ for each SBC, for the same reasons; however, in this embodiment, all network I/O 907 are composed of Ethernet components and 10/100BaseT network adapters 809 for simplicity of illustration. As is requisite for a computational SBC, each adapter also includes RAM 906 and persistent storage 905. For the same reasons, one skilled in the art will readily appreciate that the persistent storage could be either a traditional hard-disk (based upon magnetophysical rotational properties) or a solid-state device such as flash memory. In either case, persistent storage 805 is providing persistent storage for software code and data required by the invention. Further, one skilled in the art will recognize that the size, access speeds, and other operational parameters of the persistent storage are not directly relevant to the implementation of the invention.

Both PIA and ALA SBC adapter 803, 816, 817, 818, 819 are distinguished by their network connectivity with a plurality of LRCS's 811, 812, 826, 827, 828, according to the constraints upon connectivity for each as defined above, which have the intent of invoking the capabilities offered by the invention. Considering the connectivity of a single SBC as representative, SBC 803 connects to such user 811 via a network connection 810, which is commonly physically inserted into SBC 803 via the insertion plug 809. Network connection 810 is connected to user 811 via an arbitrary set of switched or bridged network connections (collectively termed the network fabric 813).

The invention minimally requires n-way connectivity for the PIA SBC and two-way connectivity for each ALA SBC adapter. The PIA SBC must be able to bi-directionally communicate with each ALA adapter, while the ALA adapters are not minimally required to intercommunicate amongst each other. However, this embodiment generalizes this minimum requirement to support n-way connectivity, or the ability for any SBC i to communicate with any SBC j (where i≠j), for all adapters (PIA and ALA). In a preferred embodiment, this generalization arises from the incorporation of PCI-to-PCI bridge chips (PBC), located either on each SBC or integrated into the interconnect (CompactPCI backplane in this example).

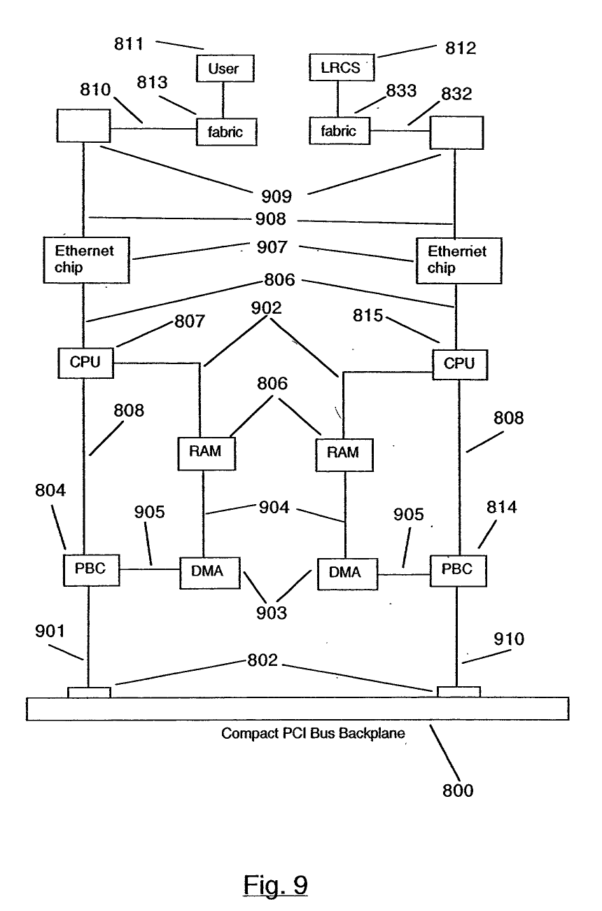

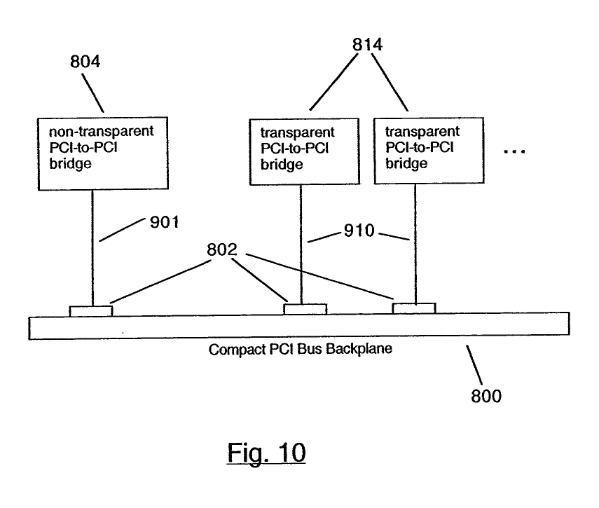

FIG. 10 illustrates a subset of FIGS. 8 and 9 relevant to the PCI-to-PCI bridge chip (PBCs) and the backplane, which is specific to a preferred embodiment using a CompactPCI interconnect. As the following are attributes of a preferred embodiment, they should not be considered defining attributes of the invention. For example, an isometric switched fabric such as Infiniband does not rely upon traditional PBCs nor differentiates between “master” and “slave”, as defined below. PBC 804 is a non-transparent PBC, located on the PIA SBC 803, and electrically connected to the PCI interface 802 on the backplane 800 via 1001. PBC 914 are transparent PBC, one per ALA SBC, electrically connected to the PCI interface 802 via 910.

In a preferred embodiment, the PIA SBC could serve electrically as the bus mastering device (termed the “master” or “system” SBC, within the chassis of a CompactPCI preferred embodiment), and thus controls enumeration of the attached PCI external peripherals, it uses a non-transparent PCI-to-PCI bridge. The ALA SBCs use transparent PCI-to-PCI bridges to prevent bus interference, as they execute the “slave” or “peripheral” role in PCI signaling. The PIA and ALA SBC PBCs are implementing the standard behavior for the PCI bus architecture.

As described above, the invention relies upon an abstract network connectivity and communication abstraction which provides bi-directional network communication between endpoints. A preferred embodiment of this abstraction is the network socket abstraction, for specifying the programmatic idiom for communication between each of the SBC adapters. An alternate preferred embodiment would be distributed shared memory, which provides a comparable abstraction by emulating network connectivity and communication abstraction over a logically-flat memory space composed of the physical memory from one or more SBCs in the UIP.

PBCs 904 and 914 define functionality in bus timings, signaling, and other electrical bus-oriented operations. As such, the PBC/backplane implementation is not suitable for providing the required socket abstraction—as that abstraction relies upon a bi-directional communication path that does not include any functional bus-oriented operations.

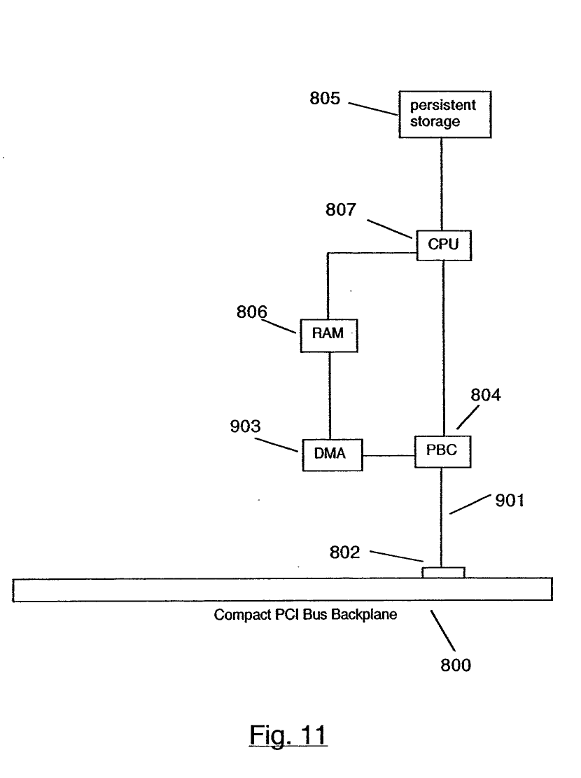

FIG. 11 illustrates the primary components involved in the simulation process. As is customary to reduce unnecessary detail, many components and electrical connections implicit in the block diagrams are not drawn. To achieve such abstraction, the CPU 807 and PBC 804 on each SBC coordinate to simulate a socket using device driver software. Such device driver software, is loaded into RAM 806 for use in the operating system kernel running on CPU 807 from persistent storage 805. As is common with device drivers, the driver is loaded into the kernel during the boot-up sequence of the OS on CPU 807. The network simulation is implemented by the device driver on CPU 807 translating socket requests into PCI bus operations on backplane 800 via PCI interface 802, and vice-versa.

Data values are placed into RAM 806 via a collaboration between PBC 804, CPU 807, and direct memory access (DMA) 1103. When data is read off backplane 800 via PCI interface 802, PBC 804, and device driver on CPU 807 coordinate to translate the bus signal into a socket read operation, moving the result of the read operation into RAM 806 via DMA 1103. Similarly, the inverse operation occurs for socket write onto backplane 800 via PCI interface 802.

One skilled in the art will readily appreciate that several other techniques for SBC connectivity are common. For example, the same functional embodiment is possible by connecting each SBC to an Ethernet switch, via an external Ethernet adapter. Thus, n-way electrical connectivity exists between each of the cards; with the Ethernet switch (not shown) and SBC Ethernet chip 907 providing the same functional role as the PBCs 804, 814 and the backplane 800. In this example, Ethernet chip 907 is implementing a live network stack, where instead CPU 807, 815 simulate a functionally-identical network stack when PBCs are used. As another example, the interconnect could autonomously perform the simulated network communication operations, implemented as direct coping from the source RAM 806 and into one or more RAM 806 on different SBCs, without involvement of or coordination with DMA 1103 or CPU 807.

Note that the embedded computer software (firmware), which runs on the invention, programmatically implements the abstract PPF model described below using this extensible asymmetric multi-computing device. The invention relies upon an abstract programming system which meets specific requirements for availability of programmatic constructs, such as the socket network abstraction; as such, any programming language commonly in use, which meets these conditions, can implement the minimal required functionality defined herein. One skilled in the art will also immediately recognize that the following abstract PPF model described below could be equivalently implemented by one or a set of ASIC, FPGA, or functionally-similar silicon components within the invention. Thus, whether the abstract PPF is implemented as firmware, silicon components, or a combination thereof is an attribute of an embodiment, rather than a defining attribute of the invention.

Having described the hardware components for a preferred embodiment of an apparatus embodying a multi-protocol integration system, observations about the structure and interdependencies of such can be identified. One skilled in the art will recognize that an individual SBC in the apparatus could combine the functionality of both a programmable interpretation adapter and an ALP logic adapter, without materially affecting the following description. Such a combined adapter would provide the combination of the functionality of both types of adapters. Within a specific instance of an apparatus for this invention, any number of programmable interpretation adapters or ALP logic adapters may be included. Thus, the quantity and mix of adapters in the invention should be considered an attribute of an embodiment of the invention, and not a defining attribute of the invention. The details and interpretation of multiple such adapters are defined as follows.

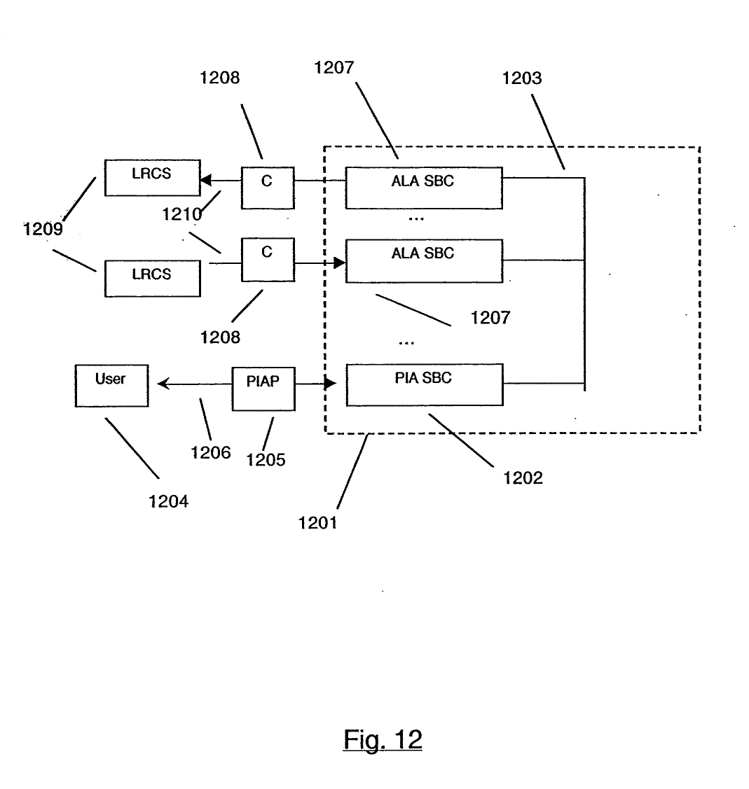

With respect to FIG. 12, an exemplary illustration of an adapter-level diagram of the invention with multiple adapters (SBCs) 1202, 1207 are shown. Each programmable interpretation adapter (PIA SBC) 1202 in the apparatus implements functionality which controls the execution of functionality within the UIC. Each PIA SBC can provide management, administration, configuration, or any similar functionality as required by a user of the apparatus. The embodiment of a PIA SBC for purposes of configuration are described below.

In contrast to existing systems, each PIA SBC 1202 does not execute software instructions which are specific to any ALP (with the potential exclusion of the application protocol which the user 1204 requires to access the PIA SBC 1202, such as RFC 854 or RFC 2068 as described below). Hence, the PIA SBC 1202 is executing the requisite management or brokering functionality, as defined above, required to implement the characteristics necessary for such universal integration platform. Users 1204 of the apparatus request and receive functionality from the UIC 1201 by establishing a PNC 1206 with the PIA SBC 1202.

Within the context of the multi-protocol integration system, each PIA SBC 1202 is an entry-point where users 1204 of the system can request services from the system. To implement such a service request, PNCs 1206 are established between the PIA SBC 1202 and each user 1204 requesting execution of an incoming user request (IUR). Each PIA SBC 1202 within the UIC 1201 offers an entry-point to users via a well-defined ALP 1205 specific to the UIC. This UIC-specific ALP 1205 is termed the PIAP. Any agreed upon ALP would suffice for a PIAP; a preferred embodiment of the invention uses the open, standardized Internet hypertext transfer protocol (HTTP), as defined in RFC 2068, as the PIAP.

Beyond serving as an entry-point, each PIA SBC 1202 provides programmable system control from the perspective of requesting users 1204. As described above, this system-wise programmability (whether for management, administration, configuration, or similar functionality) is a defining characteristic which differentiates the invention from devices which execute physical or network layer protocols. The user 1204 controlling such apparatus customizes the functionalities of the UIP via two broad uses of the PIA SBC. First, the user 1204 can load software instructions into the PIA SBC 1201, the semantics of which are not determinant from the invention. As such, any programming language which supports the socket abstraction could be used within this context. Second, the user 1204 can use specific configuration capabilities, as defined below, provided by the PIA SBC 1202 to configure the apparatus 1201 without use of programmatic code or software instructions.

For a variety of operational reasons (such as increased bandwidth, decrease latency, increased redundancy, providing fault-tolerance, or expanding user connection capacity), the apparatus can be configured with one or more PIA SBCs 1202 within a single UIC enclosure 1201. Each PIA SBC 1202 within the UIC 1201 acts autonomously with respect to all other PIA SBCs within the chassis, as each SBC is executing an independent instruction stream and utilizes independent RAM. Equivalently, each PIA SBC 1202 provides a concurrent implementation mechanism which can accept and process incoming requests from users 1204, without sharing any dynamic information (termed dynamic service state information, or DSSI) relevant to the handling of incoming requests being handled by all other PIA SBCs 1202 within the UIC 1201.

Continuing to refer to FIG. 12, ALP logical adapters (ALA SBC) 1207 implement exactly one application-layer protocol. Although capable of supporting at most one application protocol, each ALA SBC may support numerous different versions, subversions, revisions, or other similar refinements of that application protocol. The one-to-one relationship between each ALA SBC 1207 and the ALP which it is implementing is a unique attribute of the invention. Specifically, the recognition that each ALP should be implemented by a dedicated SBC is unique to the invention. Integration solutions built using common practice today do not use such an approach.

Each ALA SBC 1207 implements functionality which is not only asymmetric, but is logically constrained to a fixed logical function set (FLFS). This FLFS is defined in advance based upon the functional requirements of the specific type of computing system which the ALA SBC 1207 will connect with and the attributes of the ALP implemented by the ALA SBC 1207. Herein lies the contrast between an ALA SBC and any other computer hardware or software systems which implements application layer protocols: each ALA SBC is dedicated specifically and solely to implementing computer instructions which relate to the single ALP supported by the ALA SBC 1207. Equivalently, the ALA SBC 1207 will not execute any instructions that do not have bearing to the single ALP; the ALA SBC 1207 is not executing arbitrary general purpose computer instructions.

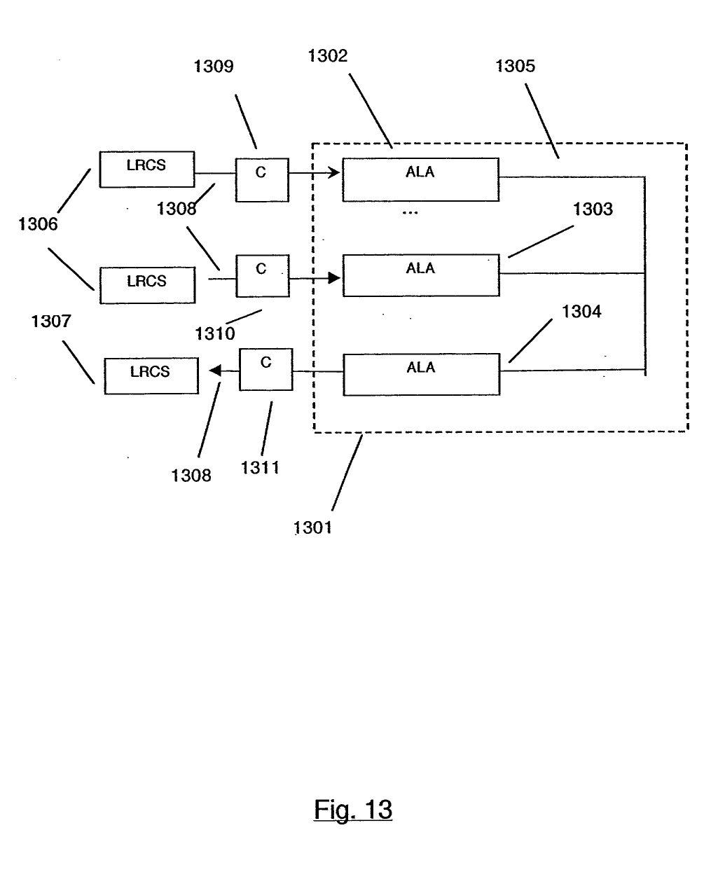

With respect to FIG. 13, a second exemplary illustration of an adapter-level diagram of the invention with multiple adapters (SBCs) 1302, 1303, 1304 are shown. The figure illustrates a representative data exchange and translation operation among 3 LRCS 1306, 1307 by the ALA SBAs 1302, 1303, 1304 in the apparatus 1301. Two source LRCS 1306 are connected to ALA SBCs 1302, 1303 in the apparatus 1301 via corresponding PNC 1308 using application protocols 1309 and 1310. One destination LRCS 1307 is connected to ALA SBC 1304 in the apparatus 1301 via a PNC 1308 using application protocol 1311. As described above, all of the ALA SBCs are connected via the interconnect 1305. Within this embodiment, the data exchange and translation occurs by translating data originating from source LRCS 1306 and exchanging it to destination LRCS 1307. This figure assumes that the configuration necessary for this data exchange and translation was previously established using a PIA SBC, compliant with the description above. As elaborated previously, the number and type of the ALA SBCs involved in FIG. 13 should be considered an attribute of an embodiment of the invention, and not a defining attribute of the invention.

Further, the number of logical remote computing systems (LRCS) 1209 which each ALA SBC 1207 supports concurrent connectivity contrasts with prior art. Specifically, each ALA SBC 1207 may enforce a bounded limit on the number of LRCS which can connect to each ALA SBC 1207 concurrently. The bounded limit on the number of LRCS may be specified by a user or may be a property of the ALA SBC 1207. Thus, the invention further contrasts with other such solutions which are designed to connect to any number of LRCS, performing any number of simultaneous connections with each.

Further, all ALA SBCs 1207 may not accept incoming IURs from users, nor do they implement general purpose logic associated with such user IURs. In the context defined above, each LRCS 1209 may be implemented by one or more physically independent computing systems, depending upon various operational requirements for the logical computing system. For example, computing systems which must be resilient to run-time failures, software programming errors, or for performance reasons are commonly aggregated together into clusters or fail-over pairs.

The invention is unique in that the capabilities of each ALA SBC 1207 are accessible by users for the functionality described above solely through PIA SBCs 1202 within the UIP 1201. Equivalently, each ALA SBC 1207 implements capabilities which are only accessible to users by invoking capabilities in the PIA SBC 1202, which are then delegated by the PIA SBC 1202 to the ALA SBC 1207 specific for such ALP. This contrasts with alternative systems which lack such asymmetry, facilitating users to access ALP capabilities via any general purpose CPU in the system.

Further considered unique to the invention, the LRCS 1209 is required to offer a single type of functionality via the specific PNC 1210 per ALA SBC 1207 which interconnects the UIP 1201 to the LRCS 1209. This constraint follows immediately from the requirement that each ALA SBC 1207 execute logic associated with a single ALP. This function-specific LRCS 1209 is referred to as a FS-LRCS, to emphasize the constraint that the LRCS 1209 is exclusively limited to offering capabilities from that specific logical functionality via a fixed function set. For example, the LRCS 1209 via the PNC 1210 could be implementing a specific type of computer database connectivity to access data stored in an arbitrary format, such as rectangularity in tabular format as required in structured query language (such as SQL).

The invention further depends upon specific implications of this one-to-one relationship between ALA SBC 1207 and ALP, as such relationship defines the relationship between the UIR, the PIA SBC 1202 handling the UIR, and the one or more ALA SBC 1207 executing the ALP requested in the UIR. As described above, connectivity between the ALA SBCs and PNC SBCs is provided via the interconnect 1203. As each SBC-to-FS-LRCS PNC 1210 is based upon exchange of a well-defined set of features, each SBC uses a ALP specific to the network encoding of such feature set. Thus, the PNC 1210 connecting the UIP 1201 and the FS-LRCS 1209 can be referred to as a FS-PNC, as the PNC 1210 is logically constrained to implement the single ALP which is appropriate for the function being provided by the FS-LRCS. Thus, each SBC not only includes a fixed and well-defined set of functionality, it also interconnects with LRCS exclusively via fixed and well-defined ALP. While the functionality of the SBC is bounded within a specific functional set, functions within the set defined by the ALP can be recursively composed to build arbitrarily complex operations. For example, the ALP for the FS-NIC with the database connectivity example would be a network encoding sufficient to represent the functional requirements of the SQL language.

Similar to how multiple PIA SBCs 1202 are supported within a single UIP, multiple ALA SBCs 1207 implementing the same ALP may exist in a single UIP, for a variety of operational reasons. While only a single ALA SBC 1207 is strictly required for supporting each ALP requested by the user 1204, multiple ALA SBCs 1207 may be included to improve operational performance (such as increased bandwidth, decreased latency, increased redundancy, providing fault-tolerance, or expanding user connection capacity). Similar to PIA SBCs 1202, each ALA SBC 1207 within the UIC 1201 acts autonomously with respect to all other PIA SBCs 1202 within the chassis. Equivalently, each ALA SBC 1207 provides a concurrent implementation mechanism which can simultaneously accept and process ALPs from any number of LRCS 1209, without sharing any DSSI relevant to the handling of incoming requests being handled by all other ALA SBCs within the UIC.

### Complementary Components

The preceding described a preferred embodiment of the invention via an apparatus which embodies a multi-protocol integration system, as defined above. What follows are descriptions of additional complementary components of a multi-protocol integration system whose capabilities would be advantageous in an apparatus. As such, one skilled in the art will immediately recognize that the following components are neither defining attributes of the invention, nor defining attributes of a preferred embodiment, nor defining attributes of the invention apparatus. Such complementary components are respectively methods or processes, as will be described below.

The components described below may equivalently be defined independently from the invention, any specific preferred embodiment, or the invention apparatus. The following components are described below within the context of a multi-protocol integration system to demonstrate their advantage and improve discussion clarity.

The discussion of complementary components is dichotomized into two groups: configuration and operation. This dichotomization scheme is deliberate, as the scheme embraces the difference between methods and processes driven by a user (configuration) from the pre-configured integration processes implemented by the multi-protocol integration system. In fundamental contrast to prior systems, the complementary components distinctly segment these two groups.

The configuration complementary components described below consist of the generalized functional integration process (GFIP), which is an abstract formulation for configuration independent of application protocol, and embodiments thereof. As will be described below, the capacity for users to specify configuration instructions to a multi-protocol integration system independently from the application protocol differs fundamentally from prior systems. A preferred embodiment of the GFIP, referred to as procedural process flow (PPF), will be described below. A preferred embodiment of GFIP dependent upon PPF, referred to as declarative configuration, will be described below. A preferred embodiment of declarative configuration is provided. Within the context of these characterizations, the specific hardware components which could compose such a system in an embodiment, and their interrelationship within the multi-processing/multi-computing apparatus are described and typified.

Subsequent to discussion of the configuration complementary components, a plurality of operation complementary components will be described below. Specifically, a method for logical dataflow within a multi-protocol integration system is described as the universal logical integration dataflow (ULID), with corresponding data processing algorithms therein. Within the context of the previous description, the ULID embodies operations which define how an intermediate virtual representation may be processed during exchange between interfaces. One skilled in the art will recognize that the ULID can be embodied by any system which provides a specific set of prerequisites, as described below. Therefore, embodying the ULID within an apparatus for a multi-protocol integration system is appropriately considered a preferred embodiment for the ULID.

### Generic Functional Integration Process

Using the above discussion of the complexity in facilitating exchange of data between computers having heterogeneous application level protocols using prior systems as a reference, configuration for a multi-protocol integration system using GFIP can be contrasted with prior systems. GFIP facilitates a integration process to be configured for a multi-protocol integration system using a common process which is independent from the application protocol. Within the invention apparatus, GFIP facilitates configuration of the configuration table in the invention for each ALA SBC. This fundamentally contrasts with prior systems which lack such configuration universality, as their configuration is dependent upon one or more application protocols involved in the integration process being configured.

The generic functional integration process (GFIP) is a process common to all application protocols which facilitates a user to configure an integration process for a multi-protocol integration system. As will be described below in the context of a preferred embodiment, configuration universality arises from the well-defined programmatic interaction between the various SBC adapters, each of which fulfills a specific well-defined part within the larger service process of fulfilling each UIR, as defined by GFIP.

The GFIP consists of the following steps: (1) accept an IUR from a user via a PNC; (2) interpret the IUR and identify the specific integration process being configured and ALPs required to implement such a process; (3) identify each ALA SBC which implements each corresponding ALP; (4) bi-directionally communicate with each ALA, to handle the respective request and reply processing for configuration of each ALP; (5) aggregate the results from all the ALA SBCs communicated within the previous step; and (6) return the result of the integration configuration back to the user which requested the original IUR. This process is the abstract formulation of the functional semantics necessary to implementing such an universal integration platform.

A preferred embodiment of GFIP consists of the 13-step procedural process flow (PPF) process. Within the context of the invention apparatus described above, the PPF formalizes the interaction between PIA and ALA SBCs as necessary for facilitating configuration of a multi-protocol integration system. The relationship between GFIP, PPF, and PIA SBCs is as follows: the PPF is a preferred embodiment of GFIP and each PIA SBC implements an embodiment of the PPF.

GFIP and PPF combine to express the essential intent and design for a preferred embodiment which facilitates configuration of the invention for an integration process. Further, this exemplifies that the invention delivers configuration which is independent of application protocol, for a universal integration system by using a specific configuration of hardware combined with a specific integration method.

The 13-step procedural process flow is a request-reply cycle for a single user configuration request for integration with this invention. In operational terms, the PPF describes how a user communicates with the UIP to execute each task which requires integration of multiple application-layer protocols. The specific implementation semantics of each step within this PPF, as implemented within this apparatus, can be instantiated via any control mechanism which meets the functional requirements for this abstract computing system; no specific software embodiment is required, as many such embodiments can be programmed to meet such requirements.

The PPF process is as follows for a given IUR being executed by a given PIA SBC for a given UIP. As described in detail above, the essential defining characteristic of PPF is that it is independent from application protocol, and thus is universally usable for configuring arbitrary integration processes which use a plurality of arbitrary application protocols in the invention. In this context, the term instantiation is defined to mean the procedural implementation of the steps required to complete a specific process.

In this context a IUR will correspond to one or more configuration instructions, the structure and organization of which are attributes of an embodiment. Finally, in this context the term configuration updates corresponds to instructions which update one or more parameters of a multi-protocol integration system, such as finite state machines, logic paths, junctures, stored values.

The steps of this PPF are as follows

(1) IUR commencement: a user requests functionality from the UIP via establishing a PNC between the user's logical remote computing system LRCS and the PIA SBC (which is listening for such a PNC establishment request), then submitting an IUR using the format and semantics defined by the agreed upon PIAP; specifically, the user writes a sequence of bytes, or any equivalent computational form, adherent to the constraints defined by the PIAP, representing the IUR to the UIP via the PIA SBC-to-LRCS PNC.

(2) request receipt: the PIA SBC receives the IUR, via the PIA SBC-to-LRCS PNC established in (1), and parses the sequence of bytes, or any equivalent computational form, representing the IUR (adhering to the PIAP constraints) into a representation which is usable by the UIP. The representation of the IUR will depend both upon the PIAP and the computational representation of the specific embodiment of configuration updates. Specifically, the IUR is translated from the network encoding required for the PIAP into a intermediate integration representation (IIR) using RAM located on the PIA SBC. The IIR is unrelated to the intermediate virtual representation defined previously, yet may be embodied by such.

(3) request interpretation: the PIA SBC interprets the IIR, as received in (2), to implement the one or more user configuration requests encapsulated in the IUR. In doing so, interpretation of the IIR indicates the ALA SBCs (and thus, LRCS and ALPs) of which functionality must be requested from. The IIR is interpreted as, or translated into, a set of machine code instructions which are executed by the one or more CPUs on the PIA SBC. As described above, the precise semantics of interpretation will depend upon the embodiment of the configuration updates. Irrespective of the embodiment, the interpretation process by the PIA SBC CPU uniquely identifies which ALA SBCs should be requested by enumerating the distinct functional sets required to implement the IUR, which may optionally require evaluation of one or more parameters for integration processes which are configured or partially-configured in the UIP via previous PPF instantiations or functionally equivalent. The subset of the IUR, which may be mutually-exclusive among ALA SBCs, which must be executed by each specific ALA SBC is termed the application-specific IUR (ASIUR) respective to that ALA SBC.

(4) IUR delegation: for each ALA SBC which is required to implement configuration updates corresponding to the ASIUR in (3), the PIA SBC establishes a dynamic service state information connection (C-DSSI) with the appropriate ALA SBC. For each ALA SBC, there is a one-to-one relationship with the PIA SBC handling the user request defined in (1). Thus, if there are n ASIUR which must be executed, then n C-DSSI are established with n ALA SBCs; the PIA SBC physically requests connection of the C-DSSI from the interconnect using the appropriate connectivity signaling mechanism.

(5) ALA connection: for each ALA SBC which established a C-DSSI with the PIA SBC in (4), the PIA SBC transmits the ASIUR specific to that ALA via the C-DSSI; the PIA SBC transmits a sequence of bytes, or any equivalent computational form, which encodes the ASIUR in a form appropriate for communication over the C-DSSI to the respective ALA SBC.

(6) ALA interpretation: for each ALA SBC which receives a ASIUR from the PIA SBC in (5), the ALA interprets the ASIUR and translates the ASIUR request into a sequence of configuration update instructions, possibly specific to that ALA SBC, which can be executed by the ALA SBC to fulfill the ASIUR. As with IUR interpretation, ALA SBC interpretation of the ASIUR may depend upon the specific embodiment for how configuration updates are computationally represented by the IUR and PIAP. This ALA-specific sequence of instructions is termed the application-specific integration representation (ASIR). Specifically, the ALA SBC receives the ASIUR via the C-DSSI, parses the sequence of bytes, or any equivalent computational form, into an internal functional representation stored in RAM. This internal representation is appropriately structured for execution on the ALA, as necessary to implement the configuration update requested by the IUR, usually defined as a sequence of instructions appropriate for the ALP which the ALA uses to communicate with the LRCS to fulfill the ASIUR

(7) ALA-LRCS communication: an IUR may require the ALA SBC to propagate configuration parameter changes to the one or more LRCS corresponding to that specific ALA SBC as defined by the IUR. In such cases, for each ALA SBC which defines an ASIR to execute the ASIUR in (6), the ALA SBC establishes a PNC with the respective LRCS and bi-directionally communicates the appropriate translation of the subset of the ASIR appropriate for that LRCS via the ALP which is mutually shared by the originating ALA SBC and the LRCS. This bi-directional communication over the PNC results in implementation of the ALP-specific formatting and logic necessary to convey the semantics of the LRCS-specific translated subset of the IUR to the LRCS using the ALP which the LRCS uses. The implementation of the ALP-specific logic by the ALA SBC results in the ALA SBC generating a set of ASIR parameter results (ASIRPR), based upon results which the LRCS returned in response to specific results from the ALA SBC embedded in the ALP over the PNC. Specifically, the ALA SBC establishes one or more physical PNC with the LRCS, as necessary; the ALA SBC conveys the ALP representation of the LRCS-specific translated subset of the ASIR to the LRCS over such PNC; the ALA SBC stores the intermediate results of the bidirectional communication between the ALA SBC and the LRCS into RAM.

(8) PIA result receipt: for each ALA SBC which generates ASIRPR in (7), the ALA SBC communicates such ASIRPR to the originating PIA SBC in (6) via the C-DSSI; specifically, each ALA SBC translates the ASIR parameter results from the corresponding LRCS into a sequence of bytes, or any equivalent computation form, which is then physically transmitted between the PIA and ALA SBCs via the C-DSSI established in (4).

(9) result interpretation: upon receipt of each ASIRPR by the PIA, for each respective ALA defined in (3), the PIA interprets the encoding of the ASIRPR and stores the results for completing interpretation of the IIR; the PIA receives the ASIRPR via the C-DSSI, interprets the sequence of bytes, or any equivalent computational form, which the ALA SBC encoded the ASIRPR for transmission over the C-DSSI, and then stores the interpreted result in RAM on the PIA SBC.

(10) intermediate IUR termination: for each ALA SBC a C-DSSI was established in (3), the PNC for the C-DSSI may be optionally disconnected, reflecting completion of the ASIUR after receipt by the PIA SBC of all the parameters from the ALA SBC required to implement the subset of the IUR corresponding to the specific ALA SBC; the PIA optionally physically requests the C-DSSI be disconnected from the interconnect using the appropriate connectivity signaling mechanism.

(11) result composition: the PIA SBC aggregates all the ASIRPRs as conveyed to the PIA SBC in (8) by each of the ALA SBCs, completes any requisite interpretation of the IIR built from the UIR, and then formats the set of parameter results appropriately using constrains required by the PIAP; the set of ASIRPRs results, stored in the RAM of the PIA SBC, are functionally transformed appropriately together based upon the functional requirements specified in the IUR; after functional transformation, the results are encoded into an outgoing byte sequence which matches the formatting requirements for the PIAP. The precise interpretation and transformation operations required of the IUR may depend upon the specific computational representation of the embodiment of the configuration updates.

(12) result delivery: the outgoing byte sequence defined in (10) and (11) may be delivered to the user via the PNC established between the PIA SBC and the user in (1). Or, the outgoing byte sequence defined in (10) and (11) may be delivered to the user via a second PNC which is established between the PIA SBC and the user, equivalent to the method specified in (1), as initiated by either the PIA SBC (asynchronously) or the user (synchronously). The sequence of bytes, or any equivalent computational form, encapsulating the result of the functional transformation defined by the UIR are physically written to the PNC established in (1).

(13) IUR termination: optionally based upon the appropriate conventions of the PIAP, the C-DSSI between the PIA and RCS established in (1) is logically closed, indicating completion of the IUR; if the C-DSSI is not logically closed, then some PIAP-specific mechanism is used to signal the completion of the request-reply cycle for a IUR. The PIA SBC physically requests disconnection of the C-DSSI from the interconnect using the appropriate connectivity signaling mechanism, breaking the communication path between the pair. If the PNC is not physically closed, then alternatively a PIAP-specific token is sent from the PIA SBC to the LRCS via the PNC (without disconnection) indicating that the IUR is complete; this signal implicitly indicates that another IUR can subsequently be submitted by the RCS to the PIA for processing within the UIC.

The PPF defines the 13 steps necessary to execute a single IUR configuration update for a single user. At any given time, a PIA may be concurrently processing an arbitrary number of independent IUR requests. For each independent IUR being interpreted by the PIA SBC, this process is executed in its entirety. One skilled in the art will recognize that logical optimizations performed on behalf of multiple concurrent IUR requests, such as reusing C-DSSI connections between PIA SBC and ALA SBCs, are attributes of an embodiment of the PPF and thus neither defining attributes of GFIP nor defining attributes of the invention.

Having identified the process steps for PPF, several abstractions about requirements for individual hardware components within a composite apparatus, are observable. These abstractions further exemplify how the invention relies upon how the specific computer hardware components are combined (rather than inherent physical or design characteristics of the components themselves), then used to implement a well-defined integration method.

First, at least one PIA SBC and one ALA SBC are required to implement non-degenerate configuration update functionality as required by a IUR. Non-degenerate functionality is defined as any functionality which requires access to one or more LRCS to access one or more data or invoke one or more remote application software capabilities. For non-degenerate functionality, at least one PIA SBC is required to provide the programmable interpretation required to fulfill a IUR. For non-degenerate functionality, at least one ALA SBC is required to access the LRCS and implement the ALP required therein.

Second, PIA and ALA SBCs mutually share dynamic service state information (DSSI) as defined above. Implementation of an IUR is dependent upon sharing state information dynamically in real-time between the PIA SBC, which is driving interpretation of the IUR, and the ALA, which is implementing the logic necessary for the application-specific task requested by the user via the IUR. An ALA SBC may share DSSI, corresponding to a single IUR, with exactly one PIA SBC. A PIA SBC may share DSSI, corresponding to a single IUR, with any number of ALA SBCs. The number of ALA SBCs which share DSSI with the PIA SBC is based upon the number of LRCS connections required to implement the functionality defined in the IUR.

Third, PIA and ALA SBCs establish PNCs with a mutually distinct set of LRCS, as lURs originate from users of computing systems which are independent from the LRCS implementing the ALP required for each ALA. One skilled in the art will recognize that a user can operate a distinct software application on a LRCS, yet accessing the PIA SBC for configuration, without violating this constraint.

Precisely how the PIA and ALA physically share such DSSI can be implemented via any method which supports electrical connectivity between the two SBCs. In a preferred embodiment of the invention, the SBCs ideally share DSSI via a physical connection established across the interconnect of the chassis. This physical connection is termed the C-DSSI previously. However, any mechanism for connection which supports this requirement would be sufficient. For example, an illustrative means for connectivity would be an external Ethernet connection between the two SBCs, whether directly connected or bridged via a switch or router.

The following is a sample embodiment implementation of the 13 step PPF model, using the hardware embodiment of a multi-protocol integration system described above. This flow model abstracts the physical component detail, instead relying upon a block flow diagram to clearly elucidate how this procedural process maps to the physical embodiment. FIGS. 8 and 9 can be decomposed into three discrete regions, those corresponding to: (1) the PCI backplane 800; (2) a PBI SBC adapter, the left branch line bounded by blocks 811 and 802; and (3) a representative ALA SBC adapter, the right branch line bounded by blocks 812 and 802.

The following 13-step process describes an embodiment of the PPF. An embodiment of the configuration updates, which provide an alternate preferred embodiment for the IUR request and operational semantics of IUR as experienced by the user, is described subsequently to this embodiment. The following maps the functional specification to the specific physical components implementing such process:

(1) IUR commencement: User 811 opens a PNC to SBC 803 (907 implements the requisite Ethernet protocol stack on SBC 803) to signal the IUR, via fabric 813 and physically connects to SBC 803 via network connection 810. The PNC 810 requests a common TCP/IP connection with Ethernet chip 907, providing bidirectional data exchange capabilities between user 811 and SBC 803 using the socket network abstraction. For this example, the PAIP for such PNC is defined via HTTP over TCP/IP and uses the common request-reply model to exchange data necessary for implementing the IUR.

(2) request receipt: the CPU 807 of the PIA SBC 803 receives the request for the IUR from Ethernet chip 907, via traditional interrupt signaling, and accepts the incoming PNC as a network socket relying upon Ethernet chip 907 and the OS to implement the framing and protocol layer semantics. CPU 807, in conjunction with RAM 806, parses the HTTP into its component parts using common lexical analysis by CPU 807. The parsed result is stored in RAM 806 for rapid access on PIA SBC 803.

(3) request interpretation: based upon the request parsed from HTTP, encapsulating the IUR from user 811, SBC 803 interprets which ALA SBC adapters (from the available set of 816, 817, 818, and 819) are required to implement the functionality defined in the IUR. This embodiment relies upon the HTTP request being formatted to specify the ALP explicitly in the URL, as is common for many programming systems designed for the Internet. With the ALP being transparently recognizable from the IUR, the PIA SBC then only must implement a simple mapping between ALP and ALA SBC. Specifically, the PIA SBC must maintain a hashtable which implement a function f, where f(ALPₗ)−>ALA SBCⱼ. Any common hashtable implementation would suffice to implement this simple function.

In this example, the IUR from user 811 is assumed to specify functionality which requires at most one ALA SBC to implement. This simplifying assumption is made solely for clarification, and should not be considered an attribute of the invention. This same process can be implemented concurrently with other ALA SBC adapters using the same implementation as described herein. Further, the format and bytestream representation of the ASIUR can be represented by a variety of processes; this embodiment relies upon the simple textual representation of the IUR, as provided by user 811 based upon HTTP. As such, the IIR for this embodiment is the same as the IUR request, as is common in many embodiments. This intermediate representation of the IUR is stored in RAM 806 on PIA 803.

(4) IUR delegation: PIA 803 establishes a C-DSSI with ALA SBCⱼ using socket abstraction. Such C-DSSI connection establishment is implemented via backplane 800, PBC 804, 814, RAM 806, connection 901, 910, and DMA 903 using the network socket simulation technique using the PCB bridging techniques described above and illustrated in FIG. 10.

(5) ALA connection: PIA 803 communicates the ASIUR to ALA SBCⱼ using the simulated socket connection constructed in (4), above. Specifically, the IIR stored in RAM 806 on SBC 803 is transmitted over backplane 800 via PBC 804, 814, using connection 901, 910, as the electrical connectivity across backplane 800. Upon receipt by PBC 814, CPU 815 and DMA 903 cooperate to store the ASIUR in RAM 806 via electrical connectivity 904 and 905. This results in the ASIUR being stored in RAM 806 and being available for interpretation by CPU 815 on ALA SBCⱼ.

(6) ALA interpretation: ALA SBCⱼ translates ASIUR into ASIR using CPU 815, in preparation for ASIR to be encoding into ALP for transmission to the LRCS 812, having received the ASIUR via the C-DSSI. In this example, ASIR is identical to ASIUR. The ALP expected by LRCS 812 is identical to what the LRCS 811 provided in the original IUR. Thus, no intermediate transformation of the ASIUR is required by ALA SBCⱼ. The ASIR is stored in RAM 806 on ALA SBCⱼ, awaiting transmission to LRCS 812. As with other simplifying assumptions, persons of ordinary skill in the relevant art will note that many more sophisticated encoding and ASIUR−>ASIR transformations could be implemented by alternative embodiments. However, this example intends to most effectively convey salient implementation attributes, rather than be overly complex.

(7) ALA-LRCS communication: if required by the semantics of the specific IUR, according to the manner defined previously in the abstract formulation, ALA SBCⱼ establishes a PNC to LRCS 812, in the manner defined above specific to ABA SBC adapters, and transmits the ASIR in the ALP format mutually agreed upon by ALA SBCⱼ and LRCS 812. CPU 815 requests that a PNC be constructed, ala the socket abstraction, using Ethernet chip 907 via electrical connection 908 and 909. Similar to other network connectivity, LRCS 812 accepts the network connection and establishes a bidirectional communication path between LRCS 812 and CPU 815. As is common, intermediate representation of data being transmitted via Ethernet chip 907, is stored in RAM 806 on ALA SBCⱼ. As ASIR is identical to ALP, in this embodiment, ALA SBCⱼ simply communicates ASIR over PNC to LRCS 812. Upon receipt, LRCS 812 responds by communicating the ASIRPR of the request defined in ASIR back to ALA SBCⱼ. Upon receipt, ALA SBC, stores such parameter results in RAM 806.

(8) PIA result receipt: using the same bidirectional process defined in (5) the C-DSSI, but in the reverse direction, ALA SBCⱼ communicates the parameter results received from LRCS 812 in (7) to SBC 803, in response to the respective ASIR request which corresponds to the IUR from the original user 811 which PIA 803 delegated ASIR to ALA SBC, in (4). PIA SBC 803 stores the ASIRPR in RAM 806 for subsequent interpretation and communication back to user 811.

(9) result interpretation: the ASIRPR received from ALA SBC, in (8) via the C-DSSI, stored temporarily in RAM 806 is interpreted by CPU 807 in PIA 803. In this example, the ASIRPR is returned verbatim to user 811 without intermediate transformation. This results in the ASIRPR being returned to user 811 directly, without adding an intermediate layer of transformational complexity. As above, this simplifying assumption is an embodiment implementation detail and not a defining attribute of the invention.

(10) intermediate IUR termination: the C-DSSI connection established between PIA SBC 803 and ALA SBCⱼ is disconnected, via a closure operation upon the simulated socket. Specifically, the device driver executed in the OS of CPU 807 signals to PBC 804 that the simulated socket should be closed, which is then translated into the PCI bus signals appropriate to signal PBC 814 of the pending connection closure. PBC 714 notifies CPU 815 of the closure, then signals acceptance of the closure to PBC 804. Finally, PBC 804 signals physical acceptance of the simulated socket closure to CPU 807 and the connection is terminated independently by both CPU 807 and CPU 815.

(11) result composition: as a single ALA SBC was involved, no result composition is necessary; had multiple ALA SBCs been involved, as identified by the IUR in (3), then CPU 807 on PIA 803 would perform a simple aggregation of the ASIRPR from each ALA SBC in (9) via a common textual concatenation operation. The concatenated text is then considered the composed ASIRPR and whose composite is also stored in RAM 806.

(12) result delivery: the PNC established between PIA 803 and user 811 is then used to communicate the composed ASIRPR to LRCS via the same socket abstraction, but in reverse, using connection 810, fabric 813, Ethernet chip 907, connection 908 and 909 as defined in (1). The ASIRPR is encoding in the PIAP for communication back to user 811; in this embodiment, the PIAP is HTTP over TCP/IP, which results in the generation of a standardized HTTP response packet by CPU 807 and Ethernet chip 907 which encapsulates the composed ASIRPR response to the original IUR from user 811. As PIAP in this example (HTTP) is a common requestresponse protocol, the PNC initiated in (1) can be used in this example for returning the reply, encoded appropriately for the PIAP, to the user.

(13) IUR termination: the PNC may optionally be closed by user 811, depending upon the requirements being fulfilled by user 811. The PIAP ALP, HTTP in this embodiment, includes a provision for either user 811 or PIA SBC 803 to optionally specify physical closure at this step. If user 811 opts to physically close the PNC, then Ethernet chip 907 is notified of the closure request via normal TCP/IP connection semantics. Ethernet chip 907 relays the closure request to CPU 807 which then disconnects the socket abstraction and releases the computational resources in RAM 806 allocated for this process. Note that in this example, the PIAP ALP (HTTP) implements the optional PlAP-specific non-physical token closure mechanism via the backplane 200 OK result status code. The backplane 200 result code indicates successful completion of the last request which was submitted via the PNC.

### Declarative Configuration

Referring to FIG. 14, a process for configuration termed declarative configuration 1403 is defined. Declarative configuration 1403 serves to facilitate arbitrary configuration of integration processes by users 1401 without the user 1401 having to explicitly or implicitly specifying programmatic code. In this context, programmatic code is defined to be any human-readable, machine-readable, or combination thereof which is source code, object code, executable code, or any equivalent intermediate form inbetween written in a manner which uses or is logically equivalent to a programming language. A preferred embodiment for declarative configuration will be described below.

Declarative configuration 1403 is one of three preferred embodiments described here for configuring the multi-protocol integration system for integration processes. Declarative configuration 1403 is particular to the invention, while the other two, common to prior systems, are: programmatic code and graphical. Thus, declarative configuration is an embodiment of an abstract formulation which could serve to interpret an IUR, as described above, within an embodiment of the GFIP such as PPF.

To contrast declarative configuration with prior systems, a summary for programmatic code configuration and graphical is described. Specifically, programmatic code configuration enables the user to instruct specific procedural instructions for the instantiation, via writing and compiling programming code (such as in Java), which adheres to a specific application programming interface (API). The compiled programmatic code must be installed or uploaded, at which time it will be available for use. Further, graphical configuration enables the user to instruct specific procedural instructions for the instantiation, via use of a graphical user interface (GUI) such as program written in HTML for use via a browser on the Internet or a custom program for Microsoft Windows. The system implementing the GUI uses the configuration instructions provided by the user via the GUI to generate some instance of programmatic code, whether compiled, interpreted, or other alternative translation into a form executable on a computer system, or its functional equivalent.

The defining characteristic of declarative configuration 1403 is that it provides a method in which users 1401 can provide configuration instructions to an instance of an embodiment 1402 of the multi-protocol integration system without writing any programmatic code or generating code with a graphical user interface, as common to prior systems. The following are attributes of declarative configuration 1403, as illustrated in FIG. 14, which further demonstrate contrast with prior systems. First, as declarative configuration 1403 is initiated by user 1401, non-programmatic configuration is a capability of GFIP, rather than functionality which is independent or an extension, and thus an “add-on” or equivalent. Second, the instructions provided by the user 1401 to declarative configuration 1403 do not generate programmatic code which must subsequently be compiled, interpreted, loaded or otherwise managed similar to programmatic code by users. Third, neither the abstract formulation nor embodiments require the structure of declarative configuration 1401 to be defined, adherent to, or otherwise affected by an application programming interface (API) for programming code or equivalent.

Continuing to refer to FIG. 14, the method provided by declarative configuration 1403 is translating one or more configuration instructions (for example, as embodied by a UIR, as described above, or any logically equivalent) from a user 1401 to one or more configuration tables 1406 associated with one or more instances of the composite set 1405 of finite state machine 1407, bytestream 1409, and intermediate virtual representation 1408, as described above. The declarative configuration 1403 relies upon communicability with each of the composite sets 1405 via a connection 1404. An abstraction formulation for such connection 1404 is provided above, while a preferred embodiment for such connection 1404 is provided below. The abstract functional role for configuration tables 1406, as they correspond with finite state machines 1407 and exception tables (not illustrated, for clarity; see below for a description), within the multi-protocol integration system is described in below.

One skilled in the art will recognize that although 2 composite sets, with two configuration tables, are shown in FIG. 14, the number of composite sets is not a defining attribute of declarative configuration 1403. Instead, declarative configuration 1403 can configure any plurality of configuration tables and corresponding composite sets 1405. In addition, to improve clarity, FIG. 14 omits specific details about the composite set, which are described in greater detail above and below.

A preferred embodiment for declarative configuration particular to the multi-protocol integration system contrasting with prior systems would be the combination of two components. First, a component capable of providing the user 1401 with a command line interface (CLI), supporting a network protocol over the connection 1410 such as RFC 854 (the embodiment of such may optionally include a terminal emulation, such as VT100). Second, a component capable of translating the CLI commands provided by the user 1401 via the connection 1410 into a format appropriate for the configuration tables 1406. A preferred embodiment for providing such translation of one or more configuration instructions, as would be embedded within one or more CLI commands, is described above for RFC 2068.

Such a preferred embodiment of declarative configuration 1403 would provide an embodiment which provided a non-programmatic, human-readable display format which enabled a user 1401 to specify arbitrary configuration instructions for arbitrary integration processes.

Multidimensional Representation Transformation and Transaction Representation

One preferred embodiment for the intermediate virtual representation is provided here, whose attributes should be considered specific to the embodiment and thus not defining attribute of the characteristics of the invention. The following embodiment of the intermediate virtual representation is termed the multidimensional representation transformation and transaction representation (MRTR).

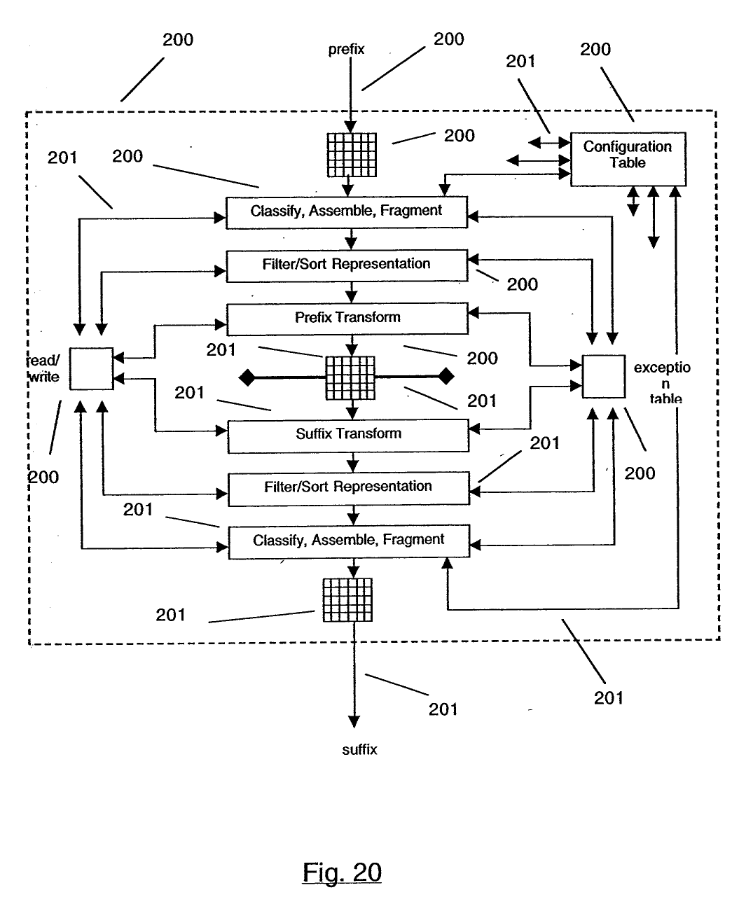

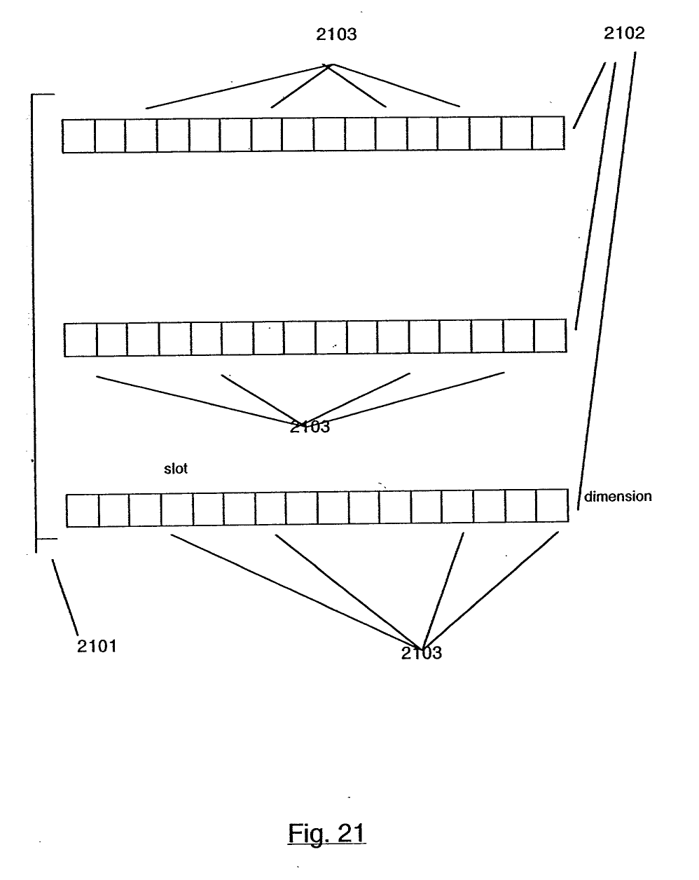

Referring to FIG. 21, the intermediate virtual representation is illustrated by this embodiment via one or more logically-contiguous sequences 2102 of zero or more logical elements 2103. Each individual element 2103 of a sequence 2102 is termed a slot. Each logically-contiguous sequence of logical slots 2102 is termed a “dimension”. Each instance of the intermediate representation corresponding to this embodiment, consisting of one or more dimensions 2102, is termed a region 2101. The quantity of dimensions 2102 in FIG. 21 is an attribute of a specific region instance; equivalently, the number of dimensions in a region is not an attribute of this embodiment.

Within this context, each slot 2103 should be interpreted as a “placeholder” or “logical unit”, rather than as an insertion point or similar interpretation arising from any specific physical interpretation (such as, for example, might be found on an embodiment of the hardware, as described previously). Thus, slots may be opaque in the interpretation that their structure does not imply a particular instantiation (such as a one-to-one mapping between slots and bytes), although such a defined structure may be illustrated by an embodiment or a specific instance of an embodiment. Slot opacity provides many benefits, for example enabling multiple concurrent data consumers to view the same dimensions in logically inconsistent ways, as described below. Further, the mechanism in which slots 2103, dimensions 2102, and regions 2101 are computationally implemented are not defined by the invention.

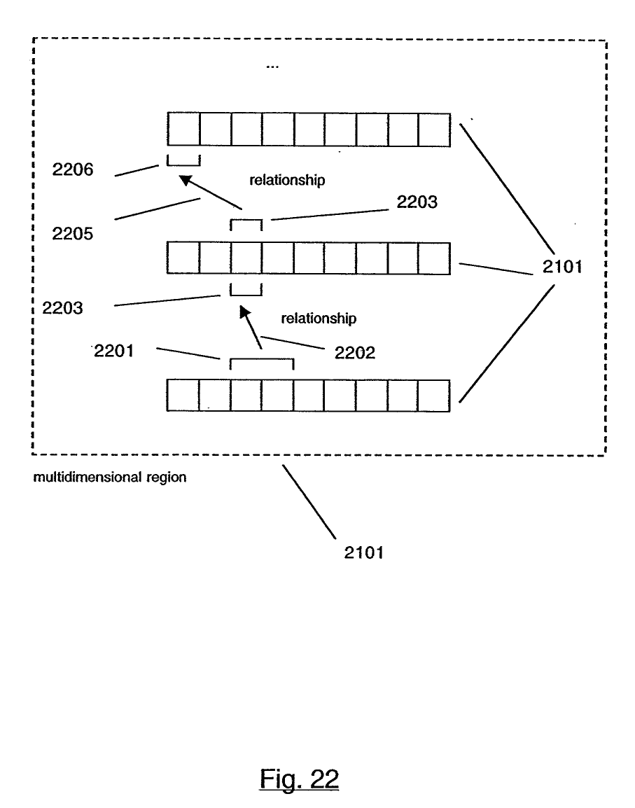

Referring to FIG. 22, a multidimensional region 2101 is composed of dimensions 2102, as in FIG. 21. A contiguous range of slots 2201, 2203, 2006 are contained within their respective dimension 2101, where a range is defined to be one or more slots which are contiguous in the same dimension. The dimensions within a region may have zero or more relationships, whether explicit or implicit. An relationship is defined in this context as a logical correspondence which may materially affect one or more operations performed upon the region 2101. One embodiment for operationalizing relationships within a MRTR is via annotations, as described below. One skilled in the art will appreciate that any criterion which can be computationally quantified, can equivalently be expressed as a relationship among dimensions, whether applicable to all MRTR intermediate representations or only specific to one or group of protocols or formats.

Referring to FIG. 23, an explicit annotation 2302 is a relationship which is denoted via specific corresponding values within one or more slots 2301 in the same dimension 2101. An implicit annotation 2303 is a relationship which is not denoted via specific corresponding values within one or more slots in the same dimension. Instead, the corresponding annotation value for the implicit relationship is maintained externally from the dimension 2101, and corresponding dimension, via any mechanism which can temporarily store the corresponding value. Thus, an annotation may be either explicit or implicit. For implicit relationships, one or more types of annotation identifiers 2304 may be required to logically associate the annotation storing the corresponding value with the one or more slots 2301. Neither the number and types of relationships among regions nor their operational interpretation, given a plurality of such relationships are possible, is not considered an attribute of MRTR

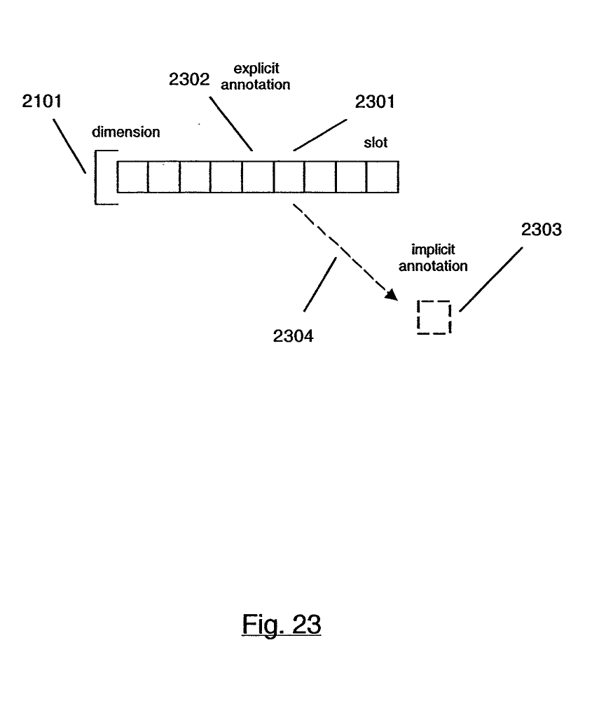

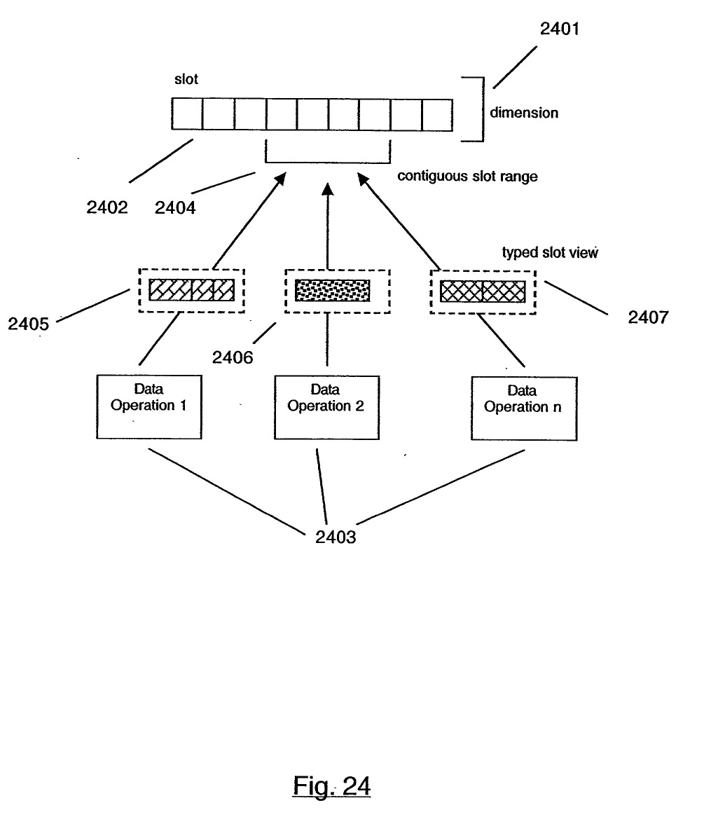

Referring to FIG. 24, a secondary function for annotations within MRTR is to provide attributes for individual slots 2402 or ranges of slots 2404 within a dimension. One example of an attribute could be type, as defined in programming language theory, as illustrated in FIG. 24. Thus, the blocks in FIG. 24 should be considered an attribute of implementing and interpreting a type attribute for a specific instance of a dimension, and thus not defining characteristics for MRTR annotations. Specifically, the dimension 2401 could maintain data being used in one or more concurrent integration process data operations 2403. Each data operation could view the data maintained by the slots with the type annotation in a type-incompatible manner. For example, a representative data operation 1 could view the slot data as type t1 2405, while data operations 2 and n interpret the slot data as type t2 2406 and t3 2407, where each type t1, t2, t3 differs mutually. The term view in this context is intended to be interpreted generally, to refer to any process of logical interpretation or similar. The difference in type is illustrated in FIG. 24 by the differing visual patterns in slot views 2405, 2406, 2407. The visual patterns are purely for display clarity and not a defining attribute of MRTR.

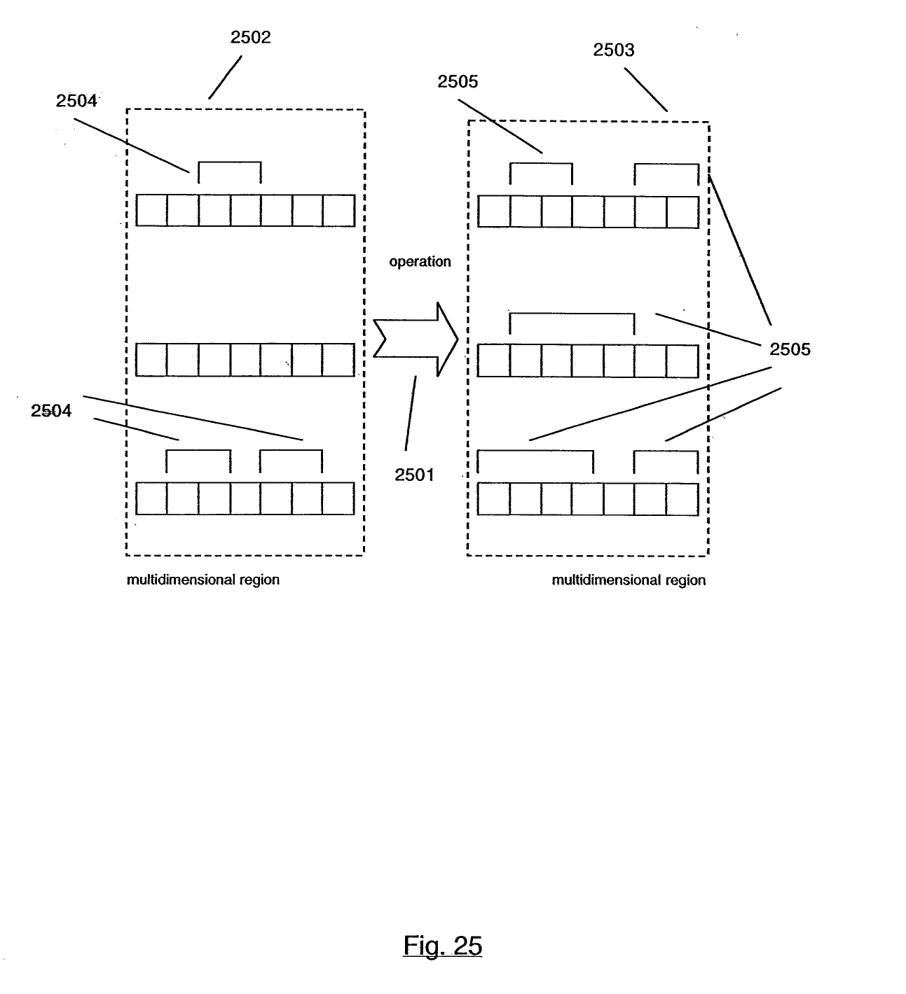

Referring to FIG. 25, MRTR supports the definition, instantiation, and operationalization of arbitrary computational operations defined over any combination of slots, ranges, dimensions, and regions, just as such operations can be defined over any well-defined abstract formulation. Further, both basic and composite operations can be derived, as necessary to facilitate arbitrarily complex data exchange and translation algorithms as necessary by the invention.

One embodiment for an abstract formulation for computational operations 2501 upon MRTR is defining a functional relationship between a source region 2502 and a destination region 2503. The functional input from the source region 2502 consists of one or more slots or ranges 2504. The functional output into the destination region 2503 consist of one or more slots or ranges 2505. The relationship between the input slot and ranges 2504 and the output slots or ranges 2505 is independent. Thus, the functional operation may result in differing number, size, or shape of output slot or ranges 2505. Further, the functional operation may result in modifications to slots in different dimensions of the destination region 2503 than the source region 2502. Finally, the functional operation may result in slots or ranges 2504 which are contiguous in the source region 2502 becoming discontiguous in the destination region 2503. Anyone skilled in the art will recognize that operations 2501 can also be composed recursively and also utilize conditional logic, facilitating implicit dependencies among and between operations.

A key advantage of this type of flexible computational operations is the ability to specify what otherwise would be complex, potentially composite, operations (e.g., require many individual programming code lines in a traditional programming Inaugage, such as Java) over slots, ranges, dimensions, or regions using a single logical operation. Finally, anyone skilled in the art will recognize that arbitrary many-to-many computational operations can be defined via composition of discrete computational operations 2501.

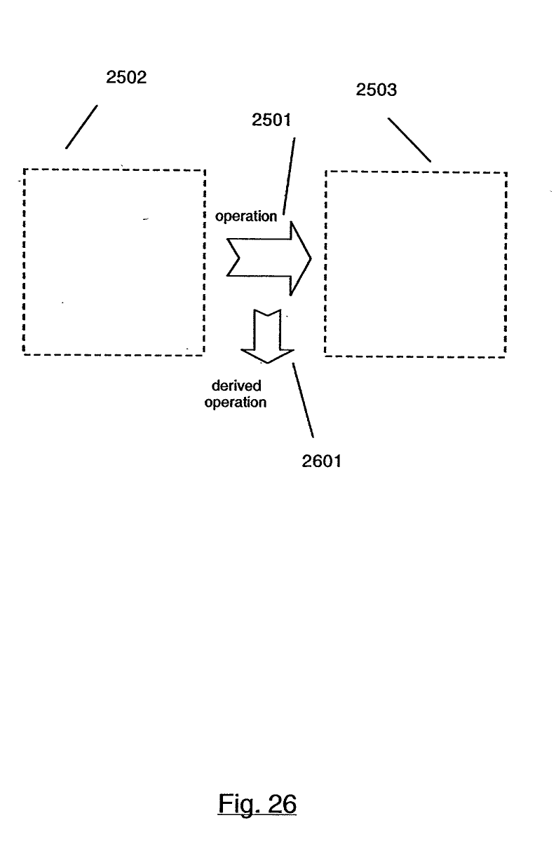

Referring to FIG. 26, 2501, 2502, and 2503 are from FIG. 25 with detail excluded for clarification. A derived operation 2601 is a computational operation, as defined above, which is invoked implicitly in response to invocation of computation operation 2501. MRTR capacity to invoke implicit operations, transparently from the perspective of the invocation of the operation 2501, provides numerous benefits. For example, a common requirement for integration processes are to participate in local or distributed transactions. Therefore, one instance of a derived operation 2601 could invoke the begin transaction operation, while a subsequent derived operation could invoke the commit or rollback operation. Such a subsequent derived operation could be associated with the same operation 2501, another functional operation, any arbitrary asynchronous functionality (such as expiration of a timer), or any equivalent. The definition of the begin, commit, and rollback operations in this context is equivalent to their accepted definition within transaction processing theory. A derived operation may or may not be opaque from the perspective of the logic invoking the operation, and may or may not require configuration.

### Resumable Pull Stream Automata

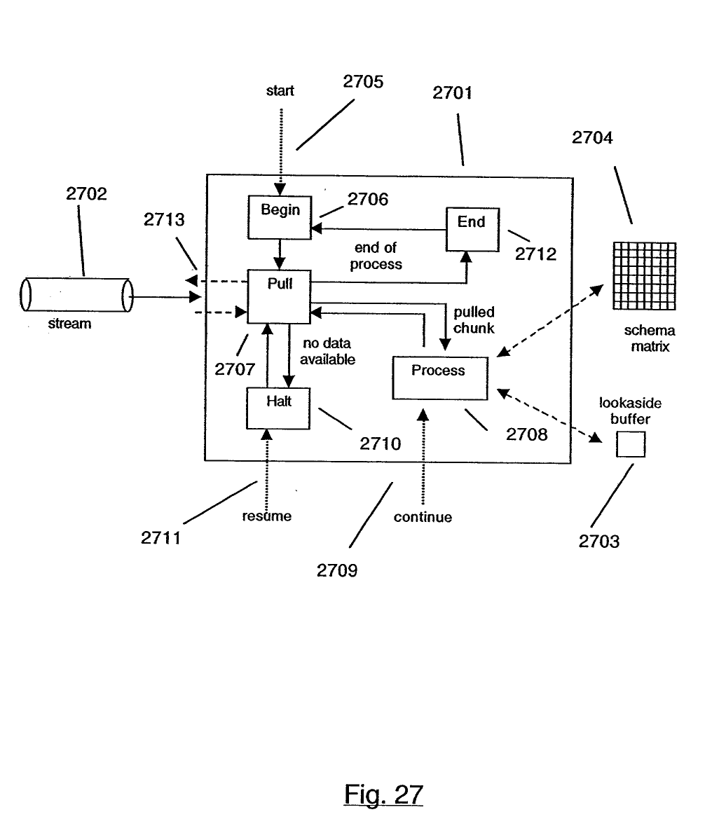

Referring to FIG. 27, a specific process provides one preferred embodiment of the finite state machine, as described initially in reference to FIG. 3, and provides significant computational advantage and contrasts with prior systems. The defining components of the process are a bytestream 2702, whose attributes are defined below, and a suitably-defined resumable pull stream automata (RPSA) 2701 as described below. As RPSA 2701 is an embodiment of the finite state machine 303 from FIG. 3, and thus should not be considered a defining attribute of this invention. For clarity in description, we describe RPSA both from the abstract automata perspective and from an operation perspective describing an example of how the RPSA could be used in practice. The combination of these defining components, the following requirements for the bytestream, and the set of optional bytestream 2702 conditions serve to contrast this process with prior systems. While not required for definition of the process, the process may also require the value of a scalar integer V to be maintained during evaluation of this process. V is not an attribute of this process, as V is only required for finite-length bytestreams. Further, the physical location where V is computationally storage is also not considered a defining attribute of this process, as it can be stored in the schema matrix, a lookaside buffer, or any other temporary storage mechanism within the invention. The value of V is set to the numeric zero (0) upon entering the Begin state 2706.

To illustrate the attributes of RPSA in this process, we consider the iteration of an instantiation of a single communication process. For an illustrative example, we consider an instantiation of an embodiment of such a communication process which will read N bytes from the bytestream. One skilled in the art will immediately recognize that any sequence of instantiations of RPCS can be defined as the sequential temporal composition of an individual instantiation. Further, one skilled in the art will recognize that bytes, as a measure of data to process and as a fundamental unit of process communication, can be interchanged with any measure of communication which supports a compatible transformation between bytes and the alternative fundamental unit.

The requirements of the bytestream 2702 are that data can be retrieved uni-directionally and that a specific logical function 2713, referred to as R 2713, can be defined over the bytestream with specific semantics. One skilled in the art will recognize that R 2713 is not a state or transition in RPSA 2701, but rather a function which may be invoked by RPSA 2701 to request data from the bytestream 2702. Specifically, the semantics of the R 2713 function is that upon request, the R function will either return a positive amount of data from the bytestream or an indication that no data is currently available. The positive amount of data, if returned, is referred to as D. The length of D, provided D is returned for an invocation of R 2713, is referred to as |D|. If R 2713 does not return a positive amount of data, then result from R 2713 is termed_and no corresponding length measure is defined for_. Precisely how such a read function is implemented over the bytestream (such as the function name, parameter values, buffer size, or data alignment) is an attribute of an embodiment of this process. One skilled in the art will recognize that bytestream 2702 can equivalently be a bidirectional bytestream without materially altering the definition of this process. In addition, one skilled in the art will immediately recognize that this process is symmetric, and thus is applicable for both input and output processing, as the bytestream 2702 and schema matrix 2704 can be exchanged without materially altering the definition of this process.

This process assumes the following conditions may occur in processing of the bytestream 2702. The incidence, regularity, and other related operational parameters of such conditions are not considered relevant to this process. The first condition is that the bytestream 2702 may stall zero or more times during a communication process. The term shall is defined in this context to mean that there exists non-zero lengths of time during a communication operation (after the start and before the end) in which no data is available. When considered in input/output prior systems, the condition which arises in response to a stall is commonly referred to as “blocking”. Specifically, the R returns_when the bytestream 2702 stalls. The sequence of data which is received on the bytestream 2702 in-between stalls, if such stalls occur, during a communication process is termed a chunk. The second condition is that the bytestream 2702 may be readable by this process only once, in a strictly sequential (non-random access) order. In such cases, the bytestream 2702 can equivalently be referred to as a sequential bytestream. The third condition is that the bytestream 2702 may have a finite (bounded) or infinite (unbounded) length; thus, the bytestream is not required to adhere to any boundedness constraints.

The schema matrix 2704 and lookaside buffer 2703, while defining attributes of this invention, are not required for this preferred embodiment of the finite state machine. If they are optionally used with this process, then the dashed lines connecting Process state 2708 and schema matrix 2704 and lookaside buffer 2703 represent the functions necessary to read and write values from the respective intermediate virtual representation or lookaside buffer. Their non-necessity arises from the observation, recognizable by one skilled in the art, that either the schema matrix 2704 or the lookaside buffer 2703 can be replaced by a null function which supports an equivalent set of read-write operations. A null function is defined in this context to mean a function whose invocation performs no material computational action.

Continuing from FIG. 27, the RPSA consists of 5 states: Begin 2706, Pull, 2707, Process 2708, Halt 2710, and End 2712. The automata state transitions are Begin_Pull, Pull_Process, Pull_Halt, Pull_End, Halt_Pull, Process_Pull. Actions which are invoked by logic external to the RPSA are represented by dotted lines: start action 2705, resume action 2711, and continue action 2709. Anyone skilled in the art recognizes that actions are neither states nor transitions within the RPSA (although they may trigger transitions in the RPSA in response to their invocation). One skilled in the art will recognize that the Pull state 2707 and Process state 2708 could be combined into a single composite state, without materially affecting the definition of RPSA or this process. The functionality of the Pull state 2707 and the functionality of the Process state 2708 are illustrated in FIG. 27 and described here as distinct automata states strictly for clarity of exposition.

A communication process which is processed by RPSA 2701 begins a communication process in state Begin 2706. The RPSA remains in the Begin slate until the start action 2705 is invoked, causing the Begin_Pull transition to occur. Upon invocation of the start action 2705, control is not returned to the logic which invoked the RPSA until a subsequent State. In this context, the term control refers to the single sequence of instructions being executed (for example, when a CPU is executing a steam of instructions and an arbitrary function f is invoked and the calling program must wait to continue until f completed execution, in one preferred embodiment)

The Pull state 2707 implements a composite operation: compare the value of V and N, if (V<N) then invoke R 2713 and incur a state transition based upon evaluation of the result. If (V≧N), then the Pull state will invoke the Pull_End transition. The RPSA will remain in the End state until the start action 2705 is invoked on the Begin state 2706. If the result of the R 2713 invocation is D, then the Pull_Process transition occurs. If the result of the R 2713 invocation is _, then the Pull_Halt transition occurs.

Upon entering the Process state 2708, a process operation is invoked. Every time the Process state 2708 is entered, V is incremented by one. Such process operation may result in reading or writing data from either or both of the schema matrix or lookaside buffer, as described above. Upon completing the Process operation (referred to as process-completion), the RPSA returns control to the logic which invoked the RPSA, yet the RPSA remains in the Process state 2708. Therefore, the automata states are independent from the states associated with any logic which invokes the RPSA. The ability for the RPSA to return control to the logic which invokes the RPSA, while still maintaining in the Process state (and optionally retaining reference to the schema matrix 2704 and lookaside buffer 2703) is a key differentiating attribute of this process, as contrasted with prior systems.

When in either the Halt state 2701 or in process-completion for the Process state 2708, the logic invoking RPSA may subsequently request RPSA continue processing the communication at any time (as control was returned upon entering the Halt state 2701 or upon completing the Process operation in Process state 2708) via the respective continue action 2709 or resume action 2711. Upon invoking the resume action 2711, the Halt_Pull transition occurs. Upon invoking the continue action 2709, the Process_Pull transition occurs.

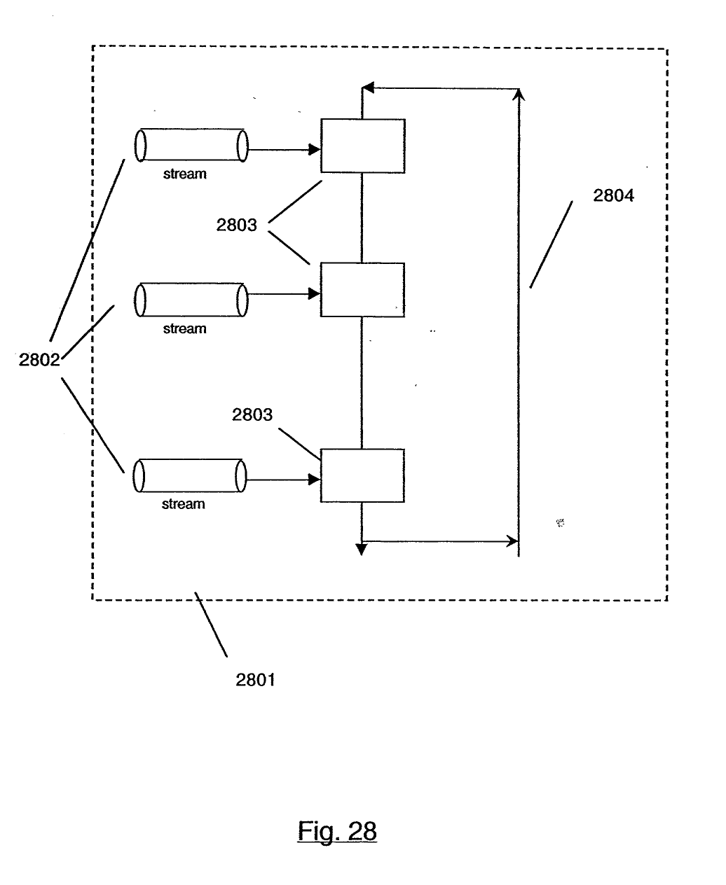

Referring to FIG. 28, a simple illustrative example of using this process for implementing one instance of quality-of-service for the invention is described. In this context, quality-of-service (QoS) is defined to mean supporting differential classes of performance priority, however that is defined by the embodiment, for different RPSA processes, based upon factors configured externally (usually configured by the user). Although the abstract formulation of generalized QoS is not particular to this invention, applying QoS principles to application protocols in an integration system is particular to this invention.

The QoS embodiment 2801 consists of any computational implementation which supports the capacity to execute a sequence of instructions and maintain temporal data (such as a CPU combined with RAM). The QoS loop 2801 is executing a processing loop 2804, which is defined as a finite or infinite flow control loop over a fixed set of operations; for example, the “for” flow control statement found in many programming languages (e.g., Java) would suffice. The processing loop 2804 is invoking operations defined over a plurality of RPSA 2803, with 3 RPSAs 2803 illustrated in FIG. 28. As described in the context of FIG. 27, each of the RPSA are feed data through a single bytestream 2802, according to the description above.

A simple QoS prioritization algorithm can be implemented by this processing loop 2804. Specifically, define the term iteration to mean the composite processing operation for the RPSA: either a continue action 2711 or resume action 2709, as appropriate for the current state of the RPSA, as described above. Conceptually, each iteration of the QoS logic 2804 provides each RPSA a “turn” for processing data. For each iteration, define the term freq(RPCS) to be the measure of how many discrete processing operations the QoS logic 2804 invokes, corresponding to each RPSA 2803. In this example, enumerate the different RPCS from 1 to n. Thus, basic QoS prioritization can be defined as differential values for freq(RPCS) of each n RPCS instances. For example, consider if n=3 and equal priority is required: freq(1)=freq(2)=freq(3)=1. Consider as another example, if n=3 and the priority of RPCS 1 should be double the priority or RPCS 2, which should respectively be double the priority of RPCS 3: freq(1)=4, freq(2)=2, freq(3)=1.

### Dynamic Adaptive Automata

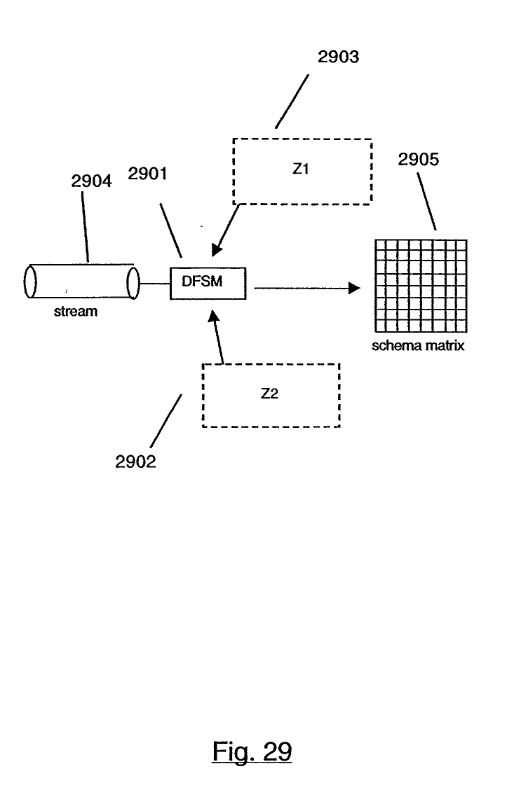

FIG. 29 illustrates the logical components associated with a dynamic finite state machine 2901. While visually similar to FIG. 11, this figure differs as it excludes detail, which was presented in previous figures, to ensure clarity in illustrating dynamic finite state machines.

The finite state machines described thus far are static: a fixed automata whose attributes depend on the attributes of its instantiation and optionally a configuration table, as described above. The finite state machines illustrated in FIG. 29 are dynamic finite state machines 2901. The definition of a dynamic state machine is that the set of states and transitions, along with all the corresponding computational instantiation implied therein, may change in response to specific, well-defined conditions. Note that whether an automata is static or dynamic is an attribute of an embodiment of this invention, and thus a defining attribute of the invention.

The dynamic finite state machine 2901 includes the same components as a finite state machine, as described previously. Of specific importance to this description are the bytestream 2904 and the intermediate virtual representation 2905. Just as with a static finite state machine, the dynamic state machine 2901 performs the state process as defined above of moving data from the bytestream into the intermediate virtual representation for input processing, and moving data from the intermediate virtual representation to the bytestream for output processing. One skilled in the art will recognize that a dynamic finite state machine can be used for both input and output processing, due to the symmetry of its definition.

The dynamic finite state machine 2901 can be defined in terms of a set of states and transition rules Z1 2903 and Z2 2902. We define the term state pair as the pair {set of states, transition rules}, as necessary to define the dynamic finite state machine 2901. Thus, both Z1 2903 and Z1 2902 are state pair instances. One skilled in the art will recognize that set of sales and transition rules are sufficient for uniquely defining a finite state machine when defined as above. For cases which such are not sufficient, as might be required in an embodiment which includes dependent functional invocation for example, the definition of Z1 2903 and Z2 2902 should be appropriately broadened, as necessary, to maintain such additional values.

What defines a dynamic finite state machine 2901 is the capacity for its state pair to change during its execution. The timing, interval, frequency, and other specific temporal parameters about its changing are not considered defining attributes of a dynamic finite state machine 2901. Further, the illustration of two state pairs in FIG. 29 is an attribute of the Figure, not a defining attribute of a dynamic state machine. More specifically, the dynamic finite state machine 2901 may have a plurality of potential state set instances which the dynamic finite state machine 2901 may be defined by. The term assignment is defined in this context to mean the process in which the state pair of the dynamic finite state machine 2901 is assigned to a specific instance value (such as Z1 2903 or Z2 2902). The condition, timing, and other operational characteristics which causes assignment to occur for a dynamic finite state machine 2901 are not considered defining attributes of a dynamic finite state machine 2901.

Two preferred embodiments, both contrasting with prior systems, for such assignment conditions are defined here to provide illustrative examples for how a dynamic finite state machine 2901 may be used in an embodiment or apparatus of the invention: dynamic autogeneration and dynamic stimuli. Equivalently, assignment of a state pair to a dynamic finite state machine results in both the abstract formulation and the operational characteristics of the automata used during integration processing to change, based upon quantitative parameters. Further, as these embodiments demonstrate, the timing of assignment can occur at any time during operation of an embodiment of a universal integration system, and thus the executing timing is not necessarily a defining characteristic of assignment conditions.

Dynamic autogeneration is an assignment conditional which results in the generation of state pairs which reflect configuration parameters, commonly provided by the user. Specifically, a configuration update, as defined above, may be performed by a user which results in the dynamic creation of the appropriate corresponding state pair for one or more dynamic finite state machines. In this example, Z2 2902 could represent a state pair which was generated in response to a configuration update performed by a user. One skilled in the art will recognize that dynamic autogeneration is independent of the state set or transition rules for a specific dynamic finite state machine, and thus is universally applicable within this invention.

Dynamic stimuli is an assignment conditional which modifies state pair used by the dynamic finite state machine 2901 based upon quantitative dynamic parameters, whether dependent or independent from specifics of the specific integration process occurring at that time. Dynamic stimuli may occur via, at least, two ways: self-reflectively or non-self-reflectively. Self-reflective dynamic stimuli assignment is defined by an assignment conditional which is invoked by the dynamic state machine itself. Equivalently, the dynamic state machine invokes the necessary operation, however that may be implemented in an embodiment, to perform the assignment. Non-self-reflective dynamic stimuli assignment is defined as any assignment of a state pair for a dynamic finite state machine which occurs in response to quantitative dynamic parameters, as defined above, performed by any logic other than the dynamic finite state machine whose state pair is being modified.

### Universal Logical Integration Dataflow

An operational complementary component for a multi-protocol integration system step is the definition of a process for logical dataflow of a multi-protocol integration system, referred to as the universal logical integration dataflow (ULID). More specifically, this definition expresses the essential intent and design of implementing a functional multi-protocol integration process using an embodiment of this invention. Further, the formulation of ULID further exemplifies that the invention delivers operations on a multi-protocol integration system by using an integration method which is independent of application protocol. ULID further demonstrates how the invention contrasts with previous systems, as well as general-purpose computers, as ULID specifically defines a formulation of dataflow which is not generally-programmable.

The ULID consists of numerous discrete components, each of which cooperate in defining one embodiment for the logical dataflow of this invention. Discussion of ULID begins by elaborating on the dataflow for the interfaces, finite state machines, and virtual intermediate representation as described above in conjunction with FIGS. 2 and 3. This initial dataflow using these components is sufficient for fulfilling the requirements for this invention as a universal integration system. Sequential multi-stage conditional dataflow (SMCD) is described below, which is one preferred embodiment of ULID. Further, using techniques conceptually similar to the means described above in the preferred embodiment for PPF, a preferred embodiment for ULID can similarly be implemented using the hardware embodiment of this invention as described above.

### Sequential, Multi-Stage Conditional Dataflow

Having described the abstract formulation for numerous discrete component embodying independent parts of ULID, one embodiment for a logical dataflow, termed the sequential multi-stage conditional dataflow (SMCD), which provides a unifying framework for such discrete components is now described. Specifically, a configurably-adaptable, sequential three-pipeline dataflow architecture which is independent from application protocol is described and illustrated.

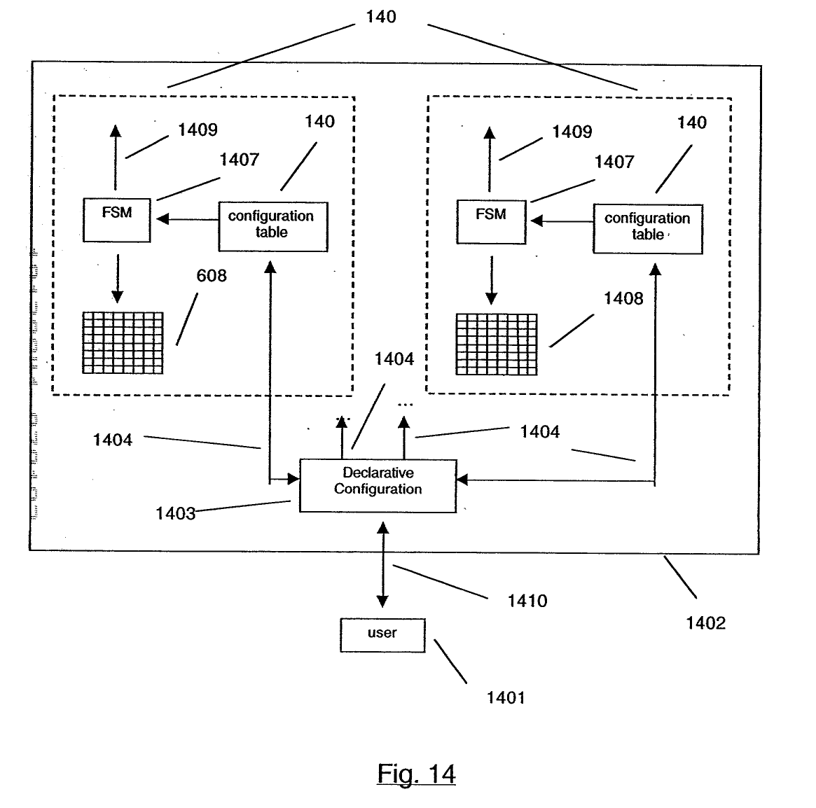

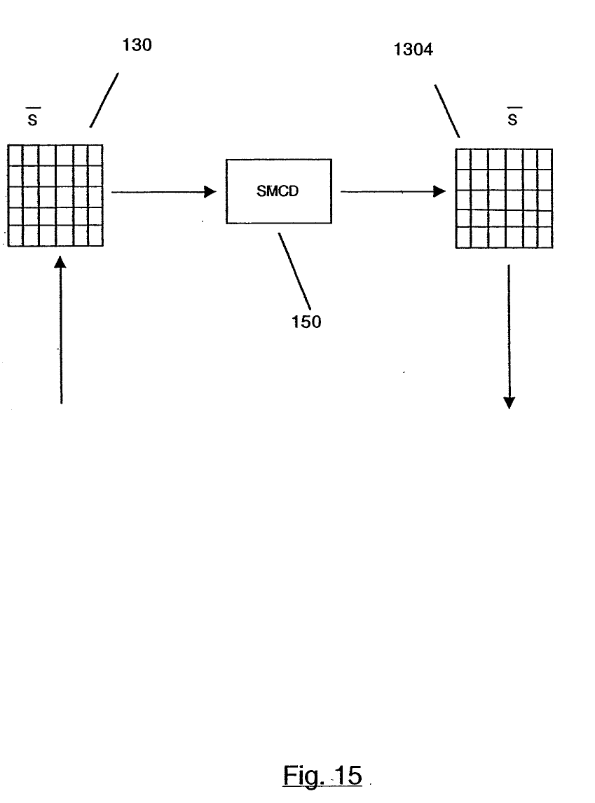

FIG. 15 provides an enlarged view of FIG. 13 focusing on illustrating how additional dataflow and corresponding integration exchange and translation operations 1501, may optionally be facilitated between intermediate virtual representation matrices 1303, 1304. In considering FIG. 15, the following describes how the dataflow for interfaces, finite state machines, and virtual intermediate representation described above can be incorporated into a composite abstraction formulation for dataflow referred to as sequential multi-stage conditional dataflow (SMCD) 1501.

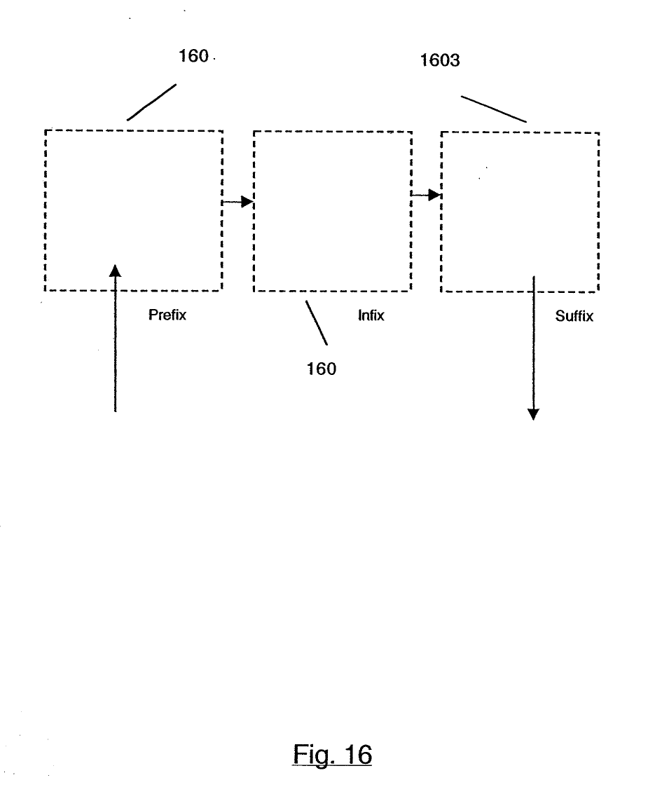

FIG. 16 provides an view of FIG. 13 overlaid with three pipelines 1601, 1602, 1603. The components in this figure represent attributes of the SMCD embodiment of the ULID, and thus should not be considered defining attributes for this invention. Specifically, the dataflow in the SMCD is broken into three pipelines, which all run concurrently: a prefix pipeline, an infix pipeline, and a suffix pipeline. The pipelines run semi-independently, as their primary inter-dependency arises from the data which is sequentially passed between them. Further, there may be one or more instances of each pipeline running independently and concurrently, depending upon the specific integration processes which are being processed by the invention.

One or more instances of the interface, finite state machine, and intermediate representation as described above may be a component included in either or both the prefix pipeline 1601 or the suffix pipeline 1603. As elaborated upon below, attributes of either the prefix pipeline 1601 or suffix pipeline 1602 may imply certain functional requirements for the corresponding finite state machine.

Data flows through the pipelines sequentially, beginning from prefix 1601 to infix and ending with suffix. However, if the integration requirements for a given process do not require capabilities provided by the infix pipeline, it may be skipped during processing on a per-process, per-data, or other distinguished basis. The prefix pipeline 1601 and suffix pipelines 1603 are physical pipelines, as they are executed on specific (i.e. defined in advance) integration interfaces: the prefix pipeline executes on an input interface and the suffix pipeline executes on an output interface. The infix pipeline 1602 may be a virtualized pipeline, and may exist for “conceptual convenience” and thus not reside on a specific integration card. Instead, the infix pipeline may be composed of composable transformation operations which can be distributed across input and output interfaces. Thus, one skilled in the art will recognize that this 3-stage SMCD design could be equivalently formulated as a 2-stage design, as the infix pipeline may be virtualized. The 3-stage design is presented here solely for clarity in description.

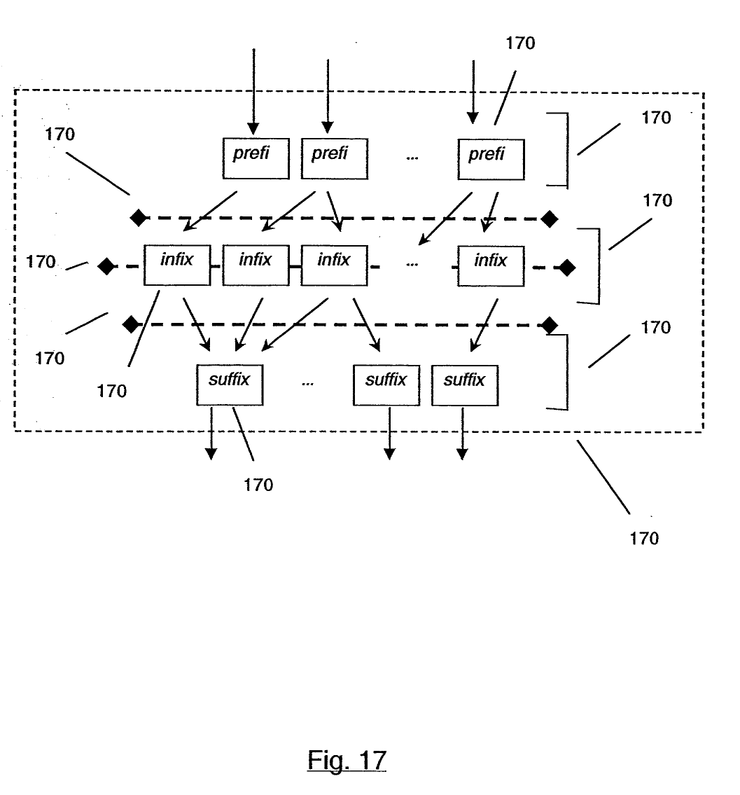

Referring to FIG. 17, the SMCD 1700 is the aggregation of one or more prefix pipelines 1701, zero or more infix pipelines 1702, and one or more suffix pipelines 1703. Data for an individual integration process is received by a prefix pipeline 1704, optionally passed to an infix pipeline 1702, passed to a suffix pipeline 1706, and then sent to the destination system by the suffix pipeline 1706, a single iteration of any pipeline is termed a cycle; the transfer of a logical piece of data through the entire process (i.e. through all iterations of the pipelines, as defined by the configurable transformation rules such as illustratively exemplified through 1704, 1705, 1706) is termed a completion.

The dataflow design minimally requires a single crossbar. A crossbar is defined as a logical interconnectivity which facilitates exchange, also referred to as representation switching, of intermediate virtual representations among one or more of the pipelines. For a uni-crossbar design, this design uses the infix crossbar 1708. For a tri-crossbar design, this design uses all three illustrated crossbars 1707, 1708, and 1709. For exposition, we assume that there are a prefix pipelines, β infix pipelines, and χ suffix pipelines in a specific instance of this invention. Thus, the minimal crossbar requires α-to-β interconnectivity. Crossbar 1707 is the prefix crossbar, which provides connectivity between the αprefix pipelines and the β infix pipelines and the χ suffix pipelines. Crossbar 1708 is the infix crossbar which connects each of the β infix pipelines. Infix pipeline switching is described below.

One familiar with the art will recognize that as direct connectivity between prefix and suffix pipelines is provided across a crossbar, crossbars 1707 and 1709 are equivalent. Thus, whether there are two or three crossbars is a detail of an embodiment, and not a defining attribute of the dataflow crossbar architecture. The electrical interconnectivity, optical interconnectivity, and other operational attributes of the crossbar (e.g., blocking, switched, wormhole) are also considered embodiment details. Whether or not the crossbar is time-divisioned according to the cycle times of the pipelines is also not considered a defining attribute of the dataflow crossbar architecture, but rather an attribute of an embodiment.

All transformations in this dataflow architecture are termed virtually sequential, as all transformations are performed upon logical sequence of bytes (equivalently referred to as streams) and the transformations virtually assume the bytes in the entire sequence are accessible in a random-access manner, even though the bytes may not be all located in memory at a single time and may not be accessible randomly (e.g., they may be processed iteratively). Further, a preferred embodiment of SMCD using RPSA would facilitate SPCD to handle both logically finite (bounded)- and infinite (unbounded)-length streams, unlike prior systems which support only logically finite streams.

While not a defining attribute of SMCD, a preferred embodiment of SMCD uses MRTR, as described above, as a standard intermediate representation which is used in common across all pipelines. In such an embodiment, the use MRTR is deliberate: all data flowing through the system must be discretely packetizable into variable-length multidimensional regions. Thus, MRTR serves a the conceptual equivalent to the “packet” in physical-layer devices. Further, the use of a homogeneous intermediate representation, such as MRTR, enables all pipelines to utilize an identical cycle. As MRTR is independent of application protocol, MRTR can further be used as a common intermediate representation across all pipelines, irrespective of the application protocols being processed by each pipeline.

The capability to use an processing cycle with homogeneous granularity across all pipelines for integration operations is particular to this invention, and differs fundamentally with prior systems which do not possess any such regularized cycle across application protocols or integration processes. Therefore, all common idioms of communication (streams, sockets, ports, etc.) found in prior systems are collapsed into a single abstraction (the MRTR) in SMCD which utilizes MRTR. Also, in this dataflow architecture, one or more data sinks may be provided. In this context, a data sink is defined as an alternative processing route through the dataflow which results in the data being halted and placed in temporary or persistent storage. Data sinks can be understood analogously as dead message queues (DMQs) within message queuing (MO) or publish-and-subscribe (PS) architectures. In contrast to prior systems, physical-layer devices such as routers or switches do not have any analogies of data sinks: packets are either dropped silently (as in contention or for unreachable UDP packets) or are never connected (as in TCP). Data sinks are necessary in this dataflow architecture to support once-and-only-once delivery (O3), transactional semantics, data validation, exception handling, state reconciliation, and state preservation.

Each individual processing step, as exemplified below, within a pipeline is termed a juncture and the collection of all the junctures are termed the juncture set. This dataflow architecture is termed contextually opaque, as pipelines, junctures, intermediate virtual representations, and all other components in the SMCD rely upon identifiers which are opaque. An opaque identifier is defined as an identifier which does not define the physically context for which the data will be processed next. This differs fundamentally from all other types of middleware and prior systems, in which explicitly knowing the identity of the destination is a prerequisite. For example, in sockets you must know the address:port, in MQ/PS you must know the address:queue name, in RPC you must know the address:function_name, and in databases you must know the address:table. One skilled in the art will recognize that the use of name resolution services (such as the Internet DNS) does not alleviate the necessity to know a destination address, they simply provide names for systems which are more easily remembers by humans.

Referring to FIG. 18, the dataflow begins with the prefix pipeline 1801 and ends with the resulting intermediate representation 1805 being sent via 1804 to the either the infix pipeline or suffix pipeline, depending upon the optionality of infix processing for the specific data being processed. The prefix pipeline 1801 starts by accepting the application protocol being connected by the integration system via an application protocol communicated via the bytestream 1803. One or more processing steps are initially executed by a finite state machine 1802, which sequentially executes junctures 1808, 1809, 1810, 1811, and 1813. Any exceptions which occur during processing in the prefix pipeline 1801 are reported to the exception table 1807 via 1816, using an operational mechanism which is an attribute of an embodiment. Finally, the lookaside buffer 1806 is accessed via 1815, using a operational mechanism which is considered an attribute of an embodiment.

The Protocol Interpretation juncture 1808 serves to interpret the basic mechanics of the specific application protocol. For example, protocol interpretation would perform all the processing to decode, decrypt, reorder, error recovery, flow control, and other similar tasks which are independent from the schematic interpretation of the data. This juncture 1808 is conceptually equivalent, while functionally different, to framing and similar frame-oriented operations (e.g., OSI layer 2) in physical-layer devices.

When necessary, the Format Parsing/Block Assembly juncture 1809 serves to interpret the data format which was prepared for interpretation by the Protocol Interpretation juncture 1808. The primary objective of this juncture 1809 is to convert the data, whose input structure depends directly upon the application protocol, into a block structure regularized for the application protocol abstraction (e.g., MQ, RPC, etc). For example, format parsing would perform all the processing necessary to interpret the semantics of the data format including operations such as data validation and schema mapping.

When necessary, the Filter/Sort juncture 1810 serves to performing arbitrarily complex filtering and sorting operations upon the blocks, based upon parameters defined in terms of the application protocol. Any operation which can logically be specified is supported by this juncture 1810. The primary objective of this juncture 1810 is to enforce data selection, data validation, data shaping, and other conceptually similar rules which depend upon mutating the structure or order of the data.

The Transposition juncture 1811 serves to transform the blocks, which are the cycle for the junctures processing the application protocol, into the intermediate virtual representation 1812 (such as MRTR). Thus, this is the crucial juncture within the finite state machine 1802 which readies the data originating from the application protocol to be processed by the remainder of the integration system using the shared intermediate representation 1812.

When necessary the Filter/Sort Representation juncture 1813 serves to perform arbitrarily complex filtering and sorting operations upon intermediate virtual representation instances 1812, based upon parameters defined in terms of the intermediate virtual representation. The output from this juncture 1813 is the resulting intermediate virtual representation 1805 from the prefix pipeline 1801. The difference between this juncture 1813 and juncture 1810, is that the filter/sort operations are defined over the application protocol in juncture 1810 while they are defined over an intermediate virtual representation in juncture 1813.

The cycle for the prefix pipeline 1801 finite state machine is a block, which is an increment of data. The definition of the term increment depends upon the application protocol, but abstract represents an aggregation of data which is organized into a logical group. For example, an application protocol which implements queuing abstraction (such as Java Message Service) defines a block in increments of a single logical dequeue operation. In contrast, an application protocol which implements a (object) remote procedural call (such as CORBA, RMI, or SOAP) defines a block in increments of functional invocations.

As described above, the finite state machine outputs an intermediate virtual representation 1812. Such intermediate virtual representation 1812 is processed by zero or more junctures external to the finite state machine (such as juncture 1813) and the resulting intermediate representation 1805 is sent to either the infix or suffix pipeline, according to the conditions defined above.

The functionality or execution operation of the finite state machine 1802 as well as juncture 1813 may be specialized by parameters provided by the configuration table 1814. Configuration tables, their role in GFIP, and their role in providing declarative configuration are described above. Also, while not a defining attribute of SMCD, a preferred embodiment of SMCD uses dynamic finite state machines to facilitate dynamic configuration.

Based upon the specifics of the integration process or the parameters maintained by the configuration table, characteristics of the system connected via the bytestream 1803, or other conceptually similar parameters, the processing of one or more junctures may be omitted. For example, execution of the Filter/Sort Blocks juncture 1810 would not commonly be required for integration processes which do not define a logical filter operation. Finally, one skilled in the art will recognize that functionality in pipelines can be implemented by junctures in either or both the finite state machine 1802 or logic external to the finite state machine 1802, such as the Filter/Sort Representation juncture 1813.

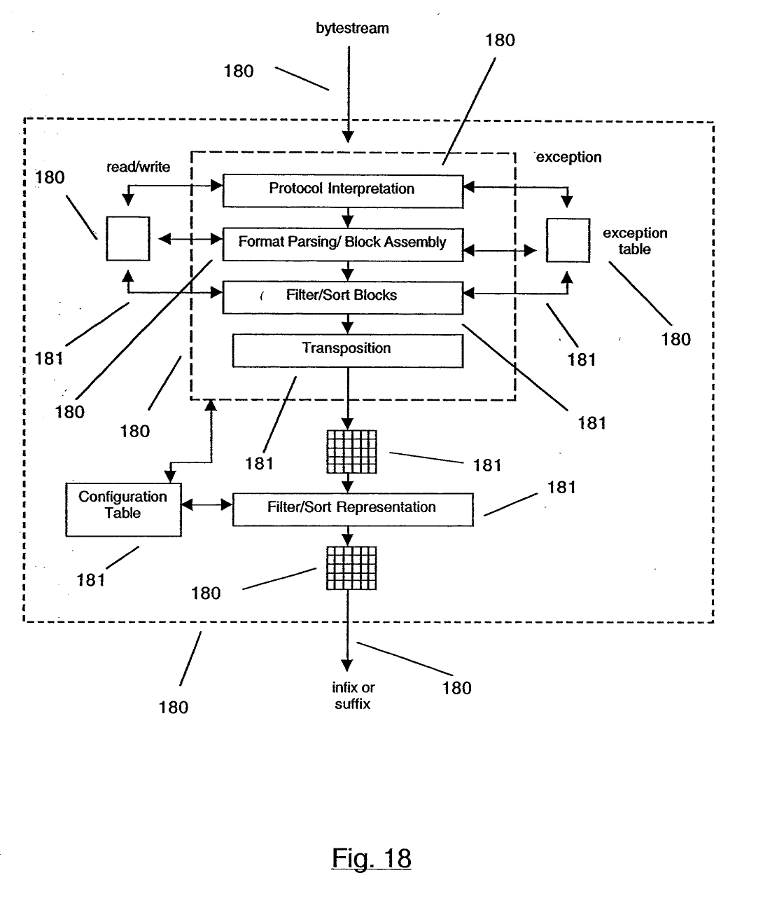

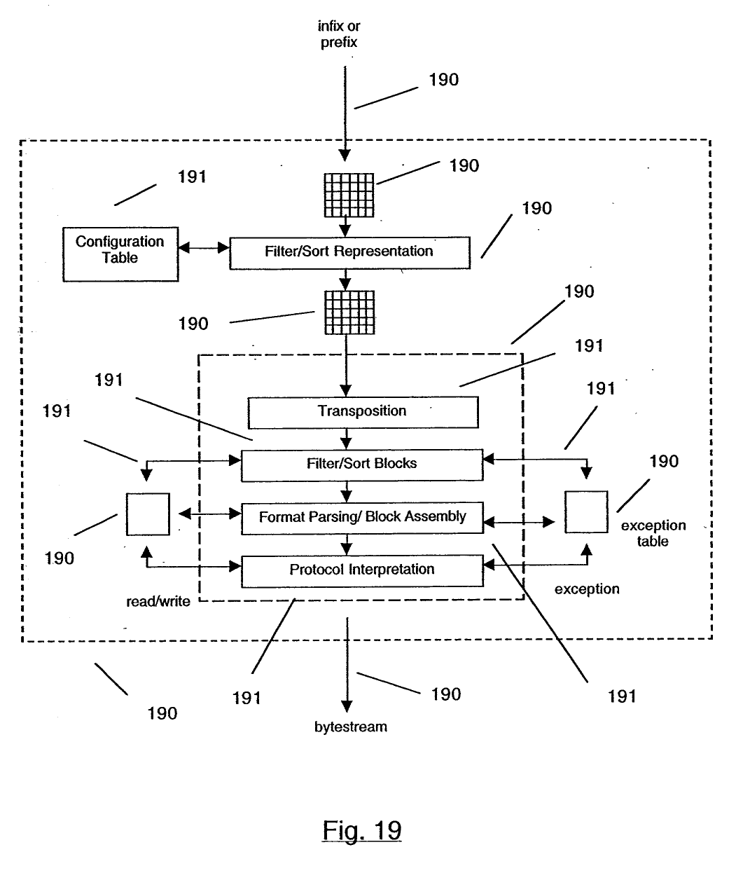

Referring to FIG. 19, the suffix pipeline 1901 is a symmetric reflection of the prefix pipeline. Therefore, the input to the dataflow for the suffix pipeline is a sequence of intermediate virtual representations 1903, while the output is a bytestream 1904 processed by a finite state machine 1902 which communicates with the connected system according to the mutually-agreed upon application protocol. The operation of the suffix junctures are respectively sequentially-symmetric equivalent to those defined for the prefix junctures. The symmetric correspondence between blocks from FIG. 18 and FIG. 19 are: 1804-1903, 1805-1905, 1806-1906, 1807-1907, 1808-1913, 1809-1912, 1810-1911, 1811-1910, 1812-1909, 1813-1908, 1814-1914, 1815-1916, 1816-1915. Given such correspondences, the descriptions for each juncture are the reverse sequentially-symmetric equivalent of the descriptions of those provided above for the prefix pipeline with data input from the intermediate virtual representation 1905 and output to the bytestream 1904. For conciseness, the descriptions are not duplicated here.

Referring to FIG. 20, the infix pipeline 2001 is optionally executed after execution of the prefix pipeline 2005 and prior to execution of the suffix pipeline 2016. The infix pipeline accepts as input an intermediate virtual representation 2006 from the prefix pipeline. The infix pipeline outputs an intermediate virtual representation 2015 which is sent to the suffix pipeline. The infix pipeline includes zero or more configuration tables 2002, which are accessed by each of the junctures via 2019. Exceptions which may occur during processing in the infix pipeline 2001 may be reported to zero or more exception tables 2004 accessed by junctures via 2018, using an operational mechanism which is an attribute of an embodiment. Zero or more lookaside buffers 2003 may be accessed by junctures via 2017, using an operational mechanism which is considered an attribute of an embodiment.

The sequential juncture processing of the infix pipeline 2001 is as follows. The Classify, Assemble, Fragment 2007 juncture performs arbitrary assembly and fragmentation operations, based upon arbitrary classification algorithms, which enable n-to-m intermediate representation transformations. If m<n, then an assembly operation was performed; otherwise, a fragment operation was performed. The Filter/Sort Representation 2008 juncture performs filtering and sorting of intermediate representations, based upon arbitrary filtering and sorting algorithms. The Filter/Sort Representation 2013 and Classify, Assemble, Fragment 2014 junctures are sequential-symmetric equivalent to the respective junctures 2008 and 2007. The output from the Classify, Assemble, and Fragment 2014 is the intermediate virtual representation 2015 which is outputted to the suffix pipeline 2016.

The prefix transform 2009, universal virtual representation 2010, and suffix transport 2012 form the core of the dataflow universality defined by the invention. Specifically, the prefix transform 2009 transforms the intermediate representation incoming from the prefix pipeline into a universal virtual representation 2010. The suffix transform 2012 performs the inverse transformation, converting the universal virtual representation 2010 into an intermediate representation.

The dataflow architecture does not define any specific attributes for this universal virtual representation 2010, other than stipulate that the representation of the universal virtual representation 2010 is independent from both the prefix intermediate representation 2006 and suffix intermediate representation 2015. Preferred embodiments for operations which can provide such a universal virtual representation include the following, which were discussed above: value-mapping, schema-mapping, and first-order-logic.

The infix crossbar 2011 provides infix pipeline switching, as described above, which facilitates switching of intermediate virtual representations between infix pipelines. As switching intermediate representations among infix pipelines is not a required attribute for minimal functionality the dataflow design, the existence or non-existence of the infix crossbar 2011 is considered an attribute of an embodiment.

### Sequential, Opaque Multi-Queue Data Processing

One skilled in the art will recognize that the individual junctures within this invention can be computationally implemented in embodiments using many different logically-equivalent techniques. Further, the junctures do not even require implementation as distinct computational entities; for example, all the individual junctures could theoretically be implemented in one large logic block with integrated control flow.

One specific embodiment for computational implementation architecture of these junctures is particular to this invention, and is motivated by its significant computational advantages when compared with alternative implementations. This specific embodiment is termed the partially-sequential opaque multi-stage queuing (POMSQ) embodiment.

POMSQ is defined by the following condition: one or more of the junctures in this invention are implemented by a queue data structure, with the interface between either side of the juncture defined exclusively through standard enqueue and dequeue operations defined over the queue (thus excluding data exchange between either side that does not adhere to the semantics defined by the queue). POMSQ is multi-stage, as this invention combines numerous junctures into a well-defined structure.

POMSQ is sequential, as this invention defines a predefined relationship among each of its junctures. POMSQ is only partially-sequential because although each of the junctures has a predefined relationship, these relationships do not constrain discrete data flowing through this invention to visit each sequential juncture. Specifically, discrete data can be given a variable path through the junctures in this invention depending upon its data processing requirements.

The use of queues for junctures are particular to this invention, as it provides an alternative abstraction than found in the prior art. Specifically, when considering network communication within this invention, the use of queues for network communication differs from prior art which relies upon remote procedure calls, sockets, streams, or distributed objects. In contrast, this embodiment would abstract network communication as a queue data structure.

The primary role for providing a queue abstraction for junctures within this invention is to facilitate decoupling between data processing stages. Decoupling provides the ability for discrete stages to provide well-defined functionality without being aware of the location of the data input or data output locations. This decoupling can be made more effective by using MRTR, which ensures that even the structure and dependent operations invoked over the data input and data output are decoupled from the stage.

One embodiment of this invention could use opaque identifiers, such as human-readable strings, to distinguish individual juncture queues. Therefore, all data processing operations are defined over opaque identifiers which are explicitly decoupled from any distinguishing attributes of the computers which this invention is communicating. In contrast, prior art relies upon non-opaque identifiers in computation (such as an IP address for network communication).

The boundedness of a POMSQ queue is an equally-important attribute for implementing advanced functionality within this invention. For example, implementing quality-of-service and resource allocation is made significantly easier if the queue is inherently bounded, and thus can perform meta-queue operations; for example: measure queue “fullness”, notify stages upon queue overflow, and statistically compute average queue “fullness”.

### Pairspace

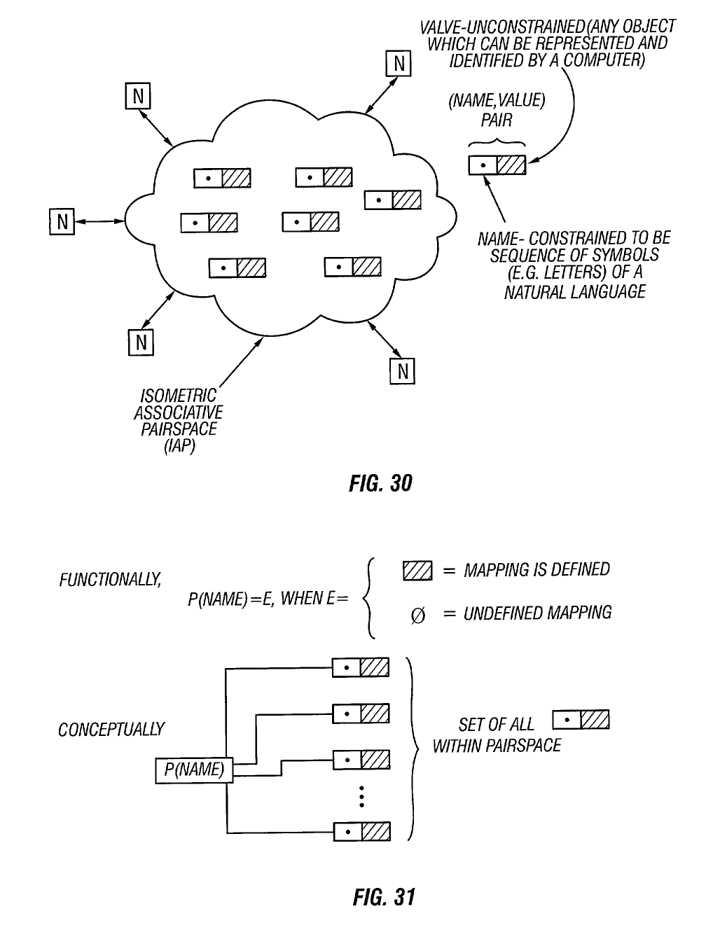

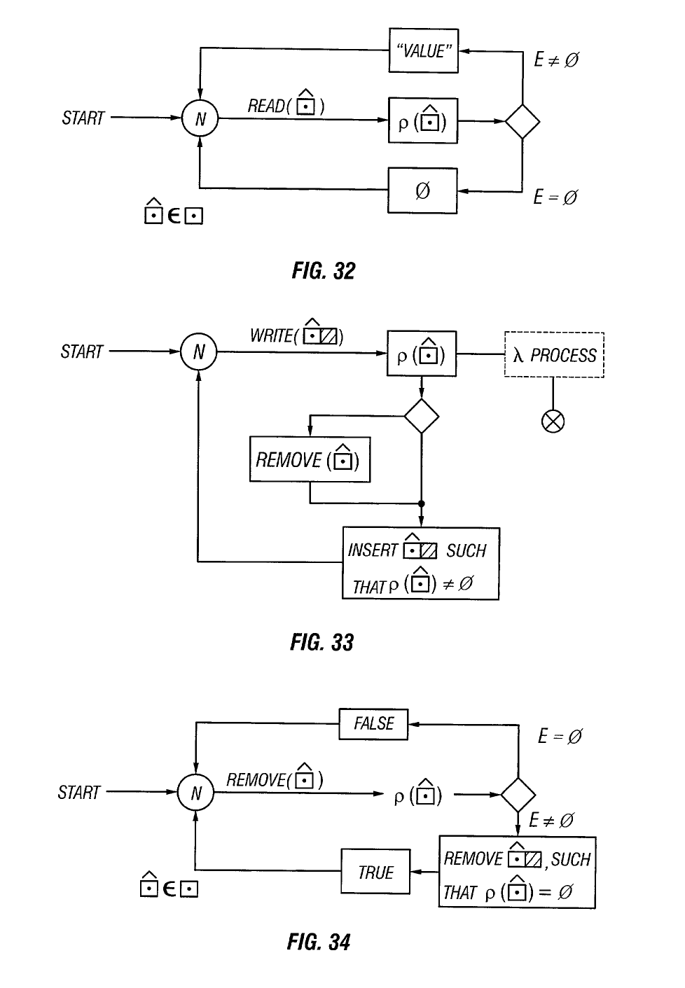

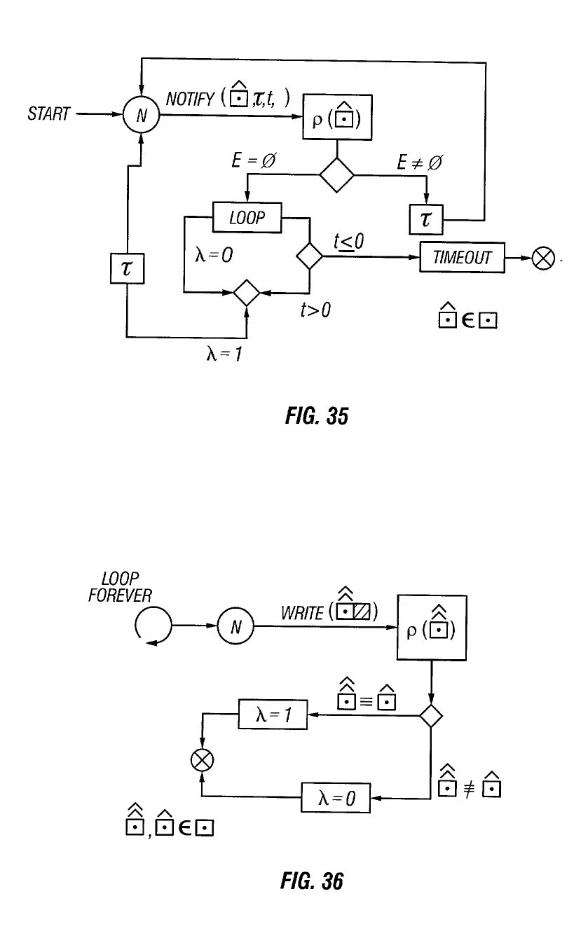

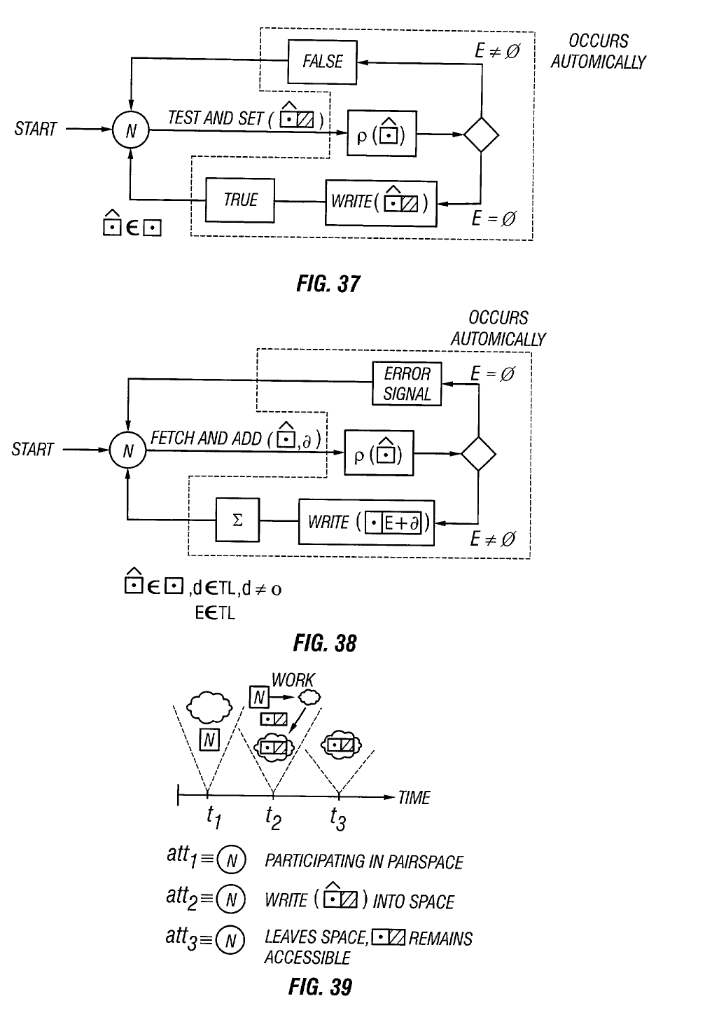

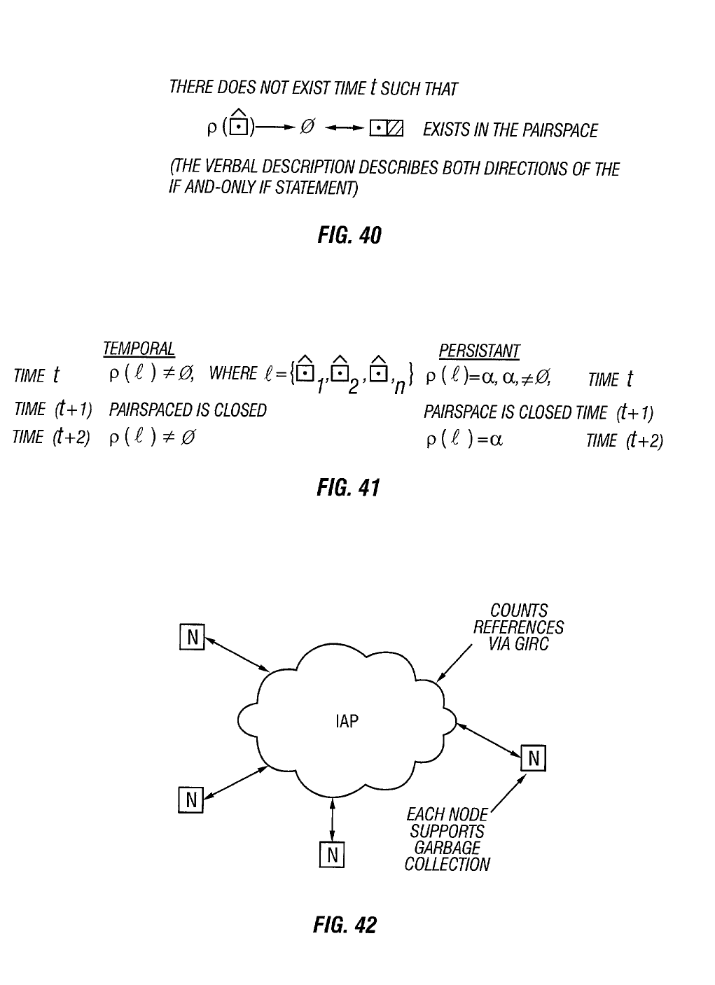

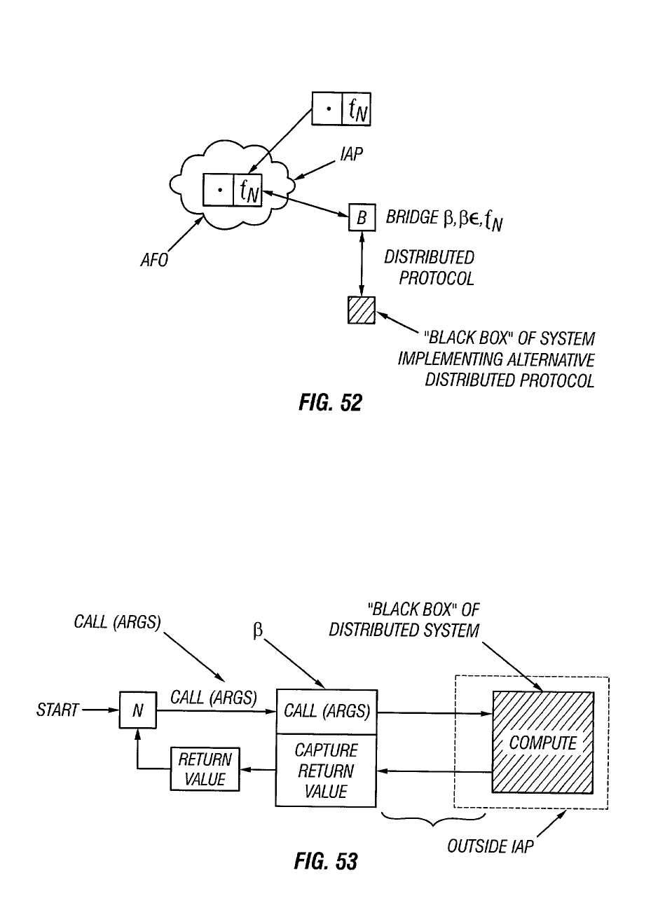

The Pairspace part of the invention pertains to a specific method and system to implement a loosely-coupled isometric distributed system, built upon an associative set of name-value pairs which are logically shared among all nodes. Such a distributed system has numerous unique attributes, which are enumerated below, which make it ideally suited for solving specific computational problems within a broad class of problem domains. FIGS. 30-53 correspond to the following description of the Pairspace pair of the invention.

The characteristics of the Pairspace part of the invention are defined in the same order as the vertical schema for a distributed system described above; such an ordering is optimal as it enables the clear exposition of each component, while equally highlighting the interdependencies between the plurality of components in the system.

The Pairspace part of the invention is built on a single concept: a single mutually shared set of pairs, denoted symbolically as (name, value), which are accessible from all nodes within the system. This set of pairs which is logically shared among all nodes, is termed a pairspace. In the terminology defined above, the pairspace is the communication abstraction. This mutually shared set of pairs is isometric, as each node within the system perceives of the pairspace identically. In contrast, prior art relies upon non-isometric systems; for example, in client-server systems, there is a clear distinction between nodes providing “server” functionality versus those playing “client” roles.

The pairspace is anonymous, as nodes communicating via a pairspace do not have unique identifiers and no “direct” communication between individual nodes is defined. Anonymity also differs from prior art, in which the role of identity is critically important. At the most mundane level, data sockets are connected between nodes by the source node specifying the identity of the destination node; thus, by definition, sockets depend upon the notion of identity to operate and thus are non-anonymous.

Given isometricity and anonymity, many common notions in distributed system are not applicable to such a pairspace: no asymmetric notion of “server” and “client”, no notion of a bi-directional stream of data linking two nodes, no distinction between individual nodes. Thus, the communication abstraction is a collection of associative (name, value) pairs which are isometrically accessible from every node. In contrast, the socket and data stream abstractions, which are so pervasive in the prior art, have no role in the communication abstraction defined by the Pairspace part of the invention as the pairspace defines an abstraction which is simultaneously more expressive yet simpler.

The defining characteristic of a pairspace is that the set of pairs are organized associatively: nodes access (or read) values within the space exclusively through a global pairwise associative function p(name)—value. Within this function, the symbol ‘name’ is constrained to a sequence of textual letters, composed from any written natural language (e.g., English, French, Japanese}. Thus, each pair within the space is uniquely identified by its name, which is associatively bound to a single value. Within this function, the symbol ‘value’ refers to an arbitrary object which can be composed in a programming language; such an object can include constructs from any language, spanning procedural to object-oriented, such as: a byte, a sequence of numbers, a hashtable, an accounting ledger, or any other operationalized concept from prior art.

Six primitive operations are defined over the pairwise function p: read, write, remove, notify, testAndSet, and fetchAndAdd (RWRNTF). Following convention, primitive operations are those operations which are defined on the pairspace which can not be decomposed into suboperations; this contrasts with composite operations, which are defined as compositions of primitive operations.

The six primitive operations are defined as follows. The write operation consists of binding a new pairwise association into the space, such that this new association is subsequently accessible via p; this operation requires the name-value pair being inserted into the space as the argument. The read operation consists of retrieving a pairwise association which was previously bound into the space, via application of p on a given name and retrieving a value composed of exactly one from the set {_, value }, where value is an arbitrary non-null object from the set of objects defined above; this operation requires a single name as the argument and returns a value. In this context, the symbol “_” is defined to mean that no value is bound to ‘name’.

The remove operation consists of removing a previously bound pairwise association, such that the removed pair is no longer subsequently accessible from the space via p; this operation requires the name from the name-value pair being removed as the argument. The notify operation consists of specifying a notification trigger, which signals the node which invoked the notify operation when an association is bound in the space which textually matches the name provided as an argument; this operation requires the name from the name-value pair which will be waited upon for subsequent binding il:1 to the space.

The testAndSet operation consists of an atomic operation which merges read and write: the pairwise association of a given name is read from the space; if the name does not map to a valid value via p (Le. the space lacks a mapping for such name), then a name-value pair is atomically written into the space; this operation requires the name-value pair and returns a boolean: true if value was written, false otherwise.

The fetchAndAdd operation consists of an atomic operation which merges read, write, and numeric addition: the value of a (name,value) pair is read, a non- zero quantity is added to the numeric quantity of the value, the newly added value is written into the space, and the pre-added value is returned; the value of the pair is assumed to be of a numeric type, while this operation requires a name, a non-zero addition quantity, and returns a numeric.

In terms of the vertical schema defined above, these primitive operations define the usage methodology for Pairspace part of the invention. The functional definition of a pairspace provided thus far is sufficient to establish that pairspaces are a generative communication abstraction: each (name, value) pair inserted into the pairspace is uncoupled from the node which inserted it; no interdependency exists between the lifecycle of any pair in the pairspace and the participation of any node (esp. the node which inserted such pair) in the system. Thus, if node n writes pair (name,value), (name,value) will continue to remain accessible within the space irrespective of whether n continues participation in the distributed system.

The primitive operations RWRNT are defined atomically over the space; specifically, the pairspace is defined such that there does not exist any time, with respect to the nodes accessing the pairspace, during which any pair is disjoint; in this context, disjointness is defined as the existence of one or both of two conditions: (1) a name exists within the space, but does not validly map to a value; or (2) a value exists within the space, but is not mapped to by a valid name. Atomiticity also guarantees validity of the notify operation, as such notification triggers are guaranteed to occur provided binding occurs on a non-disjoint pair.

How such primitive operations are implemented over the pairspace is not an inherent characteristic of the pairspace, just as how the electrical signals encode binary digits between computers is not an considered an inherent characteristic of a data socket; however, one such preferred embodiment is provided herein to illustrate the general implementation details for such operations.

As a point of contrast with prior art, a pairspace differs significantly from a tuplespace; a tuplespace defines a pattern matching function over a collection of tuples using a template tuple (commonly referred to as a pattern) composed of formal and actual fields. Formally, a tuple is an instance of a collection class whose elements are “name and value” pairs. Such a tuplespace pattern matching function considers both value and type identifiers, as well as instance type equality. Thus, a pairspace and tuplespace may be considered conceptually akin, but their inherent properties and preferred embodiments differ significantly.

Thus, the communication abstraction for the distributed system which the Pairspace part of the invention defines is simply an associative pairspace with five primitive operations; contrast this with prior art which defines bidirectional point- to-point data sockets as the primitive communication abstraction, whether stated explicitly or implied.

Pairspaces can be dichotomized into two distinct categories: temporal and persistent; specifically, an inherent attribute of each pairspace is whether the name-value pairs are stored temporally or persistently. Temporal pairspaces are a communication abstraction which are “memory-less”: all the values within the space are lost when the space is closed (space closure is defined as any set of steps which leads the space to no longer be accessible to nodes, whether explicitly closed via the nodes or implicitly closed due to power loss to the distributed system). Persistent pairspaces are a communication abstraction which has “memory”: all values written into the space remain accessible until explicitly removed by a node, irrespective of intermediate space closures.

Considering temporality as an attribute of a communication abstraction differs markedly from prior art. Prior art assumes such a time-dynamic feature is defined by independent components which overlay functionality upon the communication abstraction; for example, persistence is not even a consideration in the method and system of bidirectional data sockets, as persistence falls outside the scope of reading and writing bytes.

In terms of the vertical schema defined previously, the pairspace as a communication abstraction is notable as its attributes are self-descriptive of a fully-expressive data protocol: set of (name, value) pairs, six primitive operations, operation atomicity, and set temporality; all operations are based upon a equality comparison of a sequence of textual characters (respecting the character equality rules of the natural language; e.g., some natural languages perform textual comparison different for certain letter combinations, such as ‘ch’ in spanish). Equivalently, the pairspace does not require that nodes define a data protocol to facilitate structured communication. This is particularly notable˜egiven that communication abstractions defined in prior art require that nodes define such data protocols to facilitate any type of structured communication. For example, data sockets require nodes to specify a byte-oriented encoding and formatting for exchanging objects; tuplespaces require nodes to specify instance type and value operations {at minimum, equality} upon every object which is well- defined within the system.

Following the vertical schema defined previously, the Pairspace part of the invention defines several additional logical constructs which are built upon the pairspace communication abstraction: transparent distributed garbage collection, adaptive delegation-based object invocation, and support for heterogeneous distributed object systems via transparent generic adaptive delegation. These logical constructs composed with the definition of the pairspace result in a well-defined distributed system. Further, such additional logical constructs are important for contrasts the Pairspace part of the invention with salient aspects of prior art.

### Resource Management: Transparent Distributed Garbage Collection

The management of the lifecycle of objects inserted into a pairspace is of particular interest when considering practical application of the Pairspace part of the invention, as these policies define resource management for the pairspace communication abstraction; specifically, the definition of a pairspace thus far lacks any semantics about the lifecycle of {name, value) pairs which are inserted into it. This is of particular concern, given the very likely potential for an unbounded number of objects being inserted into the space, without being subsequently removed. Of course, such a condition would result in system failure due to exhaustion of all computational resources available to the distributed system.

The Pairspace part of the invention defines a reference-counting distributed garbage collection algorithm over the pairspace, which when combined with a system for nodes which supports scope-based garbage collection, results in a transparent distributed garbage collection {TDGC) resource management method and system for the Pairspace part of the invention. The following description assumes the existence of scope- based garbage collection for each node; this is a justifiable assumption, as the prior art demonstrates that such a system can be constructed; further, systems which support such non-distributed garbage collection are in common use today (e.g., Java).

The implementation of TDGC within the Pairspace part of the invention differs from prior art, due to the fact that pairspaces are a generative communication abstraction. As such, local reference counting based upon proxy objects, as is the common construct used in prior art, is inappropriate for such TDGC—as there is no notion of “local representation” and there are no distinctions between “processes” as all nodes communicating via a pairspace are isometric with respect to the distributed system.

Transparent distributed garbage collection is defined over a pairspace by abstracting the notion of reference counting (which is a technique well-established in the prior art; specifically( a global isometric reference count {GIRC) can be defined for each pair, which is bound to be a non-negative value. This reference count is isometric because it is not bound to any individual node, but rather is itself a {name, value) pair within the space. Thus, for every pair (x,y) in the pairspace, a second “GC pair” exists (x^{o}, Π) where x^{o}represents the reference count identifier for pair (x,y) and Π is a non-negative integer representing the present numeric GIRC.

Two composite operations defined over the pairspace are the basis for TDGC: lock and unlock. The lock operation increments the GIRC of a pair, while the unlock operation decrements the GIRC of a pair. Both operations are implemented by using the fetchAndAdd primitive on the GIRC associated with the pair being locked, specified in psuedocode as:

function lock (in name)

return fetchAndAdd(nameₒ,I) end function

function unlock (in name)

return fetchAndAdd(nameₒ,−1) end function

As these definitions imply, the value of the GIRC of a pair (name,value) in the pairspace is defined as the number of lock operations invoked for (name,value), less than number of unlock operations invoked for a (name,value). The duration over which such lock/unlock operations are maintained depends upon the temporality of the pairspace; specifically, persistent pairspaces define GIRCs permanently, while temporal pairspaces zero all GIRCs upon each closure of the space.

With this formulation, the pairspace DGC algorithm can be stated concisely as: remove pair (x,y) iff GC pair is (x−^{o},0). This concise formulation is notable, as GC algorithms in prior art are significantly more complicated. To ensure atomiticity, the pairspace must implement this algorithm eagerly (as opposed to lazily), to ensure that at no time does there exist a pair (a,b) such that (a−^{o},0), with respect to the nodes communicating via the space. Implementation of this algorithm over all pairs in the space is defined by the Pairspace part of the invention to be an attribute of the pairspace communication abstraction.

Transparency of the distributed garbage collection arises when GIRC and pairspace DBC algorithm are combined with nodes which implement transparent localized garbage collection (LGC), such as scope-based “reachability” algorithms which are common in prior art. The exact mechanics how LGC are implemented by each node is not relevant, provided that it does exist. Transparency is implemented by invoking an unlock operation (by the LGC, or related systems) every time a pair, which was previously retrieved via a read operation, becomes unreachable on a node. Thus, the LGC provides a means for eliminating the need for programmers to explicitly track GIRCs, as the scoping reachability rules for the LGC implicitly invoke the unlock operation when necessary.

Using the terminology of scope-based garbage collection prior art, this TDGC algorithm implements a pairspace-wide GC policy which ensures that pairs remain accessible (ie. are not unbound from the pairspace) at all times during which any node within the distributed system retains an reachable reference to such pair, without having explicitly decremented the GIRC to zero for such pair.

### Function Invocation: AdaptiveDelegation-based Object Invocation

Having identified the defining characteristics of a pairspace, along with a transparent resource management policy for such communication abstraction, the next immediate concern when considering the vertical schema is facilitating implementation of computer program logic. This is important as a communication abstraction without a means of implementing program logic is not generally considered useful.

While a pairspace defines loosely-coupled computation constructs via the primitive operations, support for more common object-oriented programming constructs is necessary for familiarity and compatibility reasons. Within the context of the vertical schema defined above, the Pairspace part of the invention must further define the well-defined programmatic interface and specify the broad set of contextual semantics for the distributed system, as introduced above in the vertical schema.

The context for such object invocation within the pairspace is with pairs (name, fn) which meet the following criterion: the value fn is an adaptive functional object (AFO), which provides implementation of one or more well-defined functions. For example, a trivial AFO could implement an addition operation: the AFO accepts two numeric arguments and returns their numeric sum. AFO objects can implement any function which can be specified using computer programming logic.

To introduce the notion of adaptive delegation-based object invocation, consider a psuedocode fragment using object-oriented language:

obj.foo(“test”)

In this code, the method ‘foo’ is being invoked on the object ‘obj’ with a single string argument whose value is “test”. The comparable syntax for implementing such function over a pairspace is expressed as, again using object-oriented language psuedocode:

var fn=pairspace.read(“foo”)

var args={“test”}

fn.call(args)

In this psuedocode, the ‘read’ primitive operation is being invoked on the pairspace and is returning an AFO object named ‘fn’. Next, a sequence of objects is constructed called ‘args’, whose length is one; the first index of the sequence is assigned the string value “test”. Finally, the ‘call’ method is invoked on the AFO, passing ‘args’ as the argument to ‘call’. Having introduced an operational example, consider the following formal definition of object invocation.

Object invocation defined over a pairspace is implemented via an adaptive delegation-based prototype mechanism (ADPM). As a point of contextualization, ADPM is motivated by prior art in delegation-based prototype programming languages (e.g., Self). Specifically, an AFO is a single object method interface which implements any function via a delegation-style prototype. In the example above, ‘fn’ is serving as the delegate prototype. As such, the AFO is strongly-typed (as it has defined method signatures), yet it is generic: invoking a method on a particular object is implemented by routing the invocation via the delegation prototype.

Specifically, method invocation over the AFO occurs dynamically via delegation: parameters of the method being invoked are transformed into method invocation argument parameters (the name of the method is not relevant, as the name is x in the pair (x, fn) , and thus implied in fn. As in a delegation-based prototype language, AFO defines a single generic invocation method named ‘call’ (referred to symbolically here as call( )) which accepts an ordered sequence of arguments; in an object-oriented language, the argument would be an array of objects; in a procedural language, the argument would be an array of values or pointer references).

This intuition can be formalized as: consider a fv (where v∅N) which has a method named ‘m’, which is referred to symbolically here as m( ). As identified above, the pairspace supports the isometric invocation of m( ) by any node, without prior knowledge of fv and without the use of proxies. Assume such node invokes m( ) with q parameters (paraml′ param2, . . . , paramq), where q is non-negative. The AFO dynamically delegates the invocation of mo, into a generic invocation of call( ) and marshall the parameters as necessary. Assuming m( ) had a defined return value, the return value from call( ) is marshaled back and transparently returned as the return value from m( ). In the context of the example above: m is ‘foo’, param is ‘args’, and fv is ‘fn’. Symbolically:

m(param1, param2, . . . , paramm)_fv:call(param1, param2, . . . , paramm)

Note that binding methods on adaptive functional objects results all methods being invoked on a ‘value’ from a unique (name,value) pair. Thus, this conditions ensures the only functionality which is defined over the pairspace are the six primitive operations. Thus, ensuring that the adaptive deleg˜tion-based object invocation capability does not violate the assumption of a pairspace being composed entirely of a set of associative pairs; instead, methods invoked over the pairspace must be specific to an individual AFO (such as fv in this case), and such AFO must be a value in an associative pair bound in the pairspace.

AFOs maintain all the attributes of pairspaces: generativity, anonymity, and loose-coupling. Further, the fact that AFOs maintain such attributes further distinguish them from prior art.

AFOs are generative, in that their existence is unbound from the node which defined them. Equivalently, a node may insert a pair into the pairspace and then stops participating; generativity ensures that such pair will continue to exist in the pairspace, even after the node stops participating. The pairspace makes this possible by ensuring that nodes using the AFO have no means of ascertaining whether the originating nodes are presently participating or not. In this context, the originating node for a AFO is defined as the node which inserted the AFO into the pairspace.

AFOs also retain anonymity of the pairspace, as AFO objects do not provide any information which identifies the originating node. This contrasts with systems defined in prior art, in which the identity of a particular node is critical; for example, client-server systems such as the Internet (which uses domain names via DNS) would not be possible without the use of identities.

Finally, AFOs are loosely-coupled because the only communication between the originating node and the invoking nodes is implemention of the adaptive delegation invocation semantics. Equivalently, there is no facility for node f to communicate with node g in any manner excepting that provided by the mutually shared set of pairs in the pairspace.

In contrast with methods and systems defined by prior art, AFOs do not require the generation of proxies for either the “server” (defined as the node where the object being invoked is hosted) or the “client” (defined as the node which is remotely invoking the functionality on the hosted object). In prior art, each proxy defines, for its respective node, a set of strongly-typed method signatures (whether encapsulated in an object, as in RMI, or procedurally). Each node relies upon this proxy to manage invocation semantics, parameter marshalling, return value processing, and other semantics specific to the distributed system. In contrast, ADPM relies upon a single generic AFO which has a method interface which is strongly-typed; thus, making the AFO compatible with strongly-typed languages, such as Java.

The fact that pairspaces do not require the use of proxies is critically important for practical and theoretical reasons. Specifically, systems defined in prior art exemplify that proxies must be generated for every object used within the distributed system. Thus, the use of proxies requires that users define in advance all the potential objects which are used within the system. In contrast, a pairspace provides no boundary upon the AFO objects which can be inserted into the space and further does not require any a priori knowledge about such AFO objects. As such, the use of proxies with a pairspaces would violate its inherent definition—hence, why they can not theoretically be used together.

Finally, the Pairspace part of the invention uses delegation-based object invocation to eliminate the need to implement object-specific strong type checking across the pairspace; this is necessary because proxies implement strong type checking, yet proxies are not usable with a pairspace. Instead, using delegation-based object invocation enables functionality to be defined over the pairspace using a single well-defined AFO, via call( ), which transforms strongly-typed method invocations into weakly-typed remote delegation. In the example above, the strongly-typed method invocation is foo( ), while the weakly-typed remote delegation is through call( ) with ‘args’.

Formally, the need for ADPM is necessitated by the fact that string type checking could not be supported by a pairspace, as defined above, for several theoretical reasons: (1) strong type checking requires object and method signatures prior during compilation (prior to execution), which is not possible; (2) pairspaces support arbitrary objects as values in (name, value) pairs, and assume no a priori knowledge about the objects, their types, or their method signatures; and (3) pairspaces are isometric and dynamic, eliminating the possibility of supporting statically compiled interface definitions (via IDL) or non-isometric proxies (e.g., stubs and skeletons)

### Interoperability: Transparent Generic Adaptive Delegation

Transparent generic adaptive delegation (TGAD) is the generalization of adaptive object invocation, defined above, to support invocation of functionality from objects implemented by any existing distributed object protocol (e.g., CORBA, COM, RMI). Specifically, the usage scenario is when a node desires to invoke functionality from an object in the pairspace defined in a distributed object protocol other than AFO. Of course, this type of heterogeneous adaptation is critical for providing interoperability and compatibility with existing systems.

In the example in the previous section, TGAD is necessary when ‘obj’ is an object accessible via another distributed protocol (e.g., COBRA) and ‘foo’ is remotely invoked via ‘obj’.

The Pairspace part of the invention implements TGAD via one unique AFO adaptive bridge per distributed protocol. The adaptive bridge defines the proxies or IDL required to export the AFO into the distributed protocol, and properly marshall arguments and return values between the pairspace and the other distributed protocol transparently. Specifically, the bridge defines the protocol-specific parameters for call and makes the other distributed protocols aware of the local AFO object and supports bi-directionally invocation: (1) invoked by nodes in the pairspace, to invoke functionality from objects throughout the other distributed protocol networks; or (2) objects through the distributed protocol networks can invoke functionality from AFOs in the pairspace.

Consider RMI as an example of a distributed protocol within this context. For RMI to bi-directionally exchange invocations with a pairspace, a single unique AFO bridge must be defined. Specifically, this bridge must define a RMI proxy stub which exports the delegation-based call( ) method, so it is accessible to the RMI network. In doing so, RMI objects will be accessible to nodes within the pairspace via the bridge, and vice-versa.

Formally, exactly one adaptive bridge is required per distributed protocol, as the strongly-typed AFO provides a generic object delegation through which all methods on the AFO can be bi-directionally invoked through the protocol. Conceptually, there exists exactly one bridge per protocol for the same reason that there exists a single AFO for the pairspace: AFOs eliminate the need for object-specific proxies, thus method invocation for all objects can be defined by a single generic interface.

Transparency in this adaptive transformation arises because the distributed protocol is neither aware of the pairspace semantics, nor are the nodes in the pairspace accessing the bridge aware that the object implementing the AFO are using other distributed protocols. Further, this transparency is both sufficient and necessary for ensuring that all the semantics of the pairspace are maintained when implementing the TGAD.

### Unified Data Basis Transformations

The need to make multiple independent computer systems communicate with each other and exchange data is a cornerstone functionality for nearly all information systems today. Specifically, nearly every organization using computers has multiple computers which must exchange data to implement many types of computer-assisted business processes.

The intent of the Unified Data Basis Transformations part of the invention is to define a single common abstraction through which data exchange, transformation, and process rules can be defined over. More specifically, a method and system which defines an abstract mapping between source and destination computer systems. Although all middleware systems share the same abstract formula for implementing communication between independent computer systems, the exact semantics of the map, its structure, and its implementation technique depends intimately upon the specific embodiment.

The present Unified Data Basis Transformations part of the invention defines an alternative technique for viewing such middleware processing, based upon a technique for representing data using a universal abstraction which is independent from the semantics of existing middleware; without loss of generality, a representative sample of such semantics of existing middleware include byte ordering, data representation, protocol encoding, and security parameters.

The present Unified Data Basis Transformations part of the invention defines set of basis transformations which bi- directionally transform data from any specific middleware abstraction into a representation compatible with the present Unified Data Basis Transformations part of the invention. Such basis transformations are necessary to define the interfaces between existing systems and the universal data basis, as the present Unified Data Basis Transformations part of the invention defines a representation which is explicitly incompatible (without transformation) with existing middleware abstraction. FIG. 51 provides a linear algebraic block diagram of a UDB, along with the source and destination transformations (defined below).

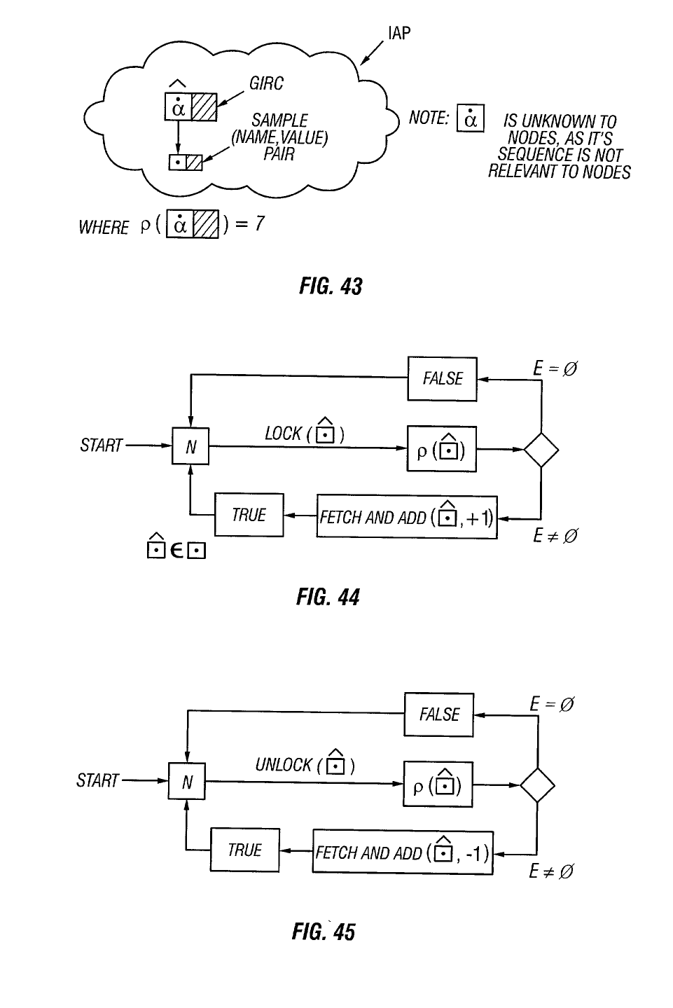

A universal data basis (UDB) is a novel abstraction which facilitates representation and transformation of data from any middleware communication abstraction, along with defining a set of primitive operations. One or more synchronization primitives are also defined over the UDB to provide asynchronous notification of process boundaries. The novelty for a UDB arises from the fact that any data and process logic, irrespective of their originating middleware abstraction, can be expressed uniquely using a single means of representation. As such, UDB differ from prior art in that a pair of source and destination transformations are necessary to bi-directionally convert data to and from existing middleware systems, to make the data available for processing within the UDB. FIG. 43 diagrams the abstract block diagram for a UDB.

A UDB is composed of three components. First, one or more equivalent means of representing the data within the UDB, Second, a set of primitive operations which define the mechanisms for how transformations on the data within the UDB are specified by software logic. Third, a set of synchronization primitives which specify how to signal asynchronous and synchronous process events over the UDB. As such, all three components are inherent qualities of the present Unified Data Basis Transformations part of the invention, yet the specific characteristics of both are instantiations of a preferred embodiment.

One or more operational primitives are required to facilitate how data is read, written, and transformed while represented in the UDB. Specifically, the operational primitives define the techniques for such read/write operations which are compatible with the way data is represented in the UDB. The precise semantics of the operation primitives are specific to an embodiment, as the present Unified Data Basis Transformations part of the invention does not define specific operations on the data represented in the UDB.

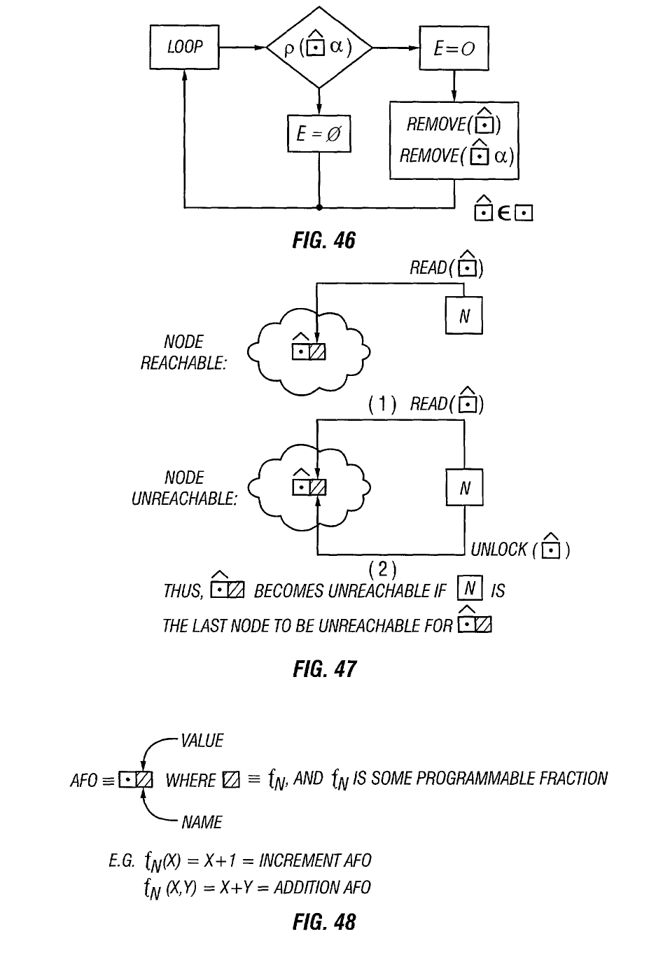

One or more synchronization primitives are required to facilitate signaling between the basis transformations. Depending upon the synchronization primitives, such synchronization could facilitate either a synchronous or asynchronous relationship between each of the transformations. Without loss of generality, using a block synchronization algorithm would facilitate a synchronous implementation of the UDB, while using a non-blocking synchronization algorithm would facilitate a asynchronous implementation of the UDB. Without loss of generality, FIG. 46 illustrates a synchronous implementation of a UDB, while FIG. 47 illustrates an asynchronous implementation of a UDB. Anyone experienced in the prior are will recognize that the asynchronous or synchronous nature of a UDB, is an artifact of the synchronization primitives selected for the UDB by a specific embodiment.

As data structured in existing middleware systems is not, by definition, compatible with such a UDB, a pair of basis transformations (BT) are required for each instantiation of a middleware abstraction. First, a source basis transformation (SBT) which transforms data and process logic originating from the instantiation of the middleware abstraction into the UDB. Second, a destination basis transformation (DBT) which transforms data and process logic in the UDB into the format required for the data destination. Essentially, basis transformations are the minimum required transformations for making data contained in alternative formats compatible with the UDB.

Both the source basis transformation and destination basis transformation consist of two discrete phases: format transformation and protocol transformation. Format transformation is the phase which converts the data to or from the UBT to the logical data format of the data source or destination. Protocol transformation is the phase which converts acquires or transmits the formatted data via the protocol appropriate for the middleware abstraction. SBT perform protocol transformation then format transformation. DBT perform format transformation then protocol transformation. FIG. 45 defines a flow diagram for a sample instantiation of a unicast, unidirectional UDB process.

For example, consider the case where the source abstraction is XML data received via RMI. In this example, XML is the data format and RMI is the protocol (with RPC being the middleware abstraction); XML defines an encoding, a character set interpretation, and a semantic interpretation (via an implicit or explicit schema); RMI defines a wire-line protocol and RPC-equivalent conventions. The SBT in this case would consist of the following two sequential phases. First, the XML data must be received and unwrapped from the RMI protocol-layer. Second, the XML data (which, in this case, would be represented by a stream of bytes in the RMI data payload) must be transformed into the format appropriate for the UDB.

Symmetrically, consider the case where the destination abstraction is XML data sent via RMI. As in the previous example, XML is the data format and RMI is the protocol (with object-oriented RPC being the middleware abstraction). The DBT in this case would consist of the following two sequential phases. First, data in the UDB format must be transformed into XML data. Second, the XML data must be wrapped into the RMI protocol-layer and sent to the destination.

Once data is accessible within the UDB, after a SBT and before a DBT, a set of intermediate transformations (IT) can be defined. Such intermediate transformations define a set of such ITs using the single set of common primitive operations defined over the UDB. This ability to concisely and elegantly express transformational logic contrasts with traditional middleware, where oftentimes such transformations are difficult to codify today. The reasons for such complexity today could arise from incompatible abstractions, incompatible data formats, incompatible APIs, or requirement for complicated adapters/interfaces. FIG. 48 provides a block diagram for an intermediate transformation.

The simplicity of intermediate transformations in UDB arises from several factors. First, the UDB provides a common representation along with a common set of operational and synchronization primitives, which facilitates data and process logic from a plurality of middleware systems to be represented and acted upon via intermediate transformation logic in a homogeneous manner. Second, a shared set of common operation primitives enable arbitrarily complex intermediate transformations to be specified once, irrespective of what type of middleware system the UDB is communicating with. Thus, transformation logic can be written once and applied to a plurality of systems, instead of requiring a unique codification for each middleware abstraction. Third, the three common characteristics of the UDB enable greater expressiveness of intermediate transformation logic, as data from multiple abstractions can be acted upon by a single IT transparently. More specifically, a UDB provides the ability to mask partition boundaries between discrete middleware systems, providing the virtualization of a unified data representation with shared common primitives for operations and synchronization. Fourth, the UDB provides the ability to define intermediate transformation logic that spans what are today a plurality of incompatible middleware abstractions. Fifth, the need to write intermediate transformations across the UDB only once, regardless of how many middleware abstractions, provides the basis for reusing such IT. Such reuse is not possible with prior art, for two reasons: (1) no such capability exists to define IT across multiple incompatible middleware abstractions; and (2) the lack of such capability prevents IT defined once to be reused across other abstractions.

A defining operational attribute of a UDB is that the SBT and DBT are transparent with respect to the intermediate transformations. Specifically, transformational logic can be expressed using the common set of shared primitives, ignoring the semantics of how the data arrives and is transformed from the source and is send and transformed to the destination. Essentially, the transformation logic is written to assume that data exists in a single representation, that of the UDB, and transformations should be defined over precisely that representation. Further, transformations defined over a UDB can only access data, attributes, and process logic from the data source and destination as it is exposed by the SBT and DBT. Equivalently, intermediate transformation logic can not access, or be dependent upon, characteristics of the source or destination data formats, representations, or middleware abstractions. Thus, there is no way to “cheat” and access the “raw” underlying source and destination data streams. This transparency contrasts markedly from prior art, where the semantics of source and destination transformation is precisely what the middleware is defining.

The source basis transformations and destination basis transformations may be composed of one or more independent steps which are composed together. For example, a DBT may transparently multiplex data contained in the UDB across multiple data destinations. Without loss of generality, a representative motivation for such multiplex semantics would be to distribute data which was represented contiguously in the UDB to multiple independent data destinations, which may utilize one or more heterogeneous middleware abstractions. Symmetrically, a SBT may transparently demultiplex data contained in multiple data sources into the UDB. A representative motivation for such demultiplex semantics would be aggregate data from multiple independent data sources, which may utilize one or more heterogeneous middleware abstractions, contiguously in the UDB.

Arbitrarily sophisticated implementations of such composition logic, defined as the semantics of individual steps along with their composition, should all be considered attributes of specific embodiments. In both of the preceding cases, the interpretation of contiguity is specific to the embodiment. For example, in the embodiment disclosed here, contiguity would be defined as a continuous set of bytes in a stream or a contiguous range of bytes in a ring buffer.

As formulated here, a universal data basis has several attributes which define it distinctly from alternative formulations in prior art.

First, universal transformation compatibility: an embodiment of a UDB must possess the capacity to support SBT and DBT for all middleware abstractions. Specifically, the UDB embodiment must be sufficiently generalized to theoretically support transformations which are feasible and well-defined. A embodiment is not required to actually define all such transformations; rather, the UDB must be theoretically capable of having such transformations defined subsequently.

This first attribute is best exemplified using existing middleware abstractions. Specifically, the complexity of middleware processes exists today precisely because there does not exist such an abstraction which is transformation-compatible with all other middleware abstractions. For example, message queues are asynchronous queue-based structures for providing loosely-coupled connectionless communication. Naturally, a message queue is, by definition, not compatible with remote procedure call, as RPC requires a connection-oriented synchronous tightly-coupled communication. Prior art has established that there does not exist transformations between a message queue and any arbitrary middleware abstraction that mutually maintains the semantics of source and destination data sources, while providing a set of primitive operations upon which intermediate transformations could be defined over. As such, a message queue does not qualify as a potential embodiment of a UDB.

Second, the operational definition of a UDB requires that an embodiment of a UDB not be the composition of two or more existing middleware abstractions. Specifically, the representation and transformation semantics of a UDB embodiment must transformation-compatible with other middleware abstractions but be defined using an alternative abstraction.

Third, for a UDB to be practically useful, embodiments of such must be amendable to acceptable performance on available hardware. Naturally, the novelty and practical applicability of the present Unified Data Basis Transformations part of the invention depends upon the ability for a UDB to be implemented practically using generally available components.

Basis transformations compared with message map transformations clearly exemplify this contrast between UDB and prior art. Specifically, message map transformations (MMT) are implemented by numerous types of middleware, with message brokers being a representative example of such. See FIG. 44 for a schematic flow representation. Specifically, MMT are instructions for converting data directly between a source data representation and one or more target data destinations. Representative examples of such MMT are schema conversions, data conversion, and protocol conversion. The advantage of such message map transformations is that they attempt to mask complexity by hiding the underlying data representation format (such as EDI or XML), while still being defined over a single middleware abstraction (message brokering, in this case). Thus, MMT are one or more intermediate transformations which define how data coming from the source is transformed such that it is compatible with the destination. In middleware terminology, the message transformation layer is the group of functionality which collects incoming data from the source, applies the MMT, and distributed the outdoing data to the destination.

In contrast to MMT, a UDB defines a minimum of three distinct categories of transformations; of those three! at most one category of transformation can be an identity transformation set. First, one or more source basis transformations define the rules for transforming data from the originating source format into the UDB. Second, one or more destination basis transformations define the rules for transforming data from the UDB into the outgoing destination format. Third, a set of intermediate transformations define the rules for how data in the UDB is manipulated to achieve the desired intermediation logic. The first and second categories can not be identity transformations, by definition, as the source and destination formats are not trivially compatible with the UDB. The third category can be an identity transformation, under the null case that data is being sent between source and destination without any transformation.

The advantage of such a unified data basis is that particular attributes of it make operations defined on data within the basis substantially easier than equivalent operations defined over individual, heterogeneous data streams not in defined in such basis. Novelty of the present Unified Data Basis Transformations part of the invention arises from the particularly combination of two boundary transformations, intermediate transformations, combined with programmatic transparency of the UDB.

One embodiment of the present Unified Data Basis Transformations part of the invention implements a UDB by transforming heterogeneous data streams into the basis via an extensible, asynchronous event-driven model. Such embodiment exposes boundaries between the UDB and the individual heterogeneous streams via either, at the discretion of the user, an unbounded bytestream or a ring buffer. Throughout the following, discussion is limited to formulation of the present embodiment via a ring buffer. As prior art demonstrates, a natural transformation between ring buffers and unbounded bytestreams exists. A bytestream can be composed by maintaining a read and write pointer in the ring buffer, and reading from the ring buffer sequentially while respecting circularity between the read and write pointers. One skilled in the art will readily recognize this is a well-established and commonplace transformation.

For this embodiment, a SBT and DBT is required for each specific middleware abstraction. Specifically, a SBT for this embodiment would accept data transmitted over a physical network interface, using the format and protocol appropriate for the middleware, and convert it into a ring buffer. Thus, irregardless of which middleware system which is communicating with this embodiment, the data and process logic communicated by the middleware system is transformed into a contiguous array of bytes over a fixed-length ring buffer. FIG. 9 diagrams the SBT transformation. Symmetrically, a DBT for this embodiment would accept data stored in a fixed-length ring buffer with contiguous array of bytes into the format and protocol appropriate for the destination middleware system. FIG. 46 diagrams the DBT transformation.

The Unified Data Basis Transformations part of the invention defines two primitive operations, which when composed recursively, are sufficient for defining arbitrarily complex intermediate transformation logic. Specifically, this embodiment defines a read operation and write operation. These primitive read and write operations are equivalent to the standard LOAD and STORE operations on the random access memory of standard microprocessors. As detailed extensively in prior art, a LOAD operation accepts a memory address, commonly within the virtual memory space of the process which is running the UDB, and returns the value stored in the random access memory at that address. A STORE operation accepts a memory address, commonly within the virtual memory space of the process which is running the UDB, and a value, then writes the value into the memory address in the random access memory. Both the LOAD and STORE operations commonly exchange data between random access memory, or some intermediate cache, and physical registers within the microprocessor.

The three categories of transformations signal transition boundaries via a conditional synchronization variable. Without loss of generality, such transition boundaries consist of completing a basis transformation: source, intermediate, and destination. Specifically, intermediate transformations wait for notification asynchronously from a SBT, indicating completion of the source transformation and requesting intermediate transformation; DBT wait for notification asynchronously from a IT, indicating completion of the intermediate transformation and requesting destination transformation. Defining a conditional variable as the synchronization primitive provides optimal performance in practical implementations, as conditional variables define a highly-efficient non-polling technique for asynchronous waiting. Among synchronization primitives, conditional variables are generally considered by prior art to be the optimal mechanism for minimizing the consumption of computational processor capacity due to waiting. Conditional variables eliminate what prior art commonly refers to as “busy waiting”.

The Unified Data Basis Transformations part of the invention encapsulates the novelty and programmatic value of a UDB by providing a natural and intuitive means to specify intermediate transformation logic: using solely read and write operations on a contiguous range of bytes in memory. Essentially, the UDB uses the SBT and DBT to transform data from the source and destination middleware systems into a contiguous region of bytes. Such a representation enables complex transformation logic, which previously had to be specified procedurally using traditional middleware programming techniques, to be specified as simplify reads and writes of memory. FIG. 47 diagrams the flow process which intermediate transformations can define over this embodiment of the UDB. Not accidentally, this embodiment of the UDB provides a perspective on middleware data and process logic which is conceptually equivalent to that of a stand-alone computer. Thus, the UDB eliminates the traditional complexity of middleware transformations by masking the physical and logical boundaries which currently partition discrete middleware systems. Moreover, this embodiment of the UDB provides a homogeneous and transparent instantiation of the present Unified Data Basis Transformations part of the invention, as a range of bytes in memory are transformed using the same techniques (read and writes) irrespective of where the data originates from or is being transmitted to.

Further, the difference between the present Unified Data Basis Transformations part of the invention and prior art is further contrasted via example programming techniques, and corresponding pseudo-code, for performing common intermediation techniques. For example, consider a simplistic example of moving data directly between two databases. Prior art defines the techniques to implement such a process “database-oriented middleware”. Technically speaking, whether this process is implemented via application logic or a database gateway is irrelevant, as the same conceptual implementation exist in either case.

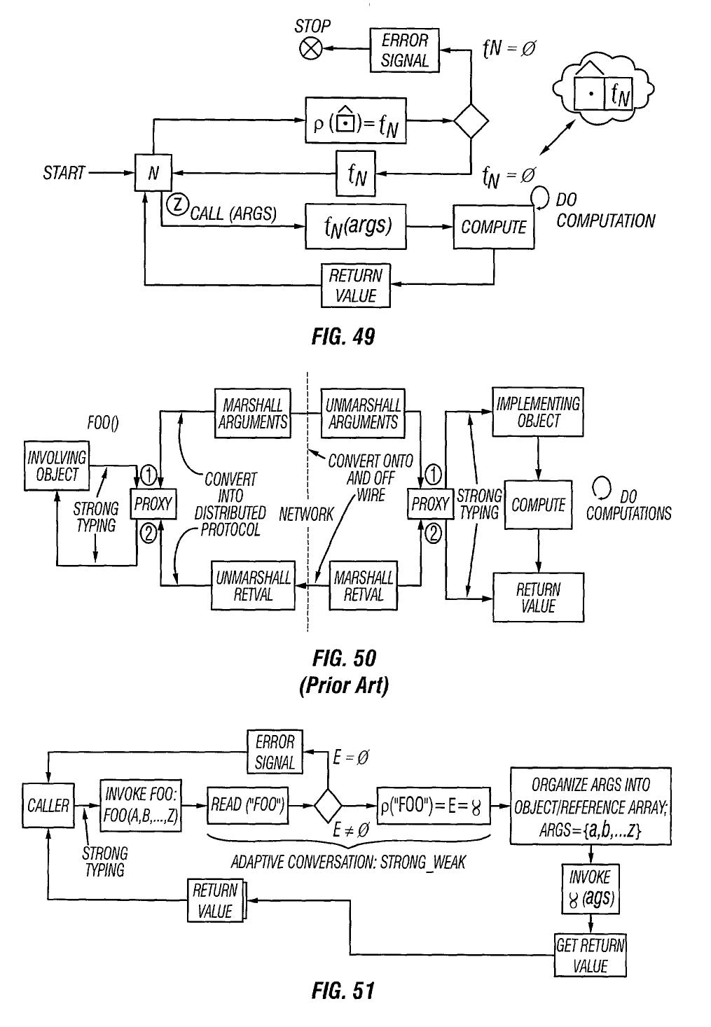

This process using techniques from prior art, diagramed in FIG. 49, would define logic roughly as follows:

(1) open connection to source database s

(2) open connection to destination database d

(3) execute database command on s retrieving data d

(4) save database command result from s

(5) transform d as required

(6) execute database command on d to send d

(7) delete d

(8) close connection to d

(9) close connection to s

The preceding logic clearly relies upon a database middleware abstraction, such as the combination of a database access standard (e.g., SQL), database wire protocols (appropriate for each database), and a defined set of operations which can be used to implement transformation of “d”.

Anyone experienced in the prior art will recognize this simplicity example could be adorned with plurality of enhancements, such as adding distributed transaction handling or performing security access checks on data being read and written. Moreover, the precise ordering of such logic can be reordered, such as inverting the first and second commands, without changing the intent of the process.

Contrast the preceding database-oriented process logic, diagramed in FIG. 50, with the following UDB logic:

(1) transform values from a source range of bytes in memory, of length n, into a destination range of byte of memory, of length m (m may or may not be equal to n)

(2) signal completion of processing via a synchronization technique

One skilled in the art will readily appreciate the advantages of this implementation, in comparison with the previous. Further, anyone experienced in the prior art will agree that the common plurality of enhancements can intuitively be defined significantly easier over the UDB process than the process defined by the database-oriented middleware.

### Zero-Copy Transparent Network Communication

The process of communicating byte streams of information between two or more independent computers is the basis for all computer system internetworking. The functionality of all network and server-based software programs depend upon such an ability. Further, the performance and usability of such programs is generally considered better as the speed of such network communication increases. As such, critical goals of computer networking include: continually increase the throughput (commonly measured as bytes/second) and decrease latency (commonly measured in millisecond delay in transmission) of physical interconnection (e.g., the speed at which packets of information are distributed between physical network interface cards), continually decrease the latency time spent processing network communication in the application, and continually decrease the latency time spend processing the network communication in the operating system kernel/libraries.

To achieve the optimal implementation of such performance requirements, the method presently considered best is to use a technique commonly referred to as “zero copy” in the prior art. Zero copy is simply a technique which copies bytes participating in a unidirectional network communication exactly once, commonly into a memory region which is shared between the user-level application and either the kernel or a memory-mapped buffer on the network interface card. Zero copy is considered ideal, as it eliminates all excessive copying between disparate memory regions. Elimination of such excessive copying is critical, as such copying requires many computer processor and memory bus cycles. These techniques are particularly important recently, as the performance provided by buses, network interface cards, and network interconnect products are now exceeding the speed at which the data being transmitted can be processed by the host computer processors on the delivery and receiving ends. As such, delivery of faster network solutions is now dependent upon eliminating these bottlenecks in the central processing unit (CPU) and random memory access (RAM) components of computers.

Over the past few years, the programming language Java has become popular for writing sophisticated network-centric software applications—as it provides many primitive network operations in its core libraries, such as streams and sockets. Transparent reflective zero-copy network communication and Java are well-suited together, as this present Zero-Copy Transparent Network Communication part of the invention defines a technique for writing next-generation network applications which are orders of magnitude higher performance than existing applications. Recently, the Java programming language was extended to include zero-copy memory support for mapping arbitrary memory regions into the Java heap management/garbage collection java virtuaL machine {JVM) algorithms, as defined through the Java native interface {JNI) As such, this present Zero-Copy Transparent Network Communication part of the invention only became feasible when such zero-copy support was provided in Java, combined with practical implementations of reflective memory.

The foregoing problems and shortcomings of the prior art are addressed by the present Zero-Copy Transparent Network Communication part of the invention, in which a method and system are provided for implementing zero-copy communication between independent computer systems while eliminating the need for explicit primitive network operations. The Zero-Copy Transparent Network Communication part of the invention is particularly, though not exclusively, suited for use as the communication technique for exchanging data between multiple independent computers organized together via multi-computing or a loosely-coupled cluster.

This method assumes the existence of a system which physically implements reflective memory between all of the computer systems (defined as “nodes” herein) participating in the network communication. Any system providing such reflective memory is suitable for use in the present Zero-Copy Transparent Network Communication part of the invention. Examples of such systems from prior art include implementations for multiprocessors, multicomputers with a shared backplane, and loosely-coupled internetworked clusters of computers.

The present Zero-Copy Transparent Network Communication part of the invention is defined as the composition of two algorithms along with˜novel method for their interdependency: a “Zero-Copy Transparent Java Network Delivery” algorithm, for the source machine participating the network interconnectivity, and a “Zero-Copy Transparent Java Network Receipt” algorithm, for the one or more destination machines participating in the network interconnectivity.

Observe that one delivery and one receipt would define a unicast network, while one delivery and an arbitrary number of receipts would define a multicast network. The algorithms defined by the present Zero-Copy Transparent Network Communication part of the invention do not differentiate, intentionally, between the two cases—as there is no difference in their implementation (as guaranteed by the defining characteristic of the underlying reflective memory), beyond the potential for reflective memoryspecific configuration details. In addition, the performance difference between unicast and multicast in many embodiments will be negligibly small, due to performance characteristics of many practice reflective memory implementations. These two attributes of the present Zero-Copy Transparent Network Communication part of the invention are also notable, as they differ from computer network communication methods and systems defined in prior art.

Each algorithm includes components whose embodiment implementation must be partitioned into two programming languages: (1) Java code which defines the class, interfaces, and implementation for the zero-copy transparent network interconnect; and (2) operating system-specific code, commonly referred to as “native code” in the prior art (when used in conjunction with Java code), providing a runtime interface between the reflective memory system and the Java code in (1). One skilled in the art will readily appreciate, the implementation details of the following zero-copy transparent network interconnect algorithms in software are artifacts of specific embodiments and not inherent attributes of this present Zero-Copy Transparent Network Communication part of the invention.

For each of the following steps which define method calls or other language-specific attributes, embodiments may choose a variety of implementation techniques (such as implementation via numerous discrete submethod calls, using dynamic type reflection, using delegation, or any other semantically-identical method) which anyone experienced in the prior art would consider equivalent as implementing the characteristics of such algorithms. Equivalently, numerous steps in the following algorithms can have their order permuted, while still retaining the same semantic interpretation; anyone experienced in the prior art would also consider such reordering equivalent as implementing the characteristics of such algorithms.

The Zero-Copy Transparent Java Network Delivery algorithm is defined by the following steps:

(1) define a Java variable “jBuf”, which is a Java byte-oriented memory array of a particular size (e.g., byte[n], where n>=0).

(2) allocate a memory buffer, termed “Buf” herein, using operation system-specific code, compatible with the reflexive memory system in use, which is shared (reflected) and made accessible in the virtual or physical memory space among all the nodes implementing Receipt algorithms as defined by the present Zero-Copy Transparent Network Communication part of the invention; this step is defined as stage 1 of a function, termed “Salloc( )”, which is implemented using native code and is invoked from Java via a “native method call” (as termed in the prior art), which is a method in a Java interface or class which is defined with a native method interface (e.g., Java method with a “native” method access qualifier).

(3) allocate a Java byte-oriented memory array and associate it with Buf, using operating system code and/or JVM-specific code (such as “java native interface”) such that reading or writing data from Jbuf in Java reads or writes data from the native memory region defined by Buf (rather than an arbitrary region of garbage collected memory in the Java heap); this step is defined as stage two of Salloc( ), which is implemented using native code.

(4) assign the value of jBuf to be equal to the returned Java memory array from Salloc( ), as executed in steps (2)-(3); One skilled in the art will readily recognize that this step and step (1) can be, for convenience, combined in a single definition and assignment statement in Java while retaining the same intent.

(5) use any combination and permutation of Java function calls, assignment statements, or other equivalent techniques to write specific byte values (either individually or in blocks) into individual byte data fields in jBuf as desired by the software program utilizing this present Zero-Copy Transparent Network Communication part of the invention to transmit data.

(6) signal completion of this algorithm to the computer systems executing the Zero-Copy Transparent Java Network Receipt algorithm via any primitive shared memory synchronization algorithm, using one or more bytes in the shared reflective, as required by the embodiment-specific synchronization algorithm; a multitude of such synchronization techniques have been defined in prior art (surveyed by Lynch 1992), and the specific implementation is considered an attribute of an embodiment rather than a attribute of this present Zero-Copy Transparent Network Communication part of the invention.

(7) upon completion of use of jBuf (either explicitly by notification by the software program or implicitly through asynchronous signaling techniques such as garbage collection), a Java native method termed “Sfree( )” (using the same definition of “native method” as defined above) is invoked to request that jBuf be deal located and its reflective memory mapping be eliminated.

(8) Sfree( ) requests that Buf be demapped from shared memory and deallocated; for reflective memory systems, this step implicitly causes any subsequent reflection between computer systems participating in the network interconnect to cease.

(9) Sfree( ) returns boolean value indicating success of the operation defined in (8), back to the software caller who invoked Sfree( ) in (7); the value of this boolean return value is defined to be equal to the success or failure of the reflective memory system to cease subsequent implicit reflection; if no such boolean value is provided by the reflective memory system, then a true return value is assumed; as one skilled in the art will readily appreciate, this step could also be implemented without a return value (a “null” return value in prior art) with equivalent intent

The data assignments in step (5) using Java are implicitly changing the shared reflective memory underlying the Java byte array jBuf, as defined by the pairwise mapping in (3) By the definition of reflective memory, such changes are automatically propagating to a corresponding shared reflective memory buffer on each of the computer systems implementing the Zero-Copy Transparent Java Network Receipt algorithm; without loss of generality, such propagation will require coordination with kernel shared memory and virtual memory mechanisms along with traffic over the shared medium connecting each of the computers participating in the interconnectivity (e.g., a shared backplane, a common bus, or a loosely-coupled cluster of computer systems internetworked by traditional wire networks such as Ethernet).

The Zero-Copy Transparent Java Network Receipt algorithm is defined by the following steps:

(1) define a Java variable “jBuf”, which is a Java byte-oriented memory array of a particular size (e.g., byte[n], where n>=0) termed “Jbuf”.

(2) allocate a memory buffer, termed “Buf” herein, using operation system-specific code, compatible with the reflexive memory system in use, which is shared (reflected) and made accessible in the virtual or physical memory space among all the nodes implementing Receipt algorithms as defined by the present Zero-Copy Transparent Network Communication part of the invention; this step is defined as stage one of a function, termed “Salloc( )”, which is implemented using native code and is invoked from Java via a “native method call” (as termed in the prior art), which is a method in a Java interface or class which is defined with a native method int˜rface (e.g., Java method with a “native” method access qualifier)

(3) allocate a Java byte-oriented memory array and associate it with Buf, using operating system code and/or JVM-specific code (such as “java native interface”) such that reading or writing data from Jbuf in Java reads or writes data from the native memory region defined by Buf (rather than an arbitrary region of garbage collected memory in the Java heap); this step is defined as stage two of Salloc( ), which is implemented using native code.

(4) assign the value of jBuf to be equal to the returned Java memory array from Salloc( ), as executed in steps (2)-(3); one skilled in the art will readily recognize that this step and step (1) can be, for convenience, combined in a single definition and assignment statement in Java while retaining the same intent

(5) wait for signal completion, for either a bounded or unbounded duration, of the corresponding Zero-Copy Transparent Java Network Delivery algorithm using a synchronization algorithm which is agreed upon using jBuf, as implemented by the computer system serving as the network interconnectivity data source for this data exchange; a multitude of such synchronization techniques have been defined in prior art (surveyed by Lynch 1992), and the specific implementation is considered an attribute of an embodiment rather than an attribute of this present Zero-Copy Transparent Network Communication part of the invention.

(6) upon signaling, if such occurs before bounded timeout, then goto (7); if no such signal occurs during a bounded timeout, then goto (8).

(7) read and use the byte values from jBuf in Java as desired by the software program utilizing this present Zero-Copy Transparent Network Communication part of the invention to transmit data; any permutation or combination of arbitrary functions can be executed during this step to achieve the desired functional result arising from the receipt of the data from the computer sending the data in the network communication defined by the present Zero-Copy Transparent Network Communication part of the invention.

(8) upon completion of use of jBuf (either explicitly by notification by the software program or implicitly through asynchronous signaling techniques such as garbage collection), a Java native method termed “Sfree( )” (using the same definition of “native method” as defined above) is invoked to request that jBuf be deallocated and its reflective memory mapping be eliminated.

(9) Sfree( ) requests that Buf be demapped from shared memory and deallocated; for reflective memory systems, this step implicitly causes any subsequent reflection between computer systems participating in the network interconnect to cease.

(10) Sfree( ) returns boolean value indicating success of the operation defined in (8), back to the software caller who invoked Sfree( ) in (7); the value of this boolean return value is defined to be equal to the success or failure of the reflective memory system to cease subsequent implicit reflection; if no such boolean value is provided by the reflective memory system, then a true return value is assumed; as one skilled in the art will readily appreciate, this step could also be implemented without a return value (a “null” return value in prior art) with equivalent intent.

In the terminology of prior art, the present Zero-Copy Transparent Network Communication part of the invention is defined as reflective memory (as opposed to shared memory): bytes written to the shared reflective buffer are automatically propagated to all computer systems participating in the network interconnectivity, without any required intrinsic synchronization support (although using such a network communication technique requires such to provide completion signaling). Thus, there is intentionally no support for cache consistency or other techniques which attempt to mask write latency, mask read latency, or reduce the need to transfer bytes between systems via optimization algorithms (although such could be added to the present Zero-Copy Transparent Network Communication part of the invention as desired by the user)—the intention is to define fully reflective memory between each of the participating systems and use such as a network communication abstraction.

The definition of the preceding algorithms illustrate several key defining attributes of the present Zero-Copy Transparent Network Communication part of the invention. First, the present Zero-Copy Transparent Network Communication part of the invention uses a “zero-copy” communication technique: the bytes of the byte array jBuf are not transferred to a secondary buffer before or-during network communication. This differs from network communication methods from prior art, such as sockets or streams, which require that jBuf be transferred to such an intermediate buffer (usually to a kernel communication buffer or a network buffer interface card) to implement the logical and/or physical transmission.

Second, the present Zero-Copy Transparent Network Communication part of the invention relies upon a “transparent” network communication technique. No input/output or socket methods are invoked to signal or implement data transmission between computers participating in the network interconnectivity. Instead, data transmission is implicitly signaled and occurs upon writing values into the byte array jBuf. This transparency attribute is critical, as it defines the means to achieve the remarkably low-latency and high-performance characteristics of the present Zero-Copy Transparent Network Communication part of the invention. In terminology defined in prior art, this attribute of the present Zero-Copy Transparent Network Communication part of the invention is commonly termed “transparent”. As such, reflective memory used in this manner provides a flexible programming model which can implement techniques pioneered in symmetric multiprocessing (SMP) computer systems: message passing and shared memory. Reflective memory in Java provides these benefits specially for computers that are organized using multi-computing and loosely-coupled clustering.

Finally, transparent network communication is also superior than existing network as it eliminates the traditional latency and computational performance cost associated with network protocol stacks, such as TCP/IP. Specifically, reflective memory using a transparent zero-copy mechanism is not processed by the operating system networking infrastructure; instead, it is mapped directly into memory, without loss of generality, through direct memory access (DMA) and user-kernel memory mapping.

### Automated Systems Integration

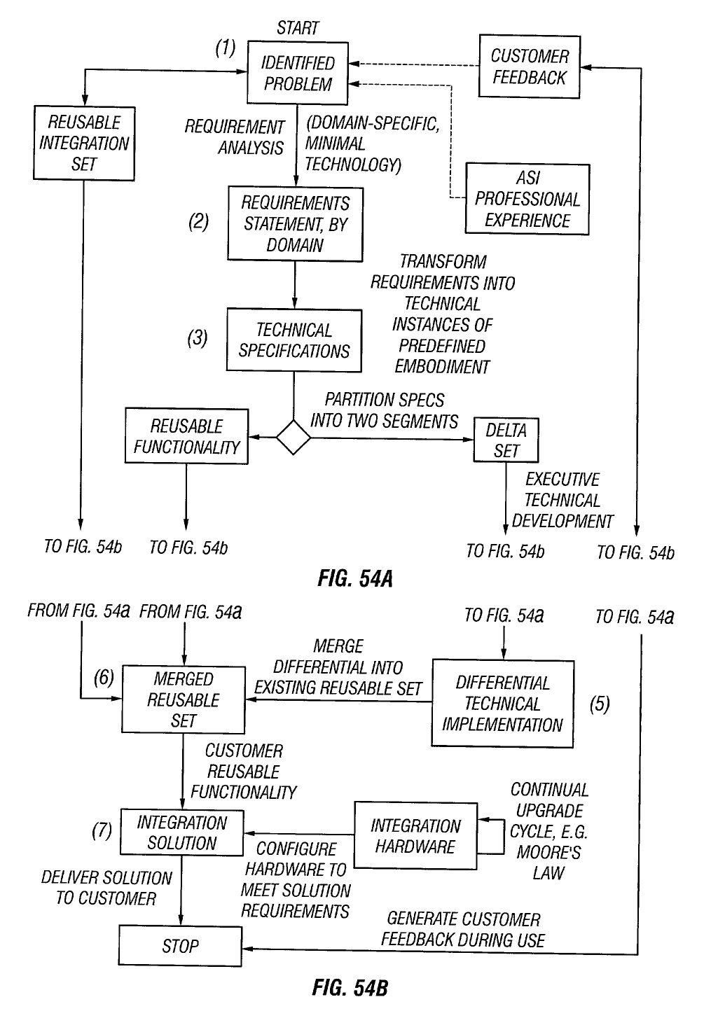

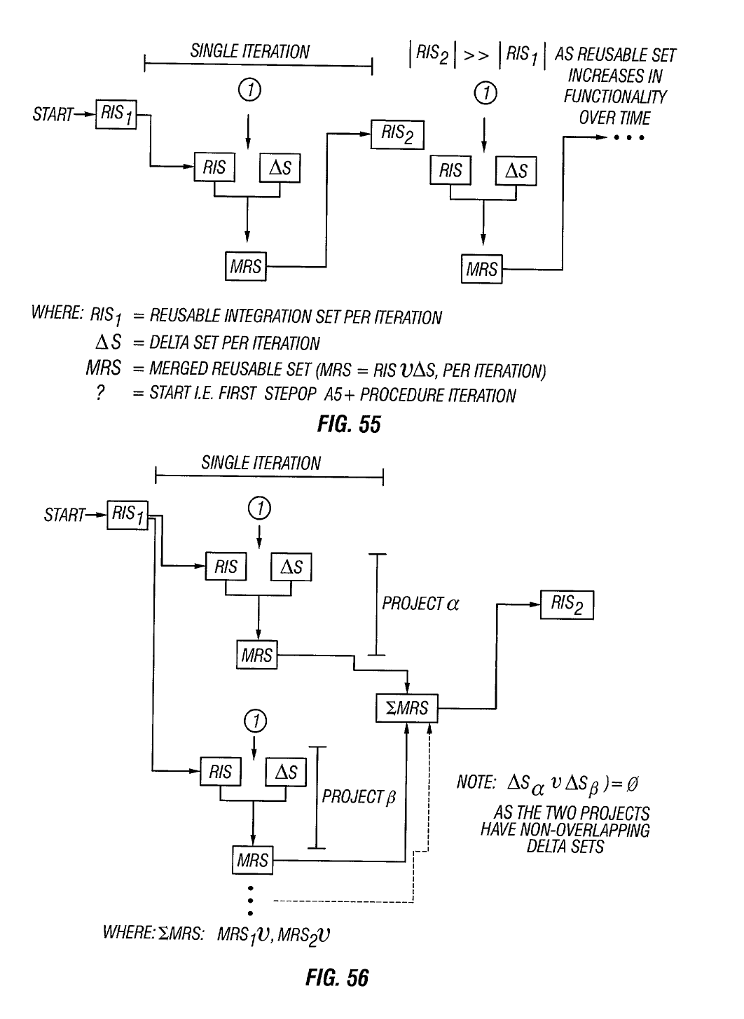

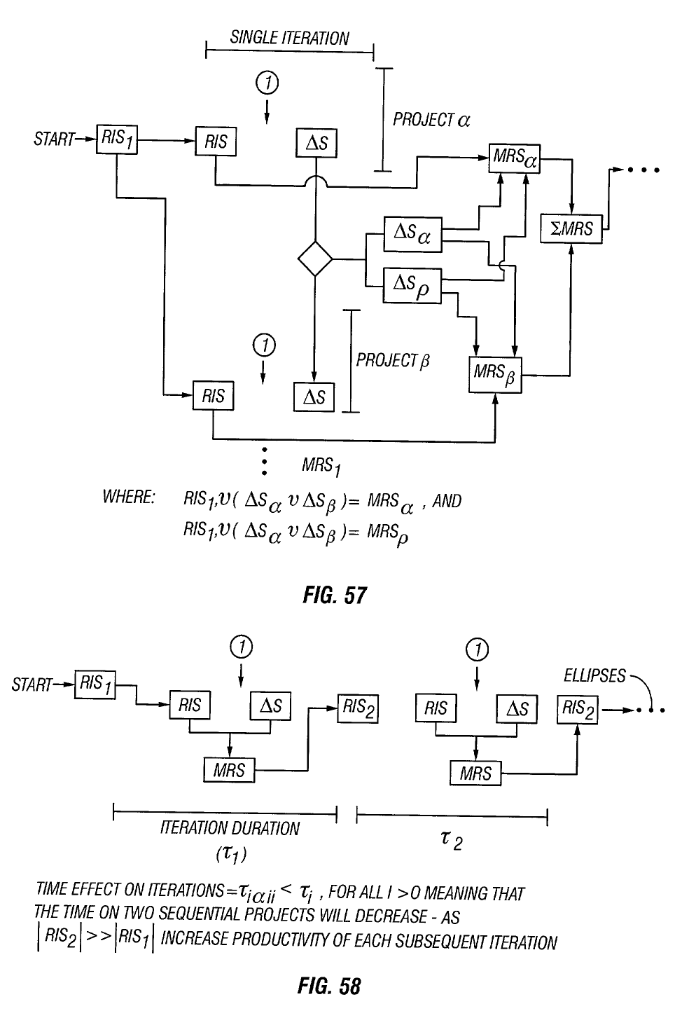

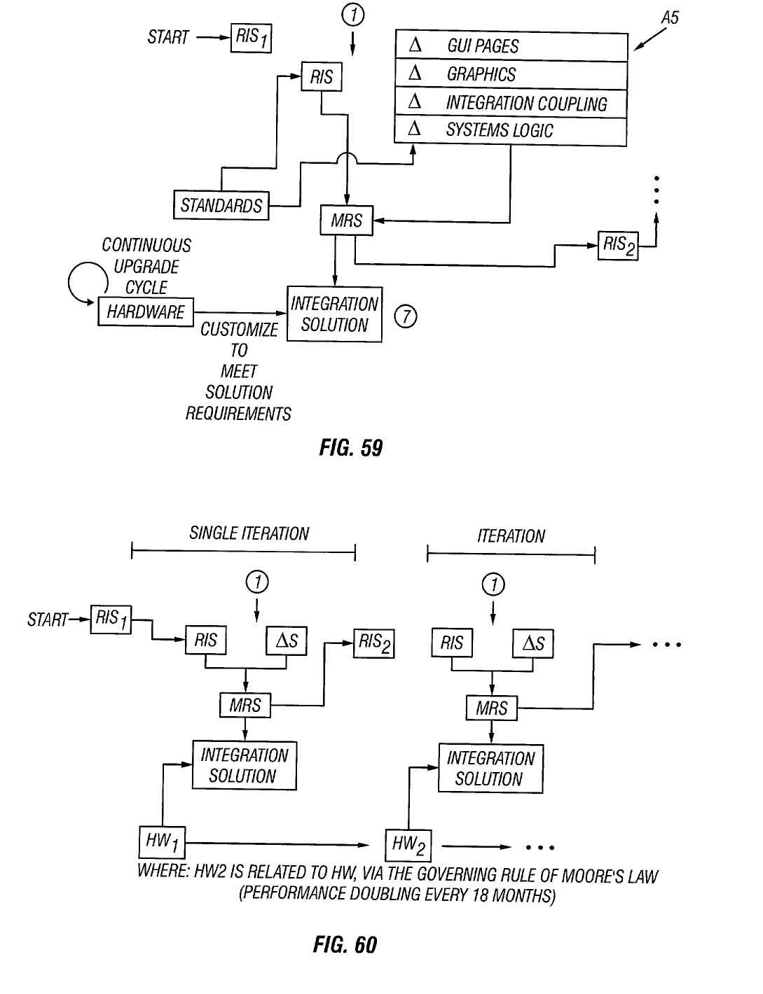

Systems integration (SI) is the field of technology concerned with making one or more discrete computers exchange data and retain process state, as part of a domain-driven process that spans a plurality of discrete computer systems. The profession of systems integration is practiced by a group of companies which are henceforth individually referred to as “SI groups”. FIGS. 54a, 54b, and 55-60 correspond to the following description of the Automated Systems Integration pair of the invention.

Data exchange is the general practice of moving bytes of information between independent computers via communication networks. Such exchange can occur between computers that are owned by a single entity, or between multiple entities. The bytes of data in any such exchange are often formatted in heterogeneous types; this lack of common format arises because the data being exchanged originates from the plurality of different computer programs using a plurality of different data format standards (e.g., ASCII text files, structured query language (SQL), or extensible markup language (XML)).

Process state is the computer representation of the “roadmakers” for the logical process flow which the data exchange is implementing. Specifically, all computer programs have a defined process flow which the instructions of the software and hardware program execute for such exchange. For programs which move data between multiple computers, the logical “roadmarkers” for this process are distributed across each of the computer participating in the process. Process state manifests as bytes stored in random access memory (RAM) and persistent storage (such as a hard drive) of each of the computers participating in the process; the software programs controlling the data exchange define the “rules” (or set of logical conditions and constraints) for how and when such process state is defined and saved into RAM or persistent storage. Thus, maintaining process state is a cooperative activity between the software, providing the algorithms and software logic for the process, and the hardware, storing the state data arising from execution of the process.

Ensuring such process state remains consistent between each of the participating computers, as well as continues to accurately reflect the intention of the integration process which the human operator is requesting of the computers, is of particular significance. In many systems integration problems, maintaining consistent process state is one of the most technically challenging aspects. This is significant as it motivates many of the technical implementation details in such systems integration solutions.

As a discipline, systems integration is practiced today via two alternative means: service-driven and product-driven. These two means are the primary techniques through which actual businesses deliver systems integration to users. Throughout the following, an “integration solution” is defined as implementation of a group of interdependent hardware and software to solve the requirements for a particular integration process requiring data exchange and process state maintenance. Hereafter, the term “customer”. is defined as the one or more entities seeking such integration solutions.

Service-driven systems integration (SDSI) is a human-intensive process driven by a group of interdisciplinary individuals, each with complementary domain-specific areas of expertise, coordinating to implement an integration solution. Such a solution delivered to the customer is composed of a set of technology components, such as computer servers and software, which have been combined together intelligently to meet the specific integration problem. Despite the end result being a tangible technology solution, the real value provided by service-driven SI is the expertise and knowledge contributed by the individual human members of the SI group—not the individual technology components. By definition, service-driven systems integration assumes the existence of an interdisciplinary group of domain experts, along with a group of enabling technology which they customize to develop customer solutions. Although other services may be provided by the SI group, such as user training, such non-technology-driven services are considered outside the scope of the systems integration practice.

This means of performing systems integration has several defining attributes; anyone knowledgeable in the art would appreciate that any particular firm practicing service-driven systems integration, may exhibit only a subset of the following attributes or may possess some modest variance of the strict attributes define below; despite such variance, the intent of the firm remains the same.

First, service-driven systems integration is, with few exceptions, structured around performing discrete projects for specifically identified customers; the scope of work of a particular “project” is defined as the process of solving that single customer's problem. The economic justification for service-driven systems integration lies in charging higher rates per project than the cost of implementing the project in terms of human labor and physical technology.

Second, the process of implementing a specific SI problem results in little or no tangible intellectual property (IP) which can be reused for future projects—thus, SI groups rarely develop software which can be reused between projects. In many cases, the only IP which is maintained from project-to-project for SDSI groups is the knowledge which the group members gain iteratively during their projects. Further, the structure of customer agreements for service-driven SIs, between the customer and the SI group, often stipulate that all tangible intellectual property developed during the course of any such project is owned by the customer; equivalently, many SI groups are contractually prohibited from reusing tangible IP developing during such projects.

Third, service-driven SI groups rely upon a trusted group of independent technology firms who provide computer hardware and/or software, upon which the systems integration solutions are built by the SI group. Oftentimes, a significant fraction of the value provided by SI group to customers is encapsulated in the training and technical expertise which the group possesses in using their selected set of technology components to solve a specific business problem. The key characteristic about this attribute is that the service-driven SI group is independent from the technology partners firms providing hardware and software.

Fourth, service-driven SI groups use whatever set of technology tools are necessary to solve the problem defined by the customer; specifically, the SI group rarely maintains specific allegiance to a particular piece of hardware or software from project-to-project. Equivalently, the service-driven SI is customer- and solution-oriented, rather than product-oriented.

Fifth, customers buying the expertise of service-driven SI often narrowly define the problem being solved, to ensure the role and scope of the SI group is clear. This narrowing of the problem domain is deliberate and based upon the economics of service-driven SI: the more expansive the problem, the exponentially greater the total cost to implement a solution.

The practice of service-driven systems integration generally follows a procedural process; anyone familiar with the art will recognize that specific firms usually vary these procedural steps modestly, to accentuate their particular mix of knowledge, expertise, and financial resources. Specifically, this process consists of the following steps: problem identification, analysis of existing technology systems, in-depth discussion with people employed by the customer; technology design and architecture, technology implementation, validation, testing, and follow-up. As exemplified by the attributes above, consultation and close communication between SI group and customers is a critical characteristic of this process from project initiation to completion. Such steps need not be executed strictly in the order defined above; specifically, the SDSI process is often practiced with modest variation in the order of such steps

Service-driven systems integration begins with problem identification, which is the communication-, time-, and human-intensive process of working to carefully identify the problem being proposed by the customer; this phase is termed the “exploratory phase” herein. Subsequently, the process continues by the SI group analyzing the type of technology products installed in the customer's facilities and the specifics of how the customer uses such technology in the business processes. A critical component of these first two steps is in-depth communication between the SI group and employees, of various skills and positions. The output of this phase is usually some form of tangible documentation which defines, quantifies, and qualifies the problem being considered for resolution via an SI project.

Forthcoming from the exploratory phase is design, specification, and development of the technology components of the systems integration solution. Essentially, this “implementation” phase is primarily concerned with customizing a set of computer hardware and software to meet the requirements specification defined in the exploratory phase. Herein, the SI group relies upon the independent technology firms to bring hardware and packaged software appropriate for the solution, which the staff of the service-driven SI then customizes using their proprietary knowledge and expertise.

Finally, the group of computer hardware and software which has been customized by the SI group is installed into the customer facilities. The installation phase includes multiple steps: physical installation is required to make the hardware or software available the customer facilities; validation is required to verify the solution meets the customer requirements which were identified during exploratory phase; and testing is required to verify the solution is technically compatible with the other hardware and software used by the customer. After the installation phase, there usually is some fixed duration of time during which the customer remains in communication with the service-driven SI group, to note any anomalies or deviations from the specified requirements with the installed solution.

An important observation to retain from the preceding description of the SDSI practice is that there exists a wide degree of variance in how such a discipline could be performed in practice; one skilled in the art will readily recognize that within each phase, the various substeps can be executed in almost any order. In addition, there does not exist a universally agreed upon order in which to execute these substeps. As such, any translation of SDSI into a strictly ordered procedural set of mechanical steps would by definition not accurately reflect the variance in how individual SI groups practice SDSI.

Product-driven systems integration (PDSI) is the codification into software of solutions to specific problems pertaining to the integration of data or program state within computer systems. The essence of product- driven SI is identifying integration problems faced by a group of customers, then developing and commercializing software which solves such problems. The limiting factor of product-driven systems integration is how quickly integration problems can be identified and solutions for them codified into software. While such integration problems are often identified in conjunction with customers, the goal of product-driven systems integration is to solve customer integration challenges for many through use of a single, standardized, fixed, well-defined set of features. Product-driven systems integration assumes the existence of group of experts with expertise in their appropriate domain and software development.

As with any software domain, there exists a myriad of software available for many common integration problems. This means of performing systems integration has several defining attributes; one knowledgeable in the art will appreciate that any particular firm practicing product-driven systems integration may exhibit only a subset of the following attributes (or may possess some modest variance with the strict attributes define below); yet, the intent of the firm remains the same.

First, product-driven systems integration is iterative: the features of the software are fixed at non-arbitrary intervals in time and a distinct product with such features is given, an identifying mark (such as a version or year) and commercialized as a discrete entity. Thus, product-driven integration contrasts markedly with service-driven integration, as product-driven integration is based upon fixed release dates with defined feature sets, rather than being project-driven. In contrast to service-driven SI, product-driven SI develops their products outside the scope of a particular customer during the development phase.

Second, product-driven SI is not concerned necessarily with meeting every conceivable requirement of a particular customer, but rather defining a generalized piece of software which can conceivably meet most requirements of a group of customers. The economic justification for product-driven integration follows from the belief that the integration product should cost a fraction of the total cost of development, while revenue is instead generated by selling the product to the broadest group of customers.

Third, products derived from product-driven SI may be customizable to a limited degree, through only within a narrowly-defined parameter space through such techniques as macro languages, graphical configuration, or other product-specific features. Although this constitutes a degree of customization, each software package is constrained within the design, architecture, and integration perspective which the software embodies. Specifically, the type of customization is fixed at the time of feature stabilization and commercialization.

Fourth, product-driven SI does not produce a complete solution; rather, product-driven SI provides the software which some trained domain-expert must purchase, install, configure, deploy, and manage. Specifically, product-driven SI predominantly lacks any people-driven processes. This contrasts with service-driven SI which delivers highly-specialized solutions to specific customers.

Fifth, product-driven SI is predominantly subject to the well-documented economic effects of software: relentless addition of new features until few competitors remain or the market demand disappears. Thus, product-driven SI develops monolithic software which gradually adds new features over time. Further, the features of such products can rarely be segmented or subsetted intelligently, preventing individual customers from choosing exclusively those features which are needed. Instead, in the name of maximizing the potential base of customers, such products often assimilate nearly every conceivable feature which could possibly be required by a customer. In contrast to service-based integration, customers bias towards buying more features than are immediately needed with the belief that at some future time the features unused today will be needed.

Sixth, product-driven SI is built around iteratively delivering a specific product. Specifically, such products usually have several defining characteristics which remain predominantly stable over various iterations. For example, the graphical “look-and-feel” of the software usually stays consistent; the set of programming interfaces (commonly referred to as application programming interfaces, or APIs) which the software makes available often remain backward-compatible and only evolve to include more features; the approach or “software paradigm” which the software uses to implement integration generally remains consistent.

The practice of product-driven systems integration differs dramatically from service-driven systems integration, as implied through the attributes enumerated above. Product-driven systems integration follows an iterative process, usually termed “product development cycle” within the industry; this process consists of the following steps: domain selection, problem definition, paradigm selection, requirements specification, trade-off analysis, feature selection, technical specification, architectural design, implementation, validation, internal testing, and external customer testing. For the majority of products built from product-driven systems integration, the duration of this iterative cycle commonly extends a year or more. Further, anyone knowledge in the art recognizes that these product development cycles require extensive time commitments from an interdisciplinary team of domain exports; certainly such products are not developed hastily or without extensive planning and documentation.

Product-driven systems integration can be considered as a specific instance of software development, as implied by the preceding discussion. Product-driven systems integration is concerned with designing a piece of software which solves a specific problem requiring data exchange or maintenance of process state. One skilled in the art will readily appreciate that a broad group of published literature exists on software development models, as elaborated in the references, and as such a discussion on such is abbreviated to include what is defined above. As is also exemplified by the broader software development industry, anyone familiar with the art will recognize that specific firms usually vary these procedural steps modestly, to accentuate their particular mix of knowledge, expertise, and financial resources.

Similar to SDSI, PDSI cannot be accurately translated into a strict procedural set of mechanical steps, as such by definition would not accurately reflect the variance in how individual PDSI groups develop their products. The existence and practice of a large number of software development methodologies, many of which are mutually contradictory in their prescriptions, clearly exemplifies this practice to anyone familiar in the prior art.

In several respects, product-driven and service-driven systems integration represent two extremes in their prototypical and practical forms. In terms of customization per customer, SDSI represents absolute individual customization while PDSI represents mass production. In terms of cost, SDSI depends upon charging customers above the production cost, while PDSI amortizes development cost over the broadest group of customers possible. In terms of features, SDSI seeks to precisely meet the customer needs, while FDSI seeks to maximize relevant features. In terms of structure, SDSI is “one-off” project-oriented while, FDSI is product-oriented and iterative. In terms of tangible intellectual property, SDSI develops little reusable IP, while PDSI is built around the sale of software which is legally protected against unauthorized redistribution via copyright law.

Both SDSI and FDSI share three common aspects: complexity, time requirements, and supply cost. Both systems integration methods rely upon an interdisciplinary group of domain experts coordinating to develop a highly sophisticated solution—essentially, SDSI and PDSI are human-centric processes which are not amendable to optimization or automation via computers. The result of this complexity is that systems integration require extensive time and cost to implement effectively. The cost of both is driven by the high salary costs of domain experts, working either for a single customer (SDSI) or towards a common group of customers (PDSI); the time requirement for both arises from the inherent complexity of the problem and the relatively small set of technology tools used by either technique to increase the productivity of individual group members.

The invention pertains to a method and system for automating the identification, design, and implementation of systems integration solution for delivery to customers as implemented by a SI group using a novel business process which relies upon five technology components designed for this purpose; the method and technique defined by the present invention is termed “automated systems integration”, as it defines a process which is highly-automated by use of such technology components. Automated systems integration (ASI) assumes the existence of five distinct, yet interdependent, components of technology:

(1) configurable hardware: specialized type of computer hardware which is suitable for rapid, flexible customization while explicitly compatible with the other components.

(2) systems logic: common reusable set of software logic which implements primary software algorithms and program logic, which can be organized into discrete components and is appropriately designed to be compatible with the specialized hardware.

(3) graphical user interfaces: a reusable set of graphical user interfaces (GUI) definitions which can be flexibly combined in arbitrary ways, to produce a plurality of GUIs. Such graphical definitions are defined in one or more graphical definition languages which are mutually compatible, either directly or via intermediate transformation.

(4) common technical standards: a set of common technical standards which describe the characteristics of data, software program structure, hardware interfaces, data boundaries, security mechanisms, error handling, and other semantic attributes of the data exchange and process state.

(5) integration coupling: a set of highly specialized computer compilers, runtime environments, application servers, transformation languages, data interfaces, and asynchronous process state maintenance mechanisms which interpret and implement the systems integration using the automation common standards, reusable systems logic, and reusable graphical interface definitions.

Through the present invention, the preceding five components are referred to in aggregate as “standardized automation components”, as they define the components which facilitate automation of the systems integration process. While not intended as part of their definition, ASI automation components can conceptually be thought of as a highly-specialized and novel type of “integration toolbox”, or set of interdependent technical tools which collectively facilitate automated systems integration.

One skilled in the art will readily appreciate that these five components could either be owned by a single company, which then executes the following process individually, or owned by several companies which cooperatively execute the following process. Irrespective of the division of ownership of the individual components, the present invention defines a method and system for automating system integration via such components (provided they meet the defining attributes enumerated herein).

Automated systems integration is a cyclic and iterative set of well-defined procedural steps, defined below, implemented by an automated SI group. ASI is cyclic as the process is performed on an on-going basis, and multiple such instantiations of this process may be optionally performed concurrently. Further, the ASI group executes such procedural steps iteratively in the order which they are presented below.

Several contrasts between ASI and SDSI/PDSI can be identified from its definition. First, ASI depends intimately upon the existence of the preceding technology components and strict adherence to the following process. Specifically, a systems integration practice would not be in the spirit of the method and system defined by the present invention if either of these conditions is not meet. This contrasts with PDSI and SDSI which, by their definition, rely exclusively upon the SI group and not any specific structured set of technology.

Second, ASI explicitly supports performing the following process concurrently, while PDSI and SDSI are sequential processes. For PDSI, the PDSI group may develop multiple products independent, but each individual product is only capable of defining a fixed set of features; thus, product development by the PDSI group on each single product can only, by definition, proceed along one path. For SDSI, each individual SI group member only has a fixed amount of hourly time available to contribute to systems integration projects; once such time is fully allocated to active projects, there is, by definition, no capacity for that individual to contribute to additional projects. Thus, the primarily resources for both SDSI and PDSI are inherently allocable in non-concurrent practice.

Automated systems integration consists of seven phases, summarized for convenience (but not a strict definition): (1) problem definition; (2) translation of problem definition into set of requirements; (3) distillation of technical implementation specification from requirements; (4) identification of set of technical features not presently available from standardized automation components; (5) implementation of the presently unavailable features identified previously; (6) merging of newly developed capabilities into standardized automation component's; (7) offering of solution to customers based upon aggregation of features from automation components. These phases are defined in detail below.

First, the ASI group identifies and defines a specific systems integration problem, with well-defined attributes, based upon professional experience or communication with one or more potential customers. An essential attribute of such a problem is that the ASI group believes that the problem affects more than a single potential customer. As such, the definition of an ASI problem differs from SDSI in that problem identification and definition exists outside the scope of a specific systems integration project for a individual customer.

Second, the ASI group takes the problem definition and translates it into a set of specific requirements which fall into the following well-defined set of “requirement domains”; anyone familiar in the prior art would recognize this step as a highly-specialized type of formal requirements analysis:

(1) user interface functionality: set of graphical user interface (GUI) definitions for how the customer will manually interact with the solution.

(2) logical data interfaces: quantity and type of independent computer systems (and their corresponding protocols and data formats) for which the solution is providing logical data exchange and process state maintenance via logical network and protocol algorithms (broadly considered to be algorithms which define interpretation of data residing in level 5+in the OST network stack).

(3) physical data interfaces: quantity and type of independent computer systems (and their corresponding protocols and data formats) for which the solution is providing network connectivity and physical data exchange via physical network adapters.

(4) persistent state rules: type and interpretation of data being exchanged between independent computers which must be saved between discrete computations via software algorithms, program logic, and storage devices attached to the specialized hardware.

(5) event handling: the synchronous and asynchronous software algorithms and program logic appropriate to handle event-driven procedures, such as triggers, time-based timers, and automated polling.

(6) transaction boundaries: use of atomic/consistent/isolated/durable (ACID) properties to define divisible boundaries between discrete computations (commonly referred to as transactions, in the prior art) in the data exchange and state maintenance processes to provide appropriate fault-tolerance, exception recovery, rollback, and retry semantics and via software algorithms.

(7) privilege enforcement: set of security conditions, event auditing, privilege states, secure-insecure transition boundaries, and logical roles which must be adhered to by the solution to meet customer requirements for security and privacy.

(8) error handling procedures: detection, handling, human notification, automated escalation, persistent record, graphical display, and reporting policies for how deviations occurring at runtime are handled by the solution via software algorithms and program logic.

(9) business rules: set of overarching technically—definable conditions (commonly known as “meta-rules” in prior art) which govern the implementation and semantics of the solution processing of each component via software algorithms and program logic.

Third, the ASI group transforms these requirements onto the technical specifications which the AST is standardized upon. This step results in the development of technical implementation guidelines for how to construct a solution, using the ASI automation components, which meets the functional requirements previously identified. While this present invention defines the general mechanism for such, anyone familiar in the prior art appreciates that the specific practice of this transformation depends upon each standardized automation component; specifically, each preferred embodiment of the present invention may define a particular means for performing such transformation for each standardized ASI automation component. Essentially, this step is composed of the logical composition of each of the transformations into technical automation components from functional requirements.

A critical observation about such requirement-component transformations is that there is a one-to-many relationship: each functional requirement may result in implementation requirements in one or more standardized ASI automation component. The key novel characteristic of this relationship is that it remains consistent during each iteration of the cyclic process (as opposed to varying based upon the semantics of the specific project as in SDSI, or varying based upon the formulation of the discrete product as in PDSI). As such, this relationship and the transformation process joining the two is considered to be a static attribute of ASI.

Fourth, the ASI group proceeds to identify which technical specifications cannot be implemented with the existing functionality provided by the ASI automation components. The set of new functionality, defined in the requirement domains for the present iteration yet not satisfied with existing automation components, is termed the “delta set”. The delta set is the composition of all of the individual differential set of features required in each standardized automation component.

Although the precise semantics of the delta set depend upon the technical standards of the preferred embodiment, general rules can be defined for the domains defined in the requirements analysis (the following list corresponds directly to the preceding list of requirement domains):

(1) user interface functionality: the portions of graphical user interface (GUI) definitions which have not been defined previously by ASI iterations via the GUI definition language; equivalently, the solution may require a “look-and-feel” (defined as the style attribute of the GUI definition language, which may or may not be divisible from the textual or image content) which differs from ASI iterations.

(2) logical data interfaces: the specific protocols and data formats, or subsets or specialized dialects therein, which have not been previously defined by ASI iterations.

(3) physical data interfaces: the specific network protocols, communication networks, or interconnection designs which have not been previously defined by ASI iterations.

(4) persistent state rules: the software algorithms and program logic necessary to persist data appropriately based upon the requirements of the integration solution which have not been previously defined by ASI iterations.

(5) event handling: algorithms and program logic necessary to support specialized types of asynchronous or synchronous event handling which have not been previously defined by ASI iterations.

(6) transaction boundaries: define the boundaries of data exchange and program state which require use of ACID properties to ensure proper fault-tolerance, exception recovery, rollback, and retry semantics for the data and process state involved in the specific integration solution.

(7) privilege enforcement: definition of the security states, transition boundaries, privilege states, and logical roles which are unique to specific integration solution and have not been defined by previous ASI iterations; and the appropriate software algorithms and program logic necessary therein.

(8) error handling procedures: definition of the error detection, escalation patterns, persistent record keeping, graphical display, and reporting necessary for the specific integration solution; and the appropriate software algorithms and program logic necessary therein.

(9) business rules: specific technically-definable conditions which are unique to the specific integration solution and have not been defined by previous ASI iterations; and the appropriate software algorithms and program logic necessary therein.

This stage is the crux of the novelty of the method and systems defined by the present invention, as it utilizes the critical mechanisms which enable the automation provided by ASI:

(1) reusability: discrete components of functionality provided by the ASI automation components can be utilized independently for implementing multiple concurrent, distinct iterations of this process.

(2) rapid and flexible customization: ability to utilize a set of tools which manipulate ASI-standardized technologies quickly and easily to meet the specific iteration-specific requirements; the exact definition and usage of such customization tools depends upon the nature of the standardized automation components defined by the preferred embodiment.

(3) technical standardization: all solution implementations using this iterative process implement technology which adheres to a well-defined and agreed upon set of technology standards; in essence, reusability and customization depend upon such adherence almost by definition.

(4) design homogeneity: all of the ASI automation components, along with the process for how requirements are transformed into implementation standards, share a common technical design theme; each of the technical standards used by the automation components are mutually compatible, appropriately chosen to work cohesively together, and designed to minimize the time required to perform an ASI iteration.

(5) common decomposition and transformation: such reusable automated solutions depend upon each iteration decomposing problems into requirements similarly and using the same standardized approach to transform requirements into technical specifications.

Fifth, the ASI group proceeds to implement the functionality required in the five automation components necessary as identified in the delta set. This implementation occurs in a well-defined and methodical manner, with the precise semantics depending upon the automation component defined by preferred embodiments.

This development phase has two explicit intents, one independent and one dependent. The independent intent is to implement and standardize the technical functionality which does not yet exist in the automation components, from the delta set. This primary independent intent is critical to understanding the objective of ASI integration: although the delta set arises from the ASI iteration for a specific integration problem, the first and foremost intent of this development phase is to facilitate augmentation and standardization of the new functionality provided in the automation components. Equivalently, the real goal of the cyclic ASI iterations is to rapidly implement and standardize systems integration functionality. The secondary, and dependent, intent of this phase is to then utilize the standardized automation components to solve the specific integration problem considered by the ASI iteration, after the delta set has been implemented and standardized.

The magnitude and complexity of the delta set of each subsequent iteration decreases exponentially, as the standardized automation components continue to gain additional new differential functionality on each iteration. This exponential reduction in complexity and time enables automation; such automation can be expressed logically as: functionality in the delta set for iteration i will never need to be implemented in iterations (i+1), (i+2), . . . (i+n). As such, this cyclic and iterative process of systems integration results in automatic driven by standardized components which are augmented with new functionality over time.

Sixth, the technical functionality implemented to meet the requirements defined by the delta set are merged into the standardized automation components. This phase implements the independent intent facilitated by the development phase.

Finally, using the standardized automation components, a solution to the specific integration problem being addressed by the ASI iteration, can be built by simply selecting and combining the appropriate set of components into a complete solution. Specifically, the graphical user interfaces and reusable systems logic is interwoven together using the integration coupling and loaded onto the configurable hardware. This interweaving process is defined by the shared technical standards and the semantics of the integration coupling—the precise semantics of which are defined by each preferred embodiment. Finally, this complete solution is delivered to all the customers who state requirements which match those defined in the requirements domain. This phase implements the dependent intent facilitated by the development phase.

As exemplified through the preceding description, a key characteristic of ASI which differentiates it from SDSI and PDSI is the fact that ASI can be practiced concurrently: multiple instances of this process can be performed at the same time, using the same set of ASI automation components. Moreover, ASI is a cyclic process which is repeated as necessary to meet disparate customer requirements. In contrast to PDSI with its long timetables, ASI implementations can have durations lasting from weeks to months.

In contrast to SDSI, each iteration of ASI may not necessarily meet all the known requirements of any single customer. Thus, multiple iterations may be necessarily to develop independent ASI solutions which can be subsequently joined to provide comprehensive solutions to the defined problems of a given customer. As such, anyone skilled in the art recognizes that ASI differs non-trivially from SDSI, as the explicit intent of SDSI is to implement a solution which satisfies the perceived requirements of the customer.

To ensure clarity of the preceding summary, several comparisons can be made between automated systems integration and service- driven/product-driven systems integration.

One skilled in the art will readily appreciate that the preceding process can be implemented to various degrees of success. Specifically, the ASI group may decide to implement systems integration using the ASI technique, but do so poorly based upon a set of systemic or idiosyncratic characteristics about their individual members, customers, or other influences. As such, even a poor implementation, defined as having the intention to adhere to each phase but not being able to effectively operationalize such adherence, would be considered an instance of the method and system defined by the present invention. As one skilled in the art will readily recognize from experience, many companies attempt to perform the idealized process of SDSI and PDSI, yet in doing so, poorly operationalize the requirements for each phase. Despite their success or lack thereof, each of these companies is still considered to be implementing their respective technique of systems integration.

Automated systems integration is a technology-centric process, which relies upon a set of highly-customizable and standardized automation components. The automation in this method and system arises from leveraging highly-customizable hardware, firmware, software, and graphical layout components combined with a well-defined process for iteratively identifying systems integration problems, implementing their solutions, and delivering the resulting integration systems to a plurality of customers. This entire process revolves around specially-designed systems integration customization tools, which automate and standardize the majority of this process.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A process for an integration system that exchanges data between application protocols, comprising the steps of:
providing at least two interface cards;
wherein each interface card is configured to send and receive a specific application protocol; wherein each interface card is communicably connected to a computer system;
wherein said interface cards are connected to a common interconnect;
wherein a first interface card converts a received first application protocol bit stream into a multi-dimensional matrix representation of said first application protocol;
wherein a first interface card converts said first application protocol multi-dimensional matrix into a multi-dimensional matrix representation of an intermediate language;
wherein said first interface card sends said intermediate language multi-dimensional matrix to a second interface card;
wherein said second interface card converts said intermediate language multi-dimensional matrix into a multi-dimensional matrix representation of a second application protocol;
wherein said second interface card converts said second application protocol multi-dimensional matrix into a second application protocol bit stream; and
wherein said second interface card sends said second application protocol bit stream to a computer system.

2. The process of claim 1, wherein said first interface card performs said conversions on a frame basis.

3. The process of claim 1, wherein said first interface card uses a first finite state machine to perform said first application protocol bit stream conversion, and said first interface card uses a second finite state machine to perform said first application protocol multi-dimensional matrix conversion.

4. The process of claim 3, wherein said finite state machines use a lookaside buffer to retain previous states.

5. The process of claim 3, wherein said finite state machines use configuration tables and exception tables to adjust the finite state machine's conversion behavior.

6. The process of claim 5, wherein said configuration tables and said exception tables are user configurable.

7. The process of claim 1, wherein said second interface card uses a first finite state machine to perform said intermediate language multi-dimensional matrix conversion, and said first interface card uses a second finite state machine to perform said second application protocol multi-dimensional matrix conversion.

8. The process of claim 7, wherein said finite state machines use a lookaside buffer to retain previous states.

9. The process of claim 7, wherein said finite state machines use configuration tables and exception tables to adjust the finite state machine's conversion behavior.

10. The process of claim 9, wherein said configuration tables and said exception tables are user configurable.

11. An apparatus for an integration system that exchanges data between application protocols, comprising:
at least two interface cards;
wherein each interface card is configured to send and receive a specific application protocol;
wherein each interface card is communicably connected to a computer system;
wherein said interface cards are connected to a common interconnect;
wherein a first interface card converts a received first application protocol bit stream into a multi-dimensional matrix representation of said first application protocol;
wherein a first interface card converts said first application protocol multi-dimensional matrix into a multi-dimensional matrix representation of an intermediate language;
wherein said first interface card sends said intermediate language multi-dimensional matrix to a second interface card;
wherein said second interface card converts said intermediate language multi-dimensional matrix into a multi-dimensional matrix representation of a second application protocol;
wherein said second interface card converts said second application protocol multi-dimensional matrix into a second application protocol bit stream; and
wherein said second interface card sends said second application protocol bit stream to a computer system.

12. The apparatus of claim 11, wherein said first interface card performs said conversions on a frame basis.

13. The apparatus of claim 11, wherein said first interface card uses a first finite state machine to perform said first application protocol bit stream conversion, and said first interface card uses a second finite state machine to perform said first application protocol multi-dimensional matrix conversion.

14. The apparatus of claim 13, wherein said finite state machines use a lookaside buffer to retain previous states.

15. The apparatus of claim 13, wherein said finite state machines use configuration tables and exception tables to adjust the finite state machine's conversion behavior.

16. The apparatus of claim 15, wherein said configuration tables and said exception tables are user configurable.

17. The apparatus of claim 11, wherein said second interface card uses a first finite state machine to perform said intermediate language multidimensional matrix conversion, and said first interface card uses a second finite state machine to perform said second application protocol multidimensional matrix conversion.

18. The apparatus of claim 17, wherein said finite state machines use a lookaside buffer to retain previous states.

19. The apparatus of claim 17, wherein said finite state machines use configuration tables and exception tables to adjust the finite state machine's conversion behavior.

20. The apparatus of claim 19, wherein said configuration tables and said exception tables are user configurable.

21. A process for an integration system that exchanges data between application protocols, comprising the steps of:
providing at least two interface cards;
wherein each interface card is configured to send and receive a specific application protocol;
wherein each interface card is communicably connected to a computer system;
wherein said interface cards are communicably connected with each other;
wherein a first interface card converts a received first application protocol bit stream into a multi-dimensional matrix representation of an intermediate language;
wherein said first interface card sends said intermediate language multi-dimensional matrix to a second interface card;
wherein said second interface card converts said intermediate language multi-dimensional matrix into a second application protocol bit stream; and
wherein said second interface card sends said second application protocol bit stream to a computer system.

22. The process of claim 21, wherein said first interface card performs said conversions on a frame basis.

23. The process of claim 21, wherein said first interface card uses a finite state machine to perform said first application protocol bit stream conversion.

24. The process of claim 23, wherein said finite state machine uses a lookaside buffer to retain previous states.

25. The process of claim 23, wherein said finite state machine uses configuration tables and exception tables to adjust the finite state machine's conversion behavior.

26. The process of claim 25, wherein said configuration tables and said exception tables are user configurable.

27. The process of claim 21, wherein said second interface card uses a finite state machine to perform said intermediate language multi-dimensional matrix conversion.

28. The process of claim 27, wherein said finite state machine uses a lookaside buffer to retain previous states.

29. The process of claim 27, wherein said finite state machine uses configuration tables and exception tables to adjust the finite state machine's conversion behavior.

30. The process of claim 29, wherein said configuration tables and said exception tables are user configurable.

31. An apparatus for an integration system that exchanges data between application protocols, comprising:
at least two interface cards;
wherein each interface card is configured to send and receive a specific application protocol;
wherein each interface card is communicably connected to a computer system;
wherein said interface cards are communicably connected with each other;
wherein a first interface card converts a received first application protocol bit stream into a multi-dimensional matrix representation of an intermediate language;
wherein said first interface card sends said intermediate language multi-dimensional matrix to a second interface card;
wherein said second interface card converts said intermediate language multi-dimensional matrix into a second application protocol bit stream; and
wherein said second interface card sends said second application protocol bit stream to a computer system.

32. The apparatus of claim 31, wherein said first interface card performs said conversions on a frame basis.

33. The apparatus of claim 31, wherein said first interface card uses a finite state machine to perform said first application protocol bit stream conversion.

34. The apparatus of claim 33, wherein said finite state machine uses a lookaside buffer to retain previous states.

35. The apparatus of claim 33, wherein said finite state machine uses configuration tables and exception tables to adjust the finite state machine's conversion behavior.

36. The apparatus of claim 35, wherein said configuration tables and said exception tables are user configurable.

37. The apparatus of claim 31, wherein said second interface card uses a finite state machine to perform said intermediate language multi-dimensional matrix conversion.

38. The apparatus of claim 37, wherein said finite state machine uses a lookaside buffer to retain previous states.

39. The apparatus of claim 37, wherein said finite state machine uses configuration tables and exception tables to adjust the finite state machine's conversion behavior.

40. The apparatus of claim 39, wherein said configuration tables and said exception tables are user configurable.

41. A process for an application protocol integration system, comprising the steps of:
providing at least two interface cards;
wherein each interface card is configured to send and receive a specific application protocol with an external computer system;
wherein said interface cards are communicably connected to each other;
providing application protocol conversion means on said interface cards for converting said specific application protocols into an intermediate language representation;
wherein an interface card sends said intermediate language representation to another interface card;
wherein an interface card, upon receipt of said intermediate language representation, converts said intermediate language representation into a specific application protocol bit stream; and
wherein said receiving interface card sends said specific application protocol bit stream to a computer system.

42. The process of claim 41, wherein said application protocol conversion means uses a dedicated finite state machine to perform said conversion.

43. The process of claim 41, wherein said receiving interface card uses a dedicated finite state machine to perform said intermediate language conversion.

44. The process of claim 41, wherein said interface cards are communicably connected across a interconnect.

45. An application protocol integration system, comprising:
at least two interface cards;
wherein each interface card is configured to send and receive a specific application protocol with an external computer system;
wherein said interface cards are communicably connected to each other;
application protocol conversion means on said interface cards for converting said specific application protocols into an intermediate language representation;
wherein an interface card sends said intermediate language representation to another interface card;
wherein an interface card, upon receipt of said intermediate language representation, converts said intermediate language representation into a specific application protocol bit stream; and
wherein said receiving interface card sends said specific application protocol bit stream to a computer system.

46. The apparatus of claim 45, wherein said application protocol conversion means uses a dedicated finite state machine to perform said conversion.

47. The apparatus of claim 45, wherein said receiving interface card uses a dedicated finite state machine to perform said intermediate language conversion.

48. The apparatus of claim 45, wherein said interface cards are communicably connected across a interconnect.

49. A process for an integration system that exchanges data between application protocols, comprising the steps of:
providing at least two interface cards;
wherein each interface card is configured to send and receive a specific application protocol; wherein each interface card is communicably connected to a computer system;
wherein said interface cards are communicably connected to each other;
wherein a first interface card converts a received first application protocol bit stream into an intermediate language representation;
wherein said first interface card sends said intermediate language representation to a second interface card;
wherein said second interface card converts said intermediate language representation into a second application protocol bit stream; and
wherein said second interface card sends said second application protocol bit stream to a computer system.

50. The process of claim 49, wherein said first interface card performs said conversions on a frame basis.

51. The process of claim 49, wherein said first interface card uses a finite state machine to perform said first application protocol bit stream conversion.

52. The process of claim 51, wherein said finite state machine uses a lookaside buffer to retain previous states.

53. The process of claim 51, wherein said finite state machine uses configuration tables and exception tables to adjust the finite state machine's conversion behavior.

54. The process of claim 53, wherein said configuration tables and said exception tables are user configurable.

55. The process of claim 49, wherein said second interface card uses a finite state machine to perform said intermediate language conversion.

56. The process of claim 55, wherein said finite state machine uses a lookaside buffer to retain previous states.

57. The process of claim 55, wherein said finite state machine uses configuration tables and exception tables to adjust the finite state machine's conversion behavior.

58. The process of claim 57, wherein said configuration tables and said exception tables are user configurable.

59. An apparatus for an integration system that exchanges data between application protocols, comprising the steps of:
at least two interface cards;
wherein each interface card is configured to send and receive a specific application protocol;
wherein each interface card is communicably connected to a computer system;
wherein said interface cards are communicably connected to each other;
wherein a first interface card converts a received first application protocol bit stream into an intermediate language representation;
wherein said first interface card sends said intermediate language representation to a second interface card;
wherein said second interface card converts said intermediate language representation into a second application protocol bit stream; and
wherein said second interface card sends said second application protocol bit stream to a computer system.

60. The apparatus of claim 59, wherein said first interface card performs said conversions on a frame basis.

61. The apparatus of claim 59, wherein said first interface card uses a finite state machine to perform said first application protocol bit stream conversion.

62. The apparatus of claim 61, wherein said finite state machine uses a lookaside buffer to retain previous states.

63. The apparatus of claim 61, wherein said finite state machine uses configuration tables and exception tables to adjust the finite state machine's conversion behavior.

64. The apparatus of claim 63, wherein said configuration tables and said exception tables are user configurable.

65. The apparatus of claim 59, wherein said second interface card uses a finite state machine to perform said intermediate language conversion.

66. The apparatus of claim 65, wherein said finite state machine uses a lookaside buffer to retain previous states.

67. The apparatus of claim 65, wherein said finite state machine uses configuration tables and exception tables to adjust the finite state machine's conversion behavior.

68. The apparatus of claim 67, wherein said configuration tables and said exception tables are user configurable.
